(19) United States
(12) Patent Application Publication
(10) Pub. No.: US 2026/0063257 A1
(43) Pub. Date: Mar. 5, 2026

(54) TRIMLESS LIGHTING FIXTURE AND METHODS FOR INSTALLING SAME

(71) Applicant: DMF, Inc., Carson, CA (US)

(72) Inventors: Harikrishnan Kumar, Redondo Beach, CA (US); Ken Czech, Redondo Beach, CA (US); Jonathan Schmidt, Manhattan Beach, CA (US); Amir Lotfi, Redondo Beach, CA (US); Michael D. Danesh, Carson, CA (US)

(73) Assignee: DMF, Inc., Carson, CA (US)

(21) Appl. No.: 19/320,231

(22) Filed: Sep. 5, 2025

Related U.S. Application Data
(60) Provisional application No. 63/691,142, filed on Sep. 5, 2024.
(60) Provisional application No. 63/691,149, filed on Sep. 5, 2024.

(51) Int. Cl. F21S 8/02; F21V 15/01; F21V 17/06; F21V 17/12

(52) U.S. Cl. CPC F21S 8/026; F21V 15/01; F21V 17/06; F21V 17/12

(57) ABSTRACT

A mud-in plate assembly is configured to convert a previously installed recessed lighting fixture having a first trade size into a trimless recessed lighting fixture having a second trade size smaller than the first trade size. The mud-in plate assembly includes a mud-in plate having a flange and a sidewall. The flange is sufficiently large to cover a first opening formed in a ceiling, which corresponds to an opening of a housing in the previously installed recessed lighting fixture. The sidewall defines a second opening smaller than the first opening. The sidewall is configured to support a lighting module designed for the second trade size. The mud-in plate assembly is implemented as part of a retrofit recessed lighting installation that utilizes components from the previously installed recessed lighting fixture, such as a housing, wiring, or a junction box, and does not require removal of drywall.

### CROSS-REFERENCE TO RELATED APPLICATION(S)

This application claims the priority benefit, under 35 U.S.C. 119 (c), of U.S. Application No. 63/691,149, filed Sep. 5, 2024 and entitled, “MUD-IN PLATE FOR RETROFIT INSTALLATION OF A COMPACT LIGHTING MODULE AND METHODS FOR USING SAME,” and U.S. Application No. 63/691,142, filed Sep. 5, 2024 and entitled, “MOUNTING FRAME WITH DRYWALL PANEL FOR TRIMLESS LIGHTING FIXTURE AND METHODS FOR USING SAME.” Each of the aforementioned applications is incorporated herein by reference in its entirety.

### BACKGROUND

A recessed lighting fixture generally includes a trim with a flange to cover an opening formed in the ceiling drywall during installation. A “trimless” recessed lighting fixture (also referred to in the art as a “flangeless recessed lighting fixture”) is a type of recessed lighting fixture that includes a trim flange integrated into the ceiling such that the trim flange is not readily visible to an observer. As a result, the surface of the ceiling extends seamlessly from the lighting fixture's surroundings to an opening formed in the ceiling to transmit light emitted by the lighting fixture with a clean and finished edge formed around the opening. Thus, a trimless recessed lighting fixture gives the appearance that the lighting fixture is built into the ceiling.

In conventional trimless recessed lighting fixtures, the lighting fixture typically includes a mud-in plate (also referred to in the art as a “mud plate,” a “mud ring,” or a “plaster ring”). Unlike conventional trims, which typically include a visible flange surrounding the opening of the lighting fixture and protruding from the ceiling surface, the mud-in plate is integrated into the ceiling thus providing the seamless appearance described above. For example, the mud-in plate often includes a flange that defines an opening for the lighting fixture. During installation, the flange is securely mounted to the ceiling and covered by multiple coats of joint compound (also referred to in the art as “mud” or “plaster”) to provide a relatively seamless appearance with the ceiling.

### SUMMARY

The Inventors have recognized and appreciated some contemporary interior designs have trended towards a minimalist aesthetic that favors less cluttered interior spaces with clean lines. In terms of lighting, this trend has led to interior designs favoring lighting fixtures that are not readily perceptible to the human eye. As an illustrative example, contemporary interior designs typically favor a “quiet ceiling,” where lighting fixtures are seamlessly integrated into a ceiling such that the lighting fixtures are not readily visible. The desire for less visually intrusive lighting fixtures has led to the development of trimless recessed lighting fixtures with smaller apertures. This has been facilitated, in part, by improvements in the efficiency of LED light sources, which have resulted in smaller, more compact LED modules capable of providing light output similar to or greater than larger, conventional lighting modules.

The Inventors have further recognized older recessed lighting fixtures often include relatively large apertures. For example, recessed lighting fixtures with incandescent or fluorescent light bulbs typically have an opening defined by a housing with a diameter ranging from about 5 inches to about 8 inches. The opening formed in a ceiling for light to pass through is typically similar in size as the opening of the housing. In view of the contemporary interior designs described above, the Inventors have appreciated it would be desirable to convert a recessed lighting fixture that includes a housing with a relatively large opening into a trimless recessed lighting fixture capable of supporting newer, smaller lighting modules designed for smaller aperture recessed lighting fixtures (e.g., lighting fixtures that have an opening with a diameter less than 5 inches). However, the Inventors have recognized several challenges with this modification.

First, a conventional mud-in plate typically has a thin flange and is thus susceptible to flexing. Excessive flexing of a mud-in plate, e.g., due to loads applied during installation and/or replacement of a lighting module, or the weight of the lighting module 300 and/or the trim 310, can damage a finished ceiling by causing cracks in the joint compound. To reduce flexing, conventional mud-in plates are designed such that the flange abuts a rigid object, e.g., the housing of the lighting fixture, the ceiling drywall. Said another way, conventional mud-in plates do not typically include a flange that is partially suspended. As a result, conventional mud-in plates are generally designed to support lighting modules that are the same size as conventional light sources and/or configured to output light through the same size opening as the conventional light source (e.g., an opening ranging from about 5 inches to about 8 inches). Because of the foregoing limitations, the installation of a lighting module for a smaller aperture recessed lighting fixture often requires extensive renovation, such as removing a portion of the ceiling drywall to replace any previously installed housing with a new housing designed to match the size of the smaller lighting module.

Second, the application of joint compound is a labor-intensive process that can have varying results depending on the skill of the person performing the process (e.g., a drywaller, a painter). For example, an excessive amount of joint compound can be easily applied to the mud-in plate. This can result in a visible bulge on the portion of the ceiling surrounding the opening of the mud-in plate, which is not desirable. The appearance of the bulge may be further exacerbated if the joint compound is not properly blended with the surrounding ceiling drywall (also referred to in the art as “feathering out”). In another example, the joint compound can easily accumulate near the opening of the mud-in plate, which can adversely affect the insertion and/or placement of the lighting module and/or a separate trim covering the lighting module (i.e., a trim that does not include a flange extending below the ceiling and/or around the opening). For instance, the presence of joint compound near the opening may prevent the trim from being fully inserted into the opening, resulting in a portion of the trim extending below the ceiling. In yet another example, the foregoing difficulties associated with the application of joint compound may be further exacerbated by the geometry of the opening. For instance, the application of joint compound around a circular opening is generally more challenging compared to a square opening and can often lead to the excessive application of joint compound.

In view of these foregoing challenges, the present disclosure is directed to various inventive implementations of a trimless recessed lighting fixture configured to support a lighting module for comparatively smaller aperture recessed lighting fixtures. The present disclosure is also directed to various components (e.g., a mud-in plate, a mounting frame) to improve the case of installing a trimless recessed lighting fixture. The inventive implementations of trimless recessed lighting fixtures disclosed herein may be implemented in a retrofit recessed lighting installation, e.g., an installation that utilizes previously installed components, such as a housing, wiring, or a junction box and/or does not require removal of drywall. The inventive implementations of trimless recessed lighting fixtures disclosed herein may be implemented in a new construction recessed lighting installation, e.g., an installation that typically involves the installation of a new housing and/or drywall.

In one example implementation, the trimless recessed lighting fixture includes a mud-in plate assembly for a retrofit installation. The mud-in plate assembly includes a mud-in plate with a flange to cover a relatively large opening formed on a ceiling for the recessed lighting fixture while providing a relatively small opening for the lighting module. It should be appreciated the opening formed in the ceiling is typically dimensioned to be the same or similar as the opening of a housing in the recessed lighting fixture. The mud-in plate may be directly coupled to the ceiling drywall, e.g., via one or more fasteners. One or more coats of joint compound may then be applied to the flange of the mud-in plate and blended with the surrounding ceiling (e.g., via sanding, painting), thus giving the appearance of the ceiling extending to the small opening of the mud-in plate.

In this manner, the large opening previously used by the recessed lighting fixture may be converted into a small opening without requiring extensive renovation of the ceiling (e.g., removal of ceiling drywall and/or replacement of the lighting fixture housing). Additionally, the retrofit installation may utilize the housing, junction box, and/or electrical wiring of a previously installed recessed lighting fixture, thus eliminating the need for a highly skilled electrician to complete the installation of the smaller lighting module unlike conventional retrofit installations.

The mud-in plate assembly may further include a vertically adjustable collar to accommodate variations in ceiling thickness. A rotation tool to facilitate vertical adjustment of the collar. In some implementations, the rotation tool may enclose the opening of the mud-in plate during installation to prevent the application of joint compound and/or paint to the opening of the mud-in plate. It should be appreciated that, in some implementations, the mud-in plate assembly may not include a collar. Furthermore, the mud-in plate assembly may include an insert to enclose the opening of the mud-in plate in the same manner as the rotation tool.

In another example implementation, the trimless recessed lighting fixture includes a mounting frame for a new construction installation. The mounting frame may include an integrated panel (e.g., a drywall panel, a composite panel) to cover a relatively large opening of the housing and/or a relatively large opening formed on a ceiling while providing a relatively small opening for the lighting module. The mounting frame may be directly coupled to a housing, e.g., via one or more fasteners. In some implementations, the features of the panel may be integrated into the mounting frame.

The panel is configured for integration into the ceiling. For example, an opening may be cut into the surrounding ceiling drywall in the shape of the panel. The panel may thereafter be inserted into the opening such that the edges of the panel abut the edges of the opening formed on the ceiling drywall. Conventional drywall installation techniques may thereafter be applied to join the panel to the ceiling drywall, such as applying drywall tape and coating the drywall tape with joint compound. In this manner, the mounting frame appreciably reduces the amount of joint compound applied to finish the trimless recessed lighting fixture compared to conventional mud-in plates.

The panel may be shaped to make integration with the ceiling drywall easier. For example, the panel may be shaped as a square so that drywall tape may be more easily applied to the edges of the panel. Additionally, the panel may include a recessed portion along its edges to accommodate the thickness of the drywall tape and/or joint compound, thus making it easier to blend the panel with the surrounding ceiling drywall and reduce the formation of any undesirable bulges between the panel and the surrounding ceiling drywall.

The mud-in plate assemblies and mounting frames disclosed herein are generally applied to recessed lighting fixtures installed in a ceiling. However, it should be appreciated that these are non-limiting examples. More generally, the mud-in plate assemblies and the mounting frames may be applied to recessed lighting fixtures installed in any orientation on any portion of a built environment including, but not limited to, a ceiling, a wall, and a floor.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a cross-section view of a lighting system with an example mud-in plate assembly.

FIG. 2A shows a cross-section view of a lighting system with a conventional light source and a conventional trim.

FIG. 2B shows a cross-section view of the lighting system of FIG. 2A where the light source and the trim are removed.

FIG. 2C shows a cross-section view of the lighting system of FIG. 2B where an electrical cable is connected to an electrical socket of the lighting system.

FIG. 2D shows a cross-section view of the lighting system of FIG. 2C where an example mud-in plate assembly is mounted to the ceiling drywall.

FIG. 2E shows a cross-section view of the lighting system of FIG. 2D where joint compound is applied onto a mud-in plate of the mud-in plate assembly.

FIG. 2F shows a cross-section view of the lighting system of FIG. 2E where a rotation tool in the mud-in plate assembly is adjusted to move a collar into alignment with a bottom end of the ceiling.

FIG. 2G shows a cross-section view of the lighting system of FIG. 2F where the rotational tool is removed.

FIG. 2H shows a cross-section view of the lighting system of FIG. 2G where a lighting module and a trim are inserted into an opening of the mud-in plate.

FIG. 3A shows a bottom perspective view of an example mud-in plate assembly with a circular opening and a vertically adjustable collar.

FIG. 3B shows a top perspective view of the mud-in plate assembly of FIG. 3A.

FIG. 3C shows a side view of the mud-in plate assembly of FIG. 3A.

FIG. 3D shows a top view of the mud-in plate assembly of FIG. 3A.

FIG. 3E shows a bottom view of the mud-in plate assembly of FIG. 3A.

FIG. 3F shows a cross-section view of the mud-in plate assembly of FIG. 3A corresponding to the plane A-A in FIG. 3E.

FIG. 3G shows an exploded view of the mud-in plate assembly of FIG. 3A.

FIG. 3H shows an exploded view of a mud-in plate and a collar in the mud-in plate assembly of FIG. 3A together with an example lighting module and an example trim.

FIG. 4A shows a bottom perspective view of another example mud-in plate assembly with a circular opening and a vertically adjustable collar.

FIG. 4B shows a top perspective view of the mud-in plate assembly of FIG. 4A.

FIG. 4C shows a side view of the mud-in plate assembly of FIG. 4A.

FIG. 4D shows a top view of the mud-in plate assembly of FIG. 4A.

FIG. 4E shows a bottom view of the mud-in plate assembly of FIG. 4A.

FIG. 4F shows a cross-section view of the mud-in plate assembly of FIG. 4A corresponding to the plane A-A in FIG. 4E.

FIG. 4G shows an exploded view of the mud-in plate assembly of FIG. 4A.

FIG. 5A shows a bottom perspective of an example mud-in plate assembly with a circular opening and a fixed collar.

FIG. 5B shows a bottom view of the mud-in plate assembly of FIG. 5A.

FIG. 5C shows a side view of the mud-in plate assembly of FIG. 5A.

FIG. 5D shows an exploded view of the mud-in plate assembly of FIG. 5A.

FIG. 6A shows a bottom perspective view of another example mud-in plate assembly with a square opening and a fixed collar.

FIG. 6B shows a top perspective view of the mud-in plate assembly of FIG. 6A.

FIG. 6C shows a side view of the mud-in plate assembly of FIG. 6A.

FIG. 6D shows a top view of the mud-in plate assembly of FIG. 6A.

FIG. 6E shows a bottom view of the mud-in plate assembly of FIG. 6A.

FIG. 6F shows a cross-section view of the mud-in plate assembly of FIG. 6A corresponding to the plane A-A in FIG. 6E.

FIG. 6G shows an exploded view of the mud-in plate assembly of FIG. 6A.

FIG. 6H shows another exploded view of the mud-in plate assembly of FIG. 6A.

FIG. 7A shows a bottom perspective of another example mud-in plate assembly with a square opening and a fixed collar.

FIG. 7B shows a bottom view of the mud-in plate assembly of FIG. 7A.

FIG. 7C shows a side view of the mud-in plate assembly of FIG. 7A.

FIG. 8A shows a bottom perspective view of an example mud-in plate assembly with a smooth inner plate and an outer plate with perforations.

FIG. 8B shows a top perspective view of the mud-in plate assembly of FIG. 8A.

FIG. 8C shows a side view of the mud-in plate assembly of FIG. 8A.

FIG. 8D shows a top view of the mud-in plate assembly of FIG. 8A.

FIG. 8E shows a bottom view of the mud-in plate assembly of FIG. 8A.

FIG. 8F shows a cross-section view of the mud-in plate assembly of FIG. 8A corresponding to the plane A-A of FIG. 8D.

FIG. 8G shows an exploded bottom perspective view of the mud-in plate assembly of FIG. 8A.

FIG. 8H shows an exploded top perspective view of the mud-in plate assembly of FIG. 8A.

FIG. 9A shows a bottom perspective view of an example mud-in plate assembly with a flange having a smooth inner portion and a perforated outer portion.

FIG. 9B shows a top perspective view of the mud-in plate assembly of FIG. 9A.

FIG. 9C shows a side view of the mud-in plate assembly of FIG. 9A.

FIG. 9D shows a top view of the mud-in plate assembly of FIG. 9A.

FIG. 9E shows a bottom view of the mud-in plate assembly of FIG. 9A.

FIG. 9F shows a cross-section view of the mud-in plate assembly of FIG. 9A corresponding to the plane A-A of FIG. 9D.

FIG. 9G shows an exploded top perspective view of the mud-in plate assembly of FIG. 9A.

FIG. 10 shows a front view of an example mud-in plate for a mud-in plate assembly to facilitate conversion of a multi gang box to a single box.

FIG. 11A shows a cover plate for a multi-gang box installed into a wall.

FIG. 11B shows the multi-gang box disposed in the wall after the cover plate is removed.

FIG. 11C shows a mud-in plate assembly attached to the wall via a plurality of fasteners. The mud-in plate assembly includes the mud-in plate of FIG. 10 and an insert covering an opening of the mud-in plate.

FIG. 11D shows the mud-in plate assembly of FIG. 11C with joint compound applied to a portion of the mud-in plate.

FIG. 11E shows the mud-in plate assembly of FIG. 11D with joint compound applied to the entirety of the mud-in plate and the insert removed to expose the opening the mud-in plate.

FIG. 11F shows a cover plate for single gang box installed onto the wall to cover the opening in the mud-in plate.

FIG. 12A shows a perspective view of a cable to facilitate connection between a lighting module and a conventional socket.

FIG. 12B shows another perspective view of the cable of FIG. 12A.

FIG. 13A shows a bottom perspective view of an example housing assembly with a mounting frame to facilitate a trimless new construction installation with a circular aperture.

FIG. 13B shows a bottom view of the housing assembly of FIG. 13A.

FIG. 13C shows an exploded bottom perspective view of the housing assembly of FIG. 13A.

FIG. 14A shows a top perspective view of the mounting frame of FIG. 13A.

FIG. 14B shows a bottom perspective view of the mounting frame of FIG. 14A.

FIG. 15A shows a bottom perspective view of another example mounting frame with a circular aperture.

FIG. 15B shows a top perspective view of the mounting frame of FIG. 15A.

FIG. 15C shows a right side view of the mounting frame of FIG. 15A.

FIG. 15D shows a front view of the mounting frame of FIG. 15A.

FIG. 15E shows a bottom view of the mounting frame of FIG. 15A.

FIG. 15F shows a top view of the mounting frame of FIG. 15A.

FIG. 15G shows a cross section view of the mounting frame of FIG. 15A corresponding to the plane A-A of FIG. 15F.

FIG. 15H shows an exploded bottom perspective view of the mounting frame of FIG. 15A.

FIG. 15I shows an exploded top perspective view of the mounting frame of FIG. 15A.

FIG. 16A shows a bottom perspective view of an example mounting frame with a square aperture.

FIG. 16B shows a top perspective view of the mounting frame of FIG. 16A.

FIG. 16C shows a right side view of the mounting frame of FIG. 16A.

FIG. 16D shows a front view of the mounting frame of FIG. 16A.

FIG. 16E shows a bottom view of the mounting frame of FIG. 16A.

FIG. 16F shows a top view of the mounting frame of FIG. 16A.

FIG. 16G shows a cross section view of the mounting frame of FIG. 16A corresponding to the plane A-A of FIG. 16F.

FIG. 16H shows an exploded bottom perspective view of the mounting frame of FIG. 16A.

FIG. 16I shows an exploded top perspective view of the mounting frame of FIG. 16A.

### DETAILED DESCRIPTION

Following below are more detailed descriptions of various concepts related to, and embodiments of, a trimless recessed lighting fixture configured to support a lighting module for comparatively smaller aperture recessed lighting fixtures and components (e.g., a mud-in plate, a mounting frame) to improve the case of installing the trimless recessed lighting fixture. Methods for installing the trimless recessed lighting fixture in a retrofit installation or a new construction installation are also disclosed. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of a mud-in plate assembly are provided, wherein a given example or set of examples showcases a mud-in plate, a collar, and a rotation tool (or, alternatively, an insert). Additionally, various examples of inventive mounting frames are provided, wherein a given example or set of examples showcases a housing, a mounting frame, a collar, an insert, and a panel. It should be appreciated that one or more features discussed in connection with a given example of a mud-in plate assembly or a mounting frame may be employed in other respective examples of mud-in plate assemblies and mounting frames according to the present disclosure, such that the various features disclosed herein may be readily combined in a given mud-in plate assembly or mounting frame according to the present disclosure (provided that respective features are not mutually inconsistent).

Certain parameters and dimensions of the mud-in plate assemblies and the mounting frames described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### 1. A Mud-In Plate Assembly for a Retrofit Installation

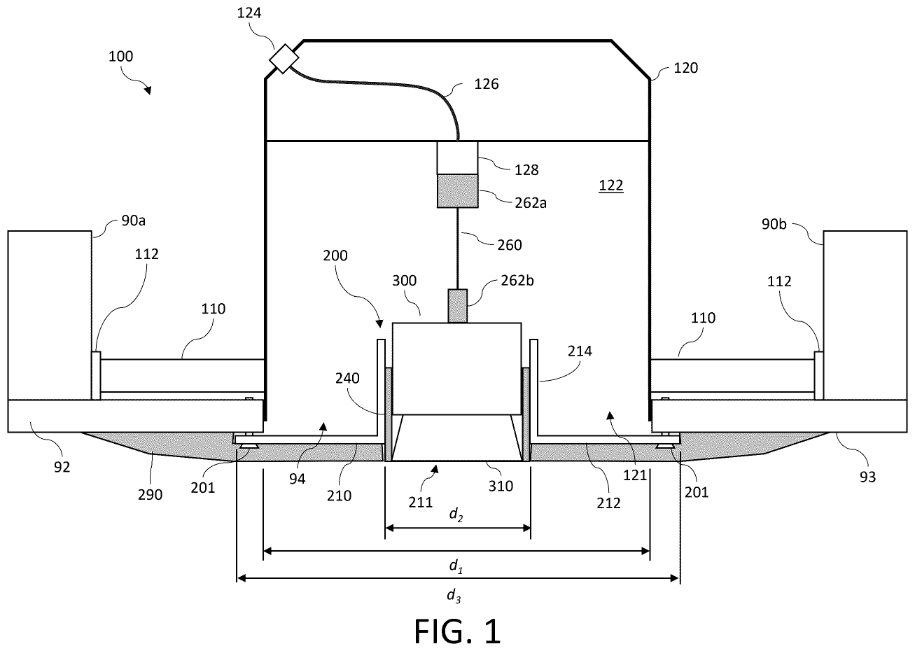

FIG. 1 shows a non-limiting example of a mud-in plate assembly 200 for a recessed lighting fixture 100 to facilitate a retrofit installation of a lighting module 300. Specifically, the recessed lighting fixture 100 may include components from a previously installed recessed lighting fixture. The components from the previously installed recessed lighting fixture may include various mechanical components to physically support the lighting module and electrical components to provide electrical power and various electrical control signals (e.g., dimming, correlated color temperature). For example, the components reused from the previously installed recessed lighting fixture may include, but is not limited to, a housing (e.g., a can housing, a new construction housing, a remodel housing), a junction box, a pan frame, one or more bar hangers, electrical wiring (e.g., electrical wiring connected to the electrical mains of a building), a remote controller (e.g., to generate electrical control signals that affect the operation of the lighting module), and the like. In some implementations, all of the components of the previously installed recessed lighting fixture may be reused except for the lighting module and the trim.

For example, FIG. 1 shows the recessed lighting fixture 100 may include a housing 120 (e.g., a can housing), a junction box (not shown), and one or more bar hangers 110 with corresponding bar hanger heads 112 to facilitate attachment of the lighting fixture 100 to support structures 90a and 90b (e.g., a wood joist, a metal joist, a T-bar, a hat channel) above the ceiling drywall 92. The housing 120 may define a cavity 122 to contain the lighting module 300. The housing 120 may be disposed proximate to or, in some instances, partially inserted into an opening 94 formed in the ceiling drywall 92 for the lighting fixture 100. In some implementations, the housing 120 may have an opening 121 that is substantially similar or, in some instances, equal in size to the opening 94 formed in the ceiling 92.

Additionally, the recessed lighting fixture 100 may include various electrical wiring and/or electrical connections to receive electrical power from a building power supply system to provide electrical power and/or a remote controller to provide electrical control signals (e.g., dimming, adjustments to the correlated color temperature). For example, FIG. 1 shows the housing may include a cable 126 connected at one end to a feedthrough 124 and another end to a socket 128 to supply electrical power to a light source (e.g., a lamp) and/or electrical control signals. It should be appreciated that the feedthrough 124 may be connected to a junction box (not shown) via another cable (not shown). The junction box, in turn, may contain various electrical connections (e.g., wire splices) to provide electrical power to the housing 120.

It should be appreciated while the mud-in plate assemblies disclosed herein are shown for a retrofit installation, this is a non-limiting use of the mud-in plate assemblies. More generally, the mud-in plate assemblies may be used in other types of installations. For instance, the mud-in plate assembly 200 may be used in a new construction installation. A new housing 120 may be installed to one or more support structures. Thereafter, a drywall panel may be installed to cover, for example, a ceiling. An opening may then be cut into the drywall panel to provide an aperture for the recessed lighting fixture. The lighting installation may include, for example, a housing 120 capable of supporting a lighting module 300 designed for a large aperture recessed lighting fixture. However, it may also be desirable for the housing 120 to support smaller aperture recessed lighting fixtures. In this manner, the same housing 120 can support different-sized lighting fixtures, thus eliminating the need for bespoke housings for each desired aperture size. This may be accomplished using the mud-in plate assembly 200. For example, an opening may be cut into the ceiling using the housing as a guide. Thus, the shape and/or dimensions of the opening may correspond to the opening in the housing. The mud-in plate assembly 200 may thereafter be installed to provide a smaller aperture as described above.

As shown in FIG. 1, the mud-in plate assembly 200 provides a way to reduce the size of the opening 121 for the previously installed recessed lighting fixture to accommodate a relatively smaller lighting module 300. In some implementations, the mud-in plate assembly 200 may also include a separate trim 310 to cover the smaller lighting module 300. The trim 310, however, may not include a flange that extends below the ceiling drywall 92 and/or around the opening 94.

The mud-in plate assembly 200 includes a mud-in plate 210 with a flange 212 and a sidewall 214 joined to the flange 212. The flange 212 is shaped and/or dimensioned to at least cover the opening 94 formed in the ceiling drywall 92 and, by extension, the opening 121 of the housing 120. In some implementations, the flange 212 may be dimensioned to be sufficiently larger than the ceiling opening 94 to provide a secure location along the ceiling 92 to securely couple the mud-in plate 210 to the ceiling 92 (e.g., via one or more fasteners). The sidewall 214 of the mud-in plate 210 defines a relatively smaller opening 211 for the lighting module 300 and/or the trim 310.

The mud-in plate 210 and, in particular, the flange 212 may be securely coupled to the ceiling drywall 92. For example, FIG. 1 shows the flange 212 may be securely coupled to the ceiling 92 via multiple fasteners 201 (e.g., a drywall screw, a wall anchor). Specifically, the flange 212 may include one or more fastener openings 219 and corresponding fasteners 201 may be inserted through the fastener openings 219 when securing the mud-in plate 210 to the ceiling drywall 92. As described above, the flange 212 may be sufficiently large in size to cover the ceiling opening 94 and provide a secure location on the ceiling 92 to couple the mud-in plate 210 to the ceiling 92. Said another way, the flange 212 may be sufficiently large so that the fasteners 201 coupling the flange 212 to the ceiling 92 are not disposed near the edge of the ceiling opening 94. In some implementations, the mud-in plate assembly 200 may not physically contact the housing 120 or any other components of the previously installed recessed lighting fixture. It should be appreciated, however, that the foregoing attachment of the mud-in plate 210 to the ceiling drywall 92 is a non-limiting example. In some implementations, the flange 212 of the mud-in plate 210 may be directly coupled to the housing 120 of the recessed lighting fixture 100, e.g., via one or more screw fasteners, one or more sheet metal screws, or the like. In some implementations, the flange 212 may be directly coupled to the housing 120 in the same manner as the mounting frames disclosed in Section 2 below.

To provide a seamless appearance with the ceiling drywall 92, one or more coats of joint compound 290 may be applied directly onto the flange 212 of the mud-in plate 210. As shown in FIG. 1, the joint compound 290 may be applied to conceal the mud-in plate 210 and provide a relatively smooth, continuous surface that merges with the surrounding ceiling drywall 92. Said another way, the joint compound 290 may be applied and feathered out to give the appearance the ceiling surface extends to the opening 211 defined by the sidewall 214 of the mud-in plate 210. It should be appreciated that the thickness of the joint compound 290 shown in FIG. 1 is exaggerated to make clear where the joint compound 290 is applied. In practice, the joint compound 290 may have a relatively small thickness sufficient to cover the flange of the mud-in plate such that the coats of joint compound 290 are not readily discernable from the surrounding ceiling drywall 92. For example, the joint compound 290 may not exhibit any appreciable bulge on and/or near the mud-in plate assembly 200.

As described above, the mud-in plate assembly 200 may facilitate the installation of a lighting module 300 designed for smaller aperture recessed lighting fixtures into the housing 120 of a larger aperture recessed lighting fixture 100. This is accomplished, in part, by the mud-in plate 210 providing a sufficiently large flange 212 to cover the opening 94 of the ceiling drywall 92 and, by extension, the opening 121 of the housing 120 and a smaller opening 211 defined by the sidewall 214 to support the lighting module 300.

In some implementations, the mud-in plate assembly 200 may convert the previously installed recessed lighting fixture from a first trade size to a second trade size smaller than the first trade size. The term “trade size” refers to the size classification of a recessed lighting fixture, which is typically based on the size of the opening of a trim located at the ceiling for the lighting fixture. The size of the trim opening is often approximately equal or, in some instances, equal to the size of an opening formed in the ceiling. Furthermore, the size of the opening formed in the ceiling is often approximately equal or, in some instances, equal to the size of an opening of a housing (e.g., a can housing) in the recessed lighting fixture. As used herein, the term “trade size” may correspond to a size range for the ceiling opening and/or the opening of the housing that is commonly used with the trade size. Generally, the size of the opening (e.g., of the ceiling and/or the housing) may be characterized as a characteristic width of the opening. For example, if the opening is shaped as a square, the characteristic width (also referred to herein as a “width”) may correspond to the length of one side of the square. In another example, if the opening is shaped as a circle, the characteristic width may correspond to the diameter of the circle.

Common trade sizes include, but are not limited to, a 1-inch trade size, a 2-inch trade size, a 3-inch trade size, a 4-inch trade size, a 5-inch trade size, a 6-inch trade size, a 7-inch trade size, and an 8-inch trade size. Following below are examples of dimensional ranges for each of the foregoing trade sizes. A 1-inch trade size may correspond to a width of an opening for the recessed lighting fixture (e.g., the opening in the ceiling, the opening of the housing) ranging from about 1 inch to about 2 inches, including all values and sub-ranges in between. A 2-inch trade size may correspond to a width of an opening for the recessed lighting fixture ranging from about 2 inches to about 3 inches, including all values and sub-ranges in between. A 3-inch trade size may correspond to a width of an opening for the recessed lighting fixture ranging from about 3 inches to about 4 inches, including all values and sub-ranges in between. A 4-inch trade size may correspond to a width of an opening for the recessed lighting fixture ranging from about 4 inches to about 5 inches, including all values and sub-ranges in between. A 5-inch trade size may correspond to a width of an opening for the recessed lighting fixture ranging from about 5 inches to about 6 inches, including all values and sub-ranges in between. A 6-inch trade size may correspond to a width of an opening for the recessed lighting fixture ranging from about 6 inches to about 7 inches, including all values and sub-ranges in between. A 7-inch trade size may correspond to a width of an opening for the recessed lighting fixture ranging from about 7 inches to about 8 inches, including all values and sub-ranges in between. An 8-inch trade size may correspond to a width of an opening for the recessed lighting fixture ranging from about 8 inches to about 10 inches, including all values and sub-ranges in between.

It should be appreciated that the foregoing dimensional ranges of the width for each trade size are non-limiting examples. In some implementations, the dimensional ranges for the width may be different (e.g., larger) for a given trade size. For example, the mud-in plate assemblies 200a and 200b include respective mud-in plates 210a and 210b with openings 211 to support a lighting module 300 for a 2-inch trade size lighting fixture. The openings 211 in both examples have a diameter, d₂, equal to about 3 5/16 inches.

The mud-in plate assemblies disclosed herein may convert a previously installed recessed lighting fixture from any trade size to any smaller trade size. In one non-limiting example, the mud-in plate assembly 200 may convert the recessed lighting fixture from an 8-inch trade size to a 4-inch trade size. In another non-limiting example, the mud-in plate assembly 200 may convert the recessed lighting fixture from a 6-inch trade size to a 4-inch trade size. In another non-limiting example, the mud-in plate assembly 200 may convert the recessed lighting fixture from a 5-inch trade size to a 4-inch trade size. In yet another non-limiting example, the mud-in plate assembly 200 may convert the recessed lighting fixture from a 6-inch trade size to a 2-inch trade size. In yet another non-limiting example, the mud-in plate assembly 200 may convert the recessed lighting fixture from a 5-inch trade size to a 2-inch trade size. In yet another non-limiting example, the mud-in plate assembly 200 may convert the recessed lighting fixture from a 4-inch trade size to a 2-inch trade size.

As shown in FIG. 1, the mud-in plate assembly 200 may cover a ceiling opening 94 having a width, d₁, and provide a relatively smaller opening 211 (e.g., defined by the sidewall 214 of the mud-in plate 210) having a width, d₂. In some implementations, the opening 121 of the housing 120 may have a width equal to d₁. In some implementations, the width, d₁, may range from about 4 inches to about 8 inches, including all values and sub-ranges in between. For example, the width, d₁, may be equal to about 4 inches, about 5 inches, about 6 inches, about 7 inches, or about 8 inches. In some implementations, the width, d₂, may range from about 0.5 inches to about 4 inches, including all values and sub-ranges in between. For example, the width, d₂, may be equal to about 1 inch, about 2 inches, about 3 inches, or about 4 inches. In other examples, the width, d₂, may be equal to about 3 5/16 inches, about 3⅜ inches, about 4¼ inches, about 4 1/16 inches, about 4.2 inches, or about 4.3 inches. In some implementations, the difference between the widths d₁ and d₂ may be greater than or equal to 1 inch. In some implementations, the difference between the widths d₁ and d₂ may range from about 1 inch to about 7 inches, including all values and sub-ranges in between. For example, the difference between the widths d₁ and d₂ may be equal to about 1 inch, about 2 inches, about 3 inches, about 4 inches, about 5 inches, about 6 inches, or about 7 inches.

The mud-in plate 210 and, in particular, the flange 212 may be relatively thin, in part, to reduce the depth at which the mud-in plate 210 extends below the surrounding ceiling drywall 92 and the amount of joint compound 290 applied to cover the flange 212, which both contribute to a more seamless appearance. In some implementations, the mud-in plate 210 may have a flange 212 with a thickness less than or equal to about 3 millimeters (mm), including all values and sub-ranges in between. In some implementations, the thickness of the flange 212 may range from about 0.5 mm to about 3 mm, including all values and sub-ranges in between. For example, the thickness of the flange 212 may be equal to about 0.5 mm, about 1 mm, about 1.5 mm, about 2 mm, about 2.5 mm, or about 3 mm. In another example, the thickness of the flange may be equal to about 1/16 inch.

The flange 212 of the mud-in plate 210 may further be sufficiently large to ensure the entirety of the opening 94 formed in the ceiling 92 for the previously installed recessed lighting fixture is covered by the flange 212. In some implementations, the flange 212 may also be sufficiently large to provide a secure location for one or more fasteners 201 to securely couple the flange 212 to the ceiling drywall 92. In some implementations, the flange 212 may have an outer width, d₃, that ranges from about 6 inches to about 10 inches, including all values and sub-ranges in between. For example, the width, d₃, of the flange 212 may be equal to about 6 inches, about 6¾ inches, about 7 inches, about 8 inches, about 8 1/16 inches, about 9 inches, or about 10 inches.

It should be appreciated that the foregoing discussion of the dimensional values for the widths d₁, d₂, and d₃ can apply to various geometries. For example, if the openings 94 and 211 and/or the flange 212 are square in shape, the length of one side of the respective square geometries may have the same dimensional values as d₁, d₂, and d₃, respectively, discussed above. In another example, if the openings 94 and 211 and/or the flange 212 are circular in shape, the diameter of the respective circular geometries may have the same dimensional values as d₁, d₂, and d₃, respectively, discussed above.

The term “about,” when used to describe the dimensions of the mud-in plate assembly 200 or the recessed lighting fixture 100, is intended to cover manufacturing tolerances and variations in the assembly and installation of the recessed lighting fixture 100. For example, “about 1 inch” may correspond to the following ranges: 0.99 inches to 1.01 inches (+/−1% variation), 0.98 inches to 1.02 inches (+/−2% variation), 0.97 inches to 1.03 inches (+/−3% variation), 0.96 inches to 1.04 inches (+/−4% variation), 0.95 inches to 1.05 inches (+/−5% variation), 0.9 inches to 1.1 inches (+/−10% variation), including all values and sub-ranges in between.

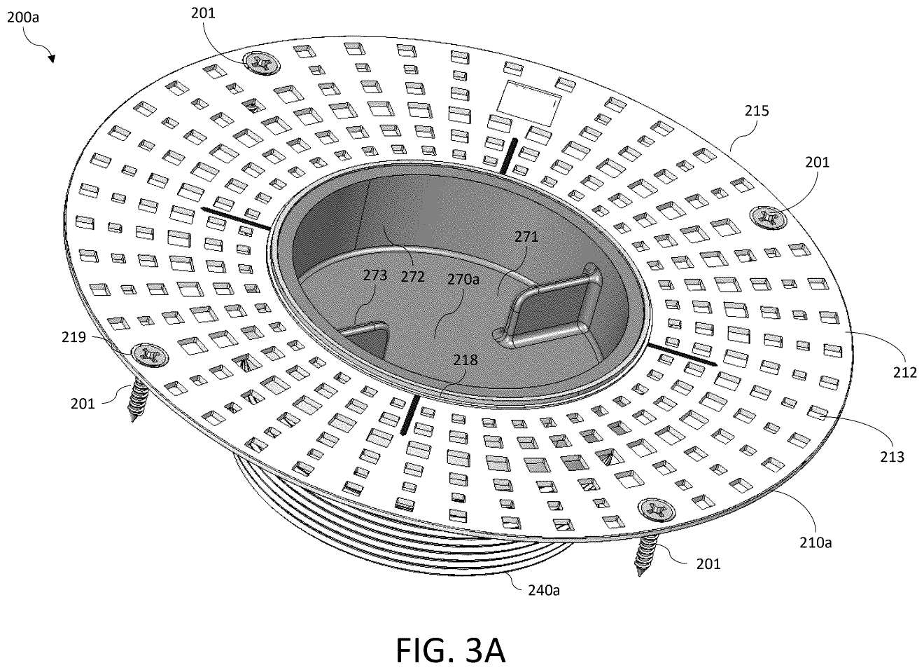

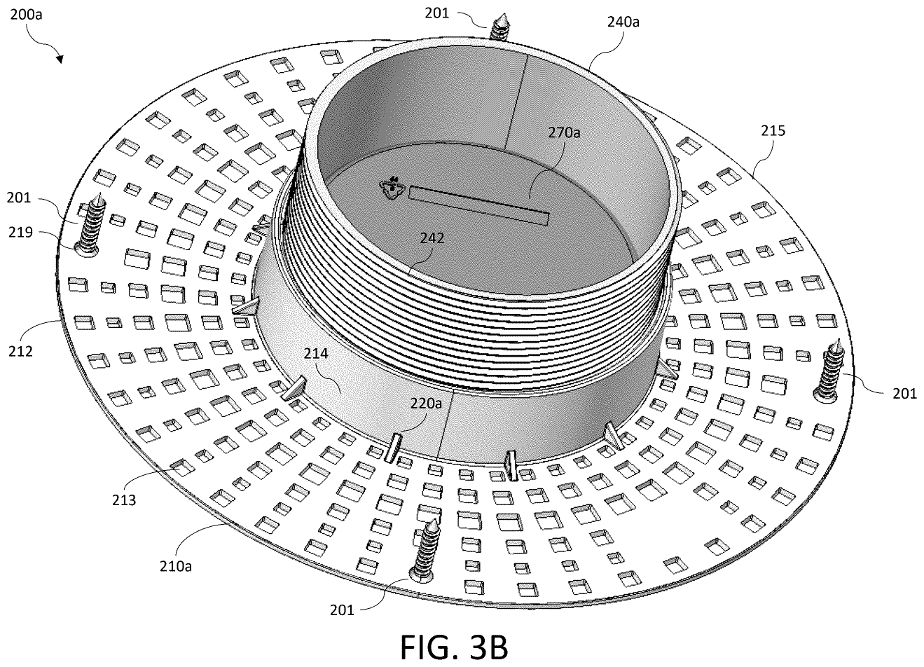

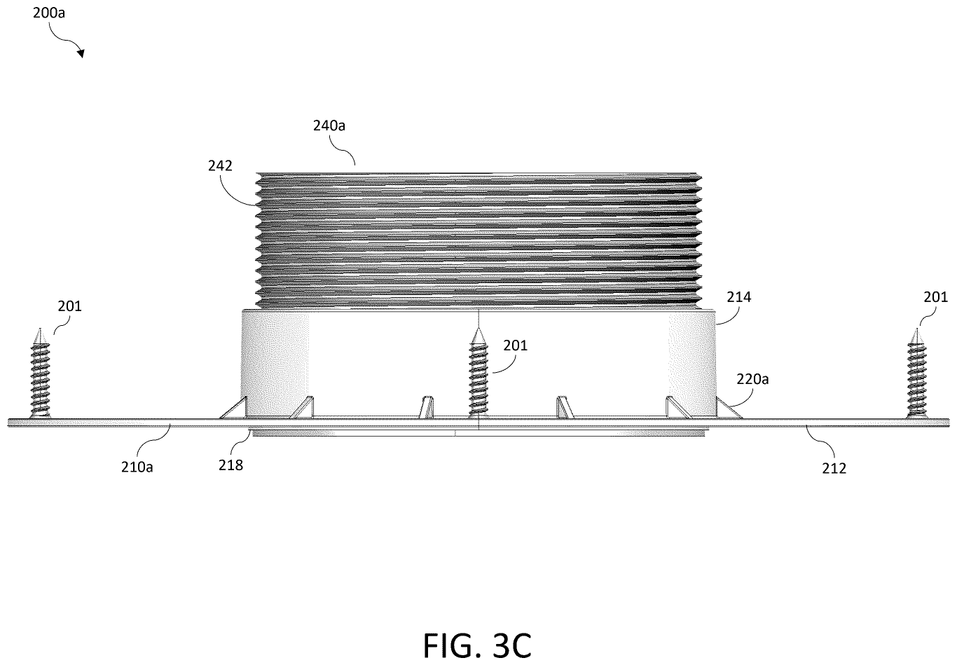

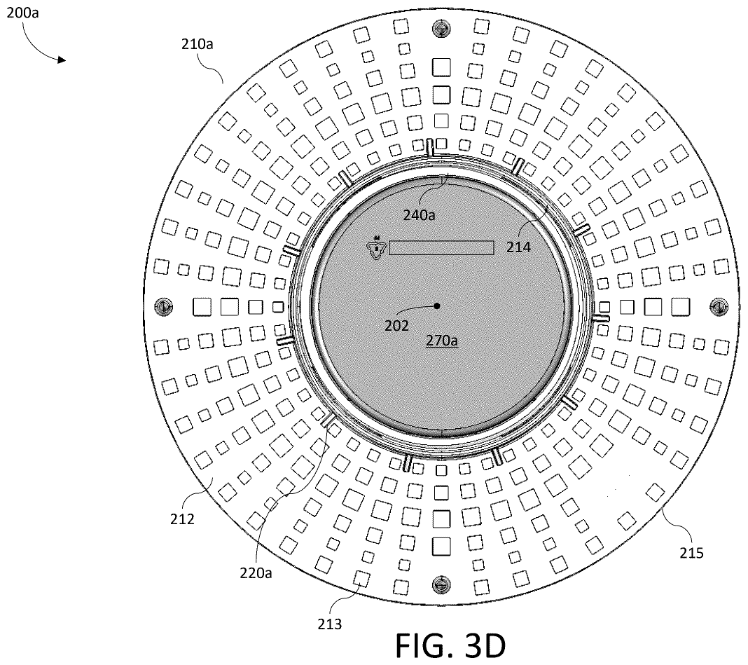

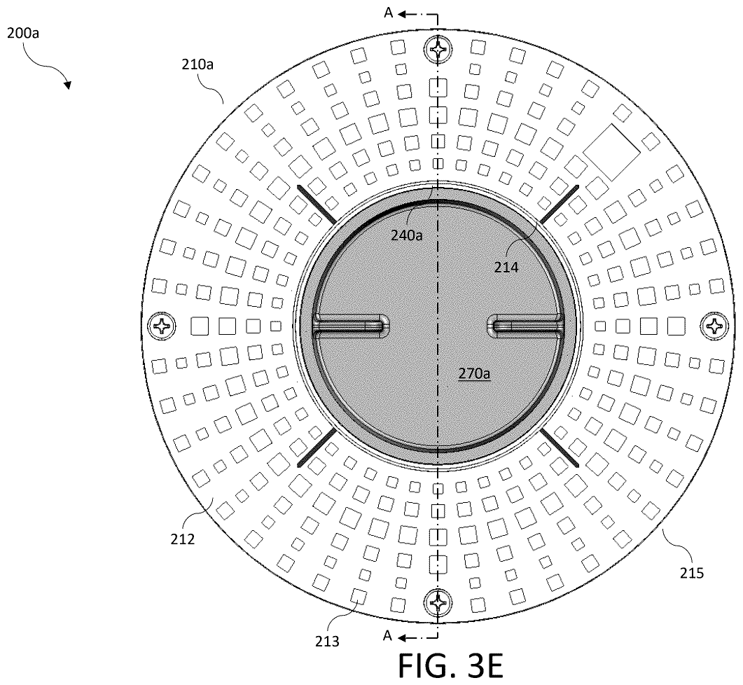

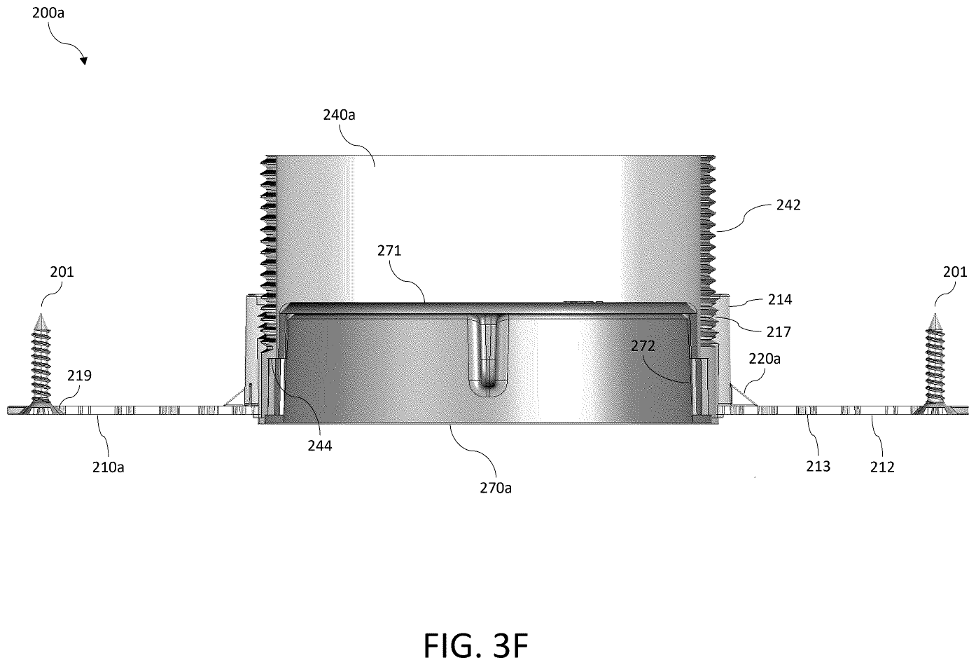

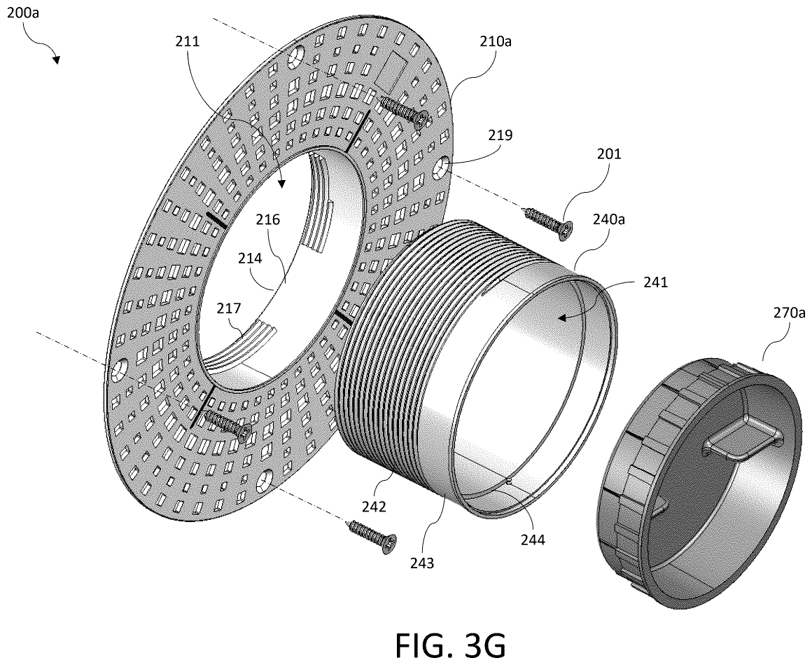

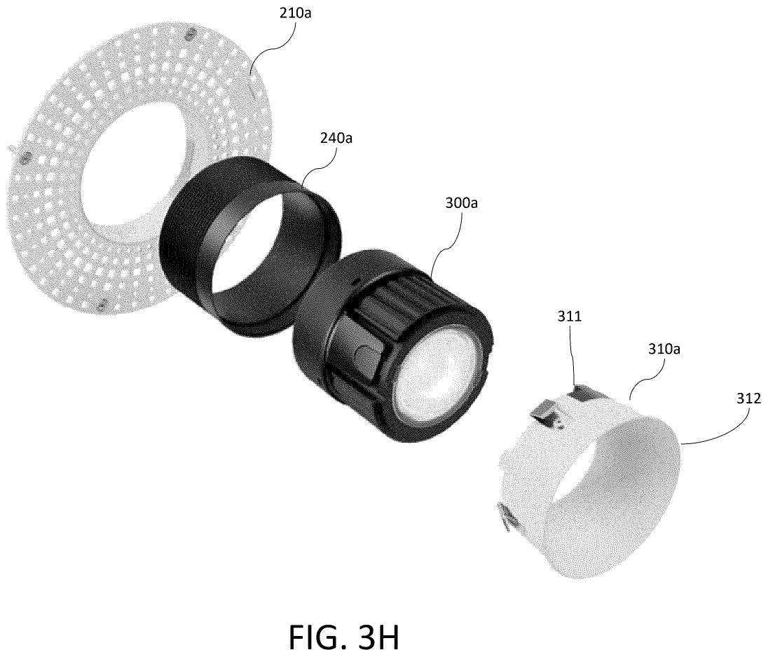

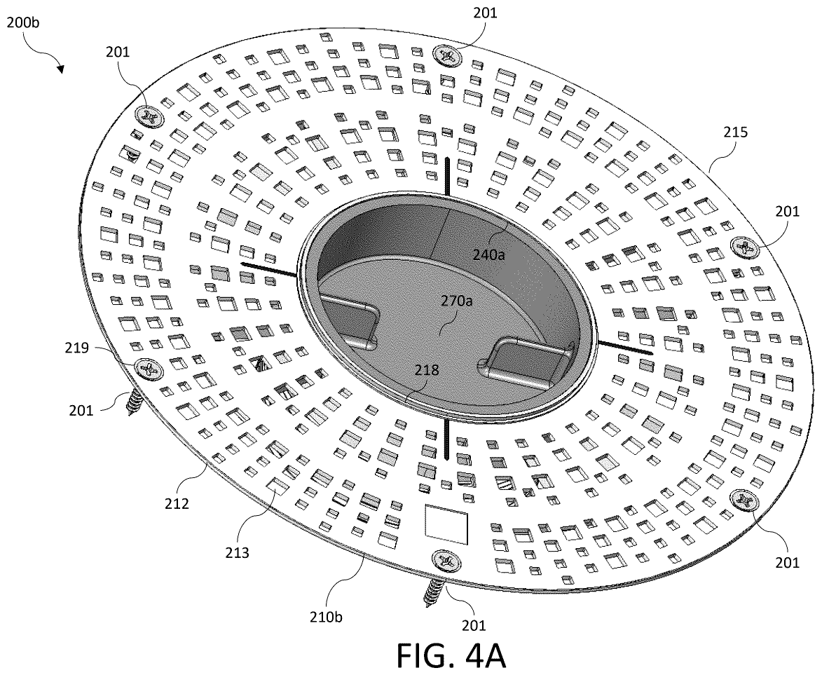

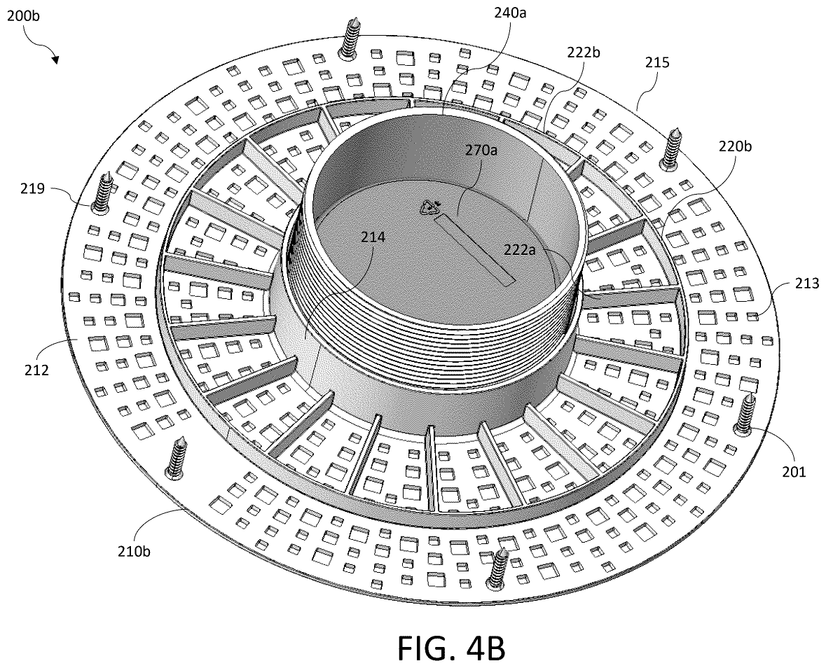

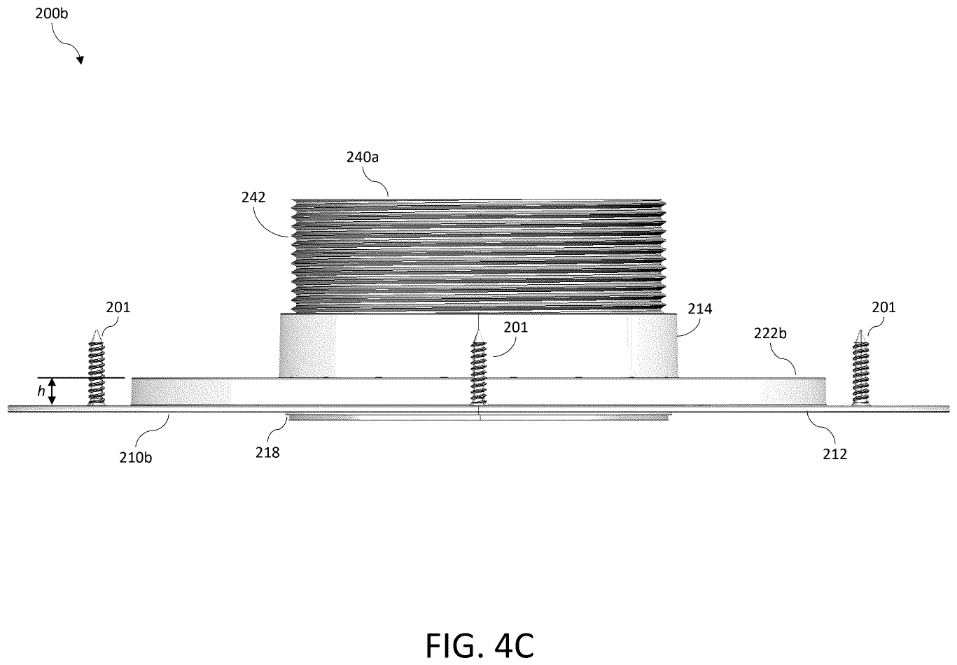

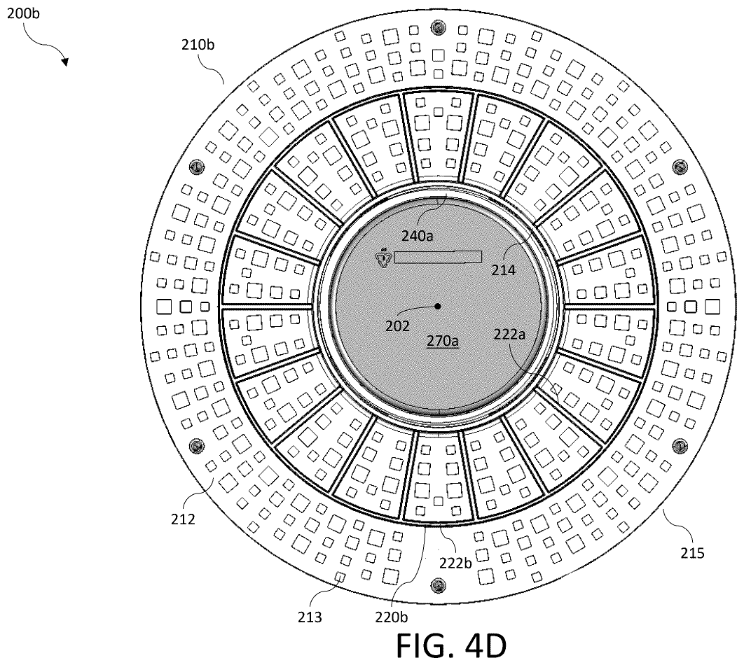

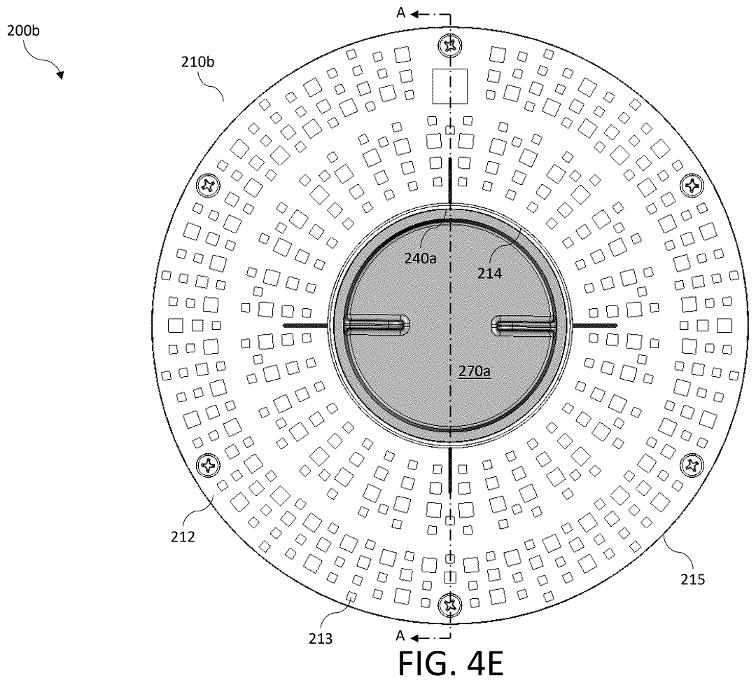

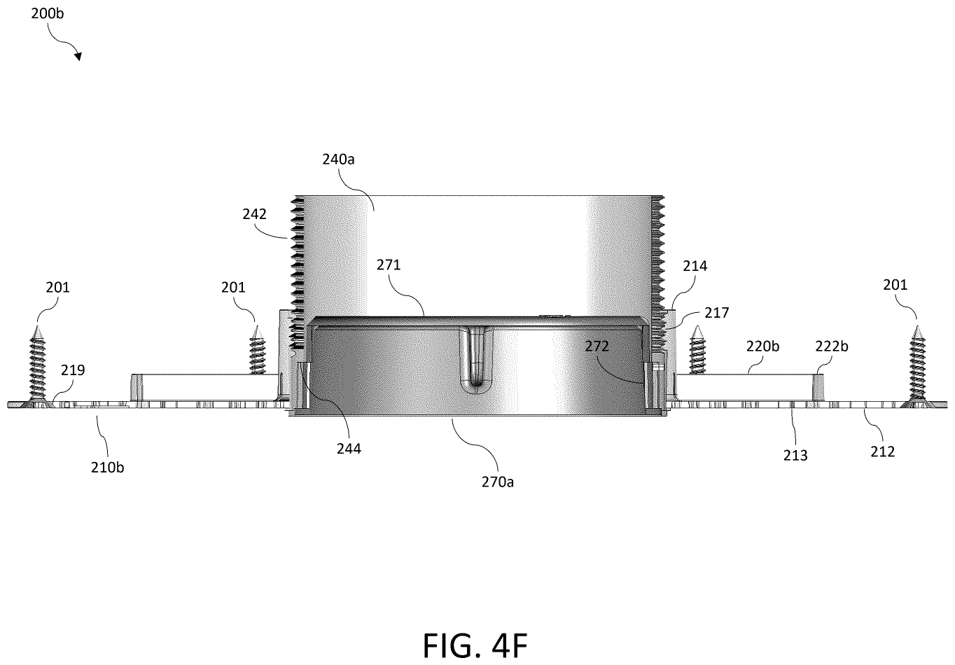

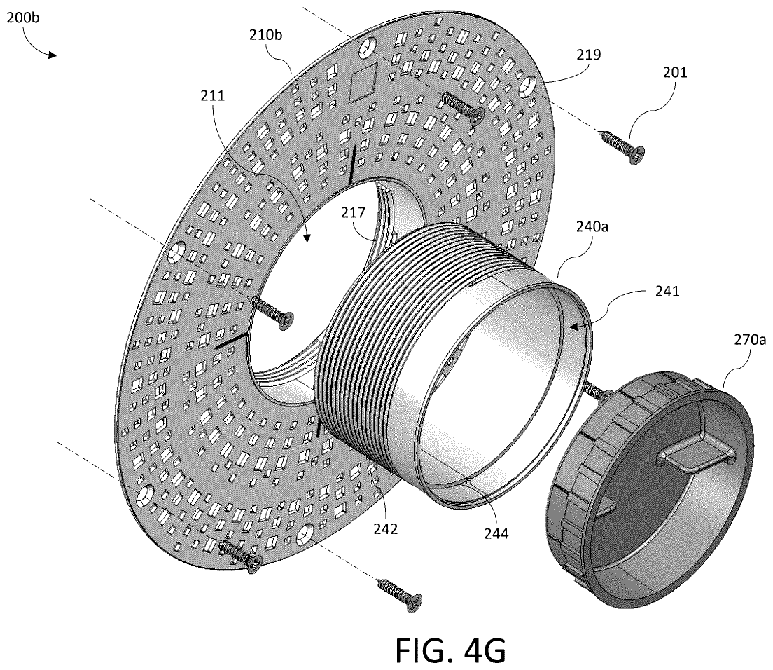

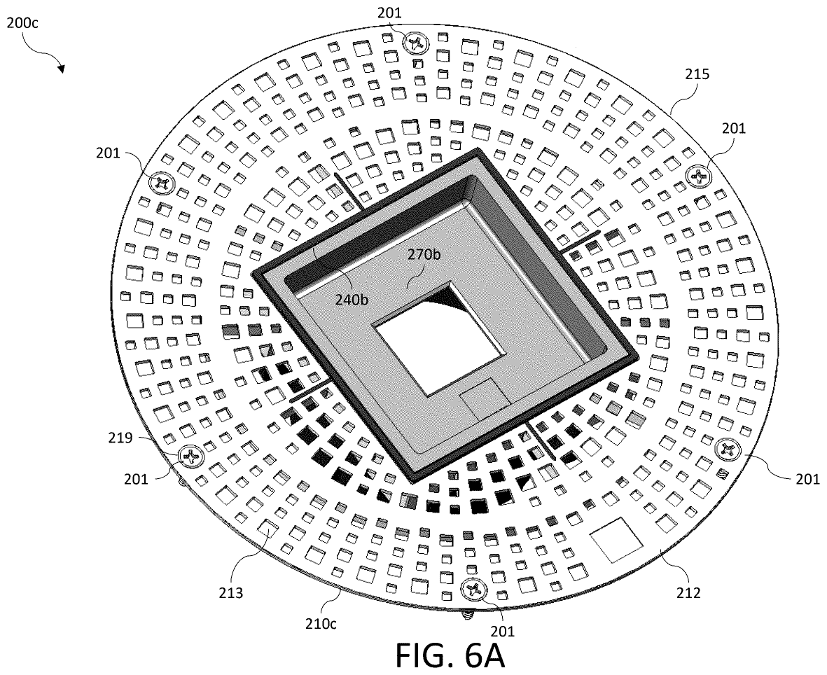

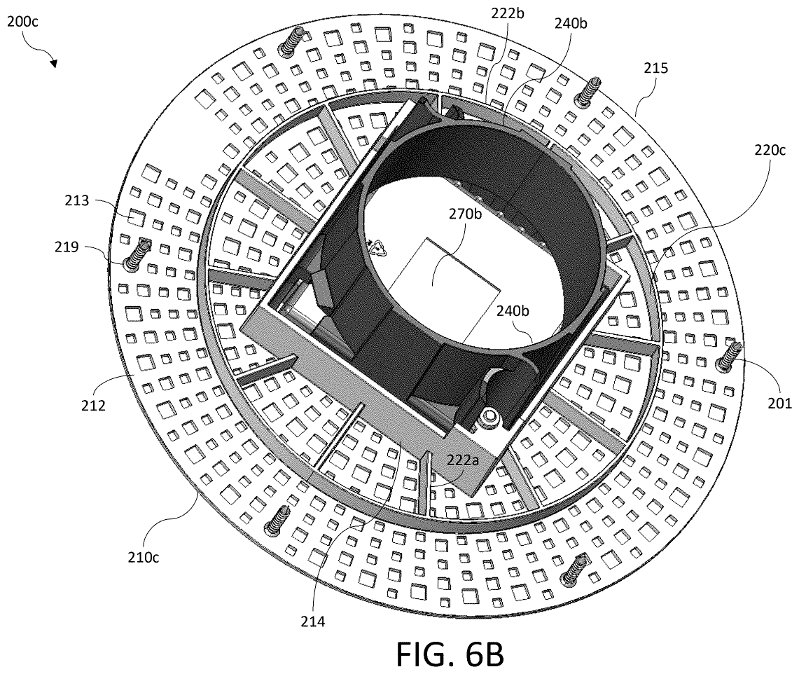

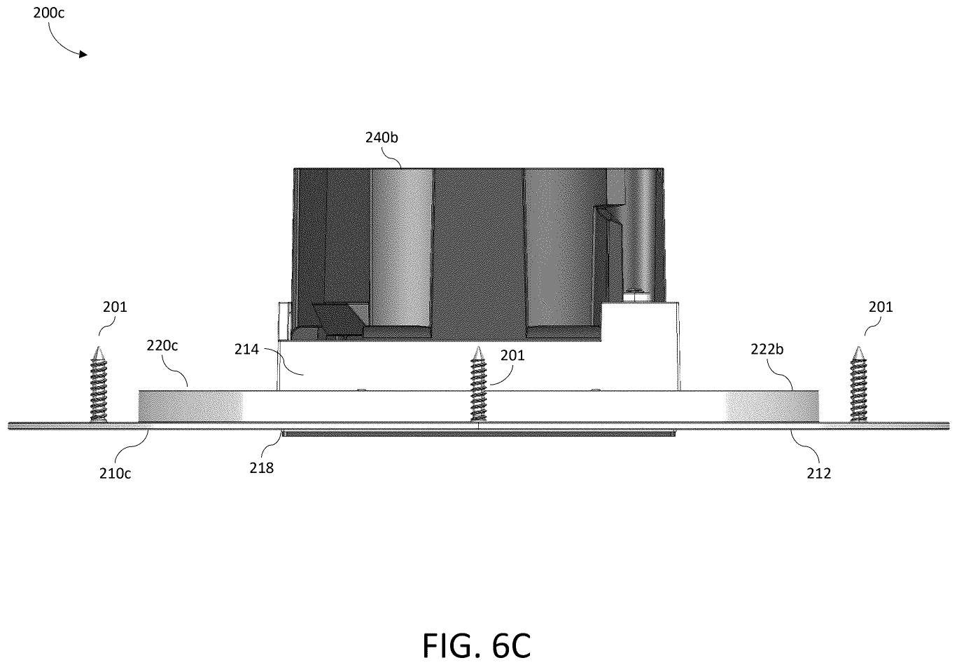

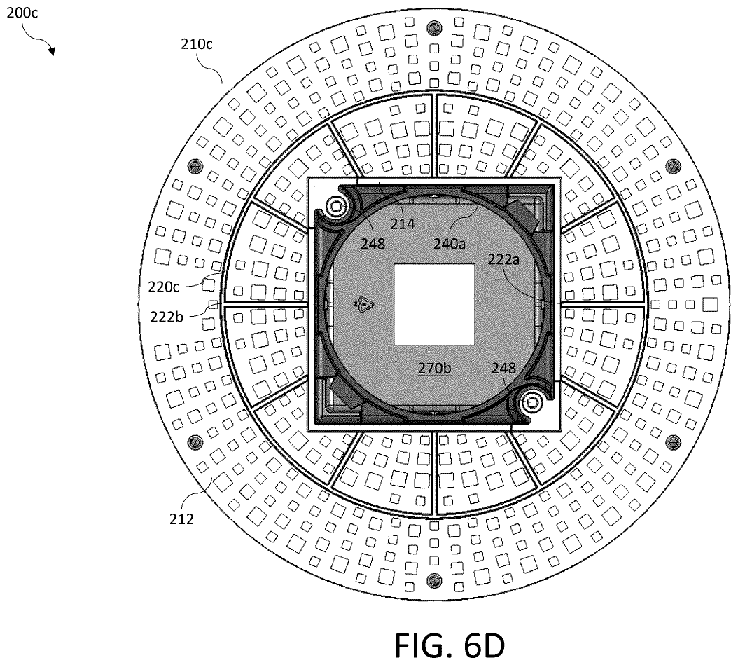

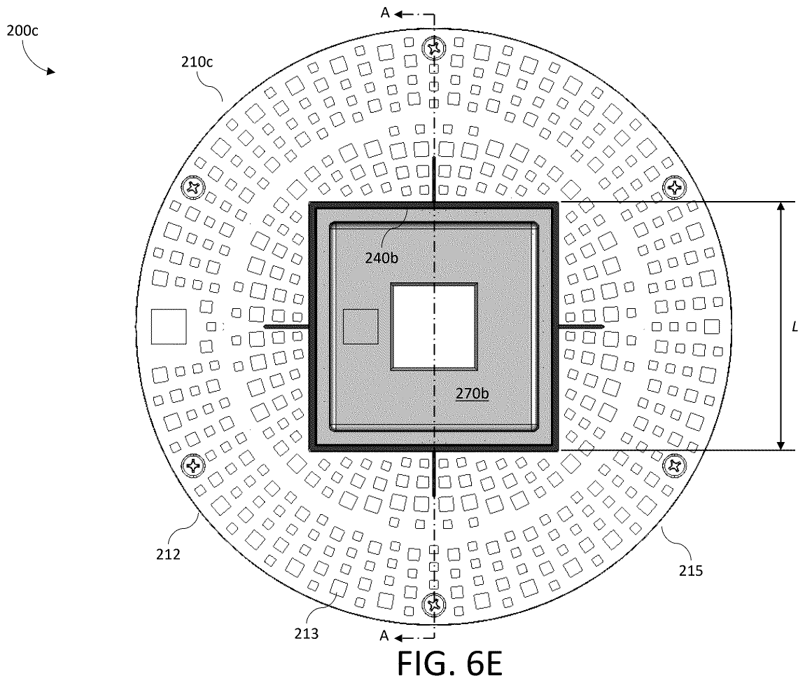

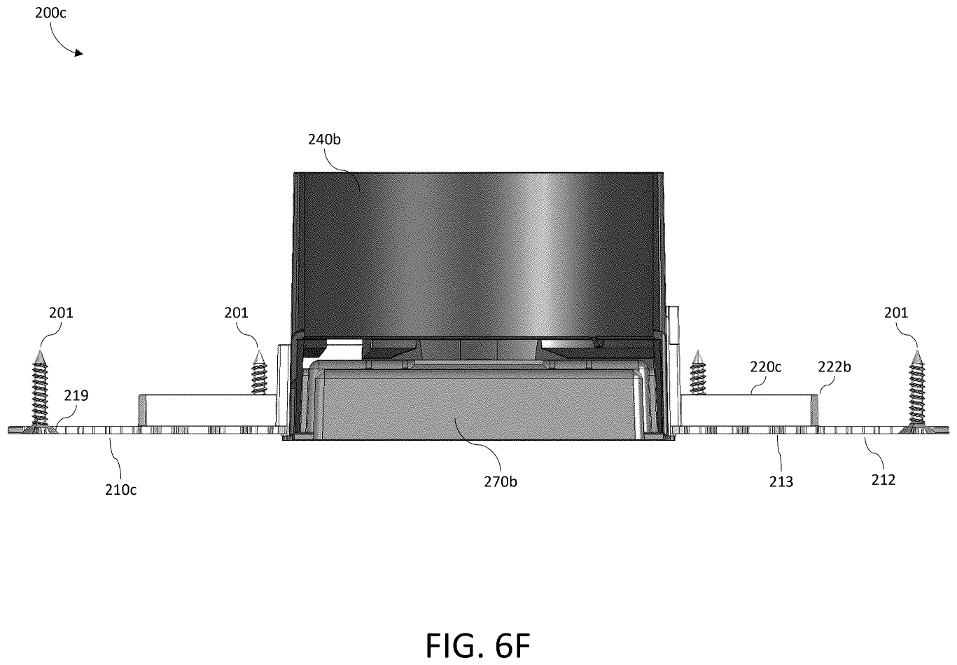

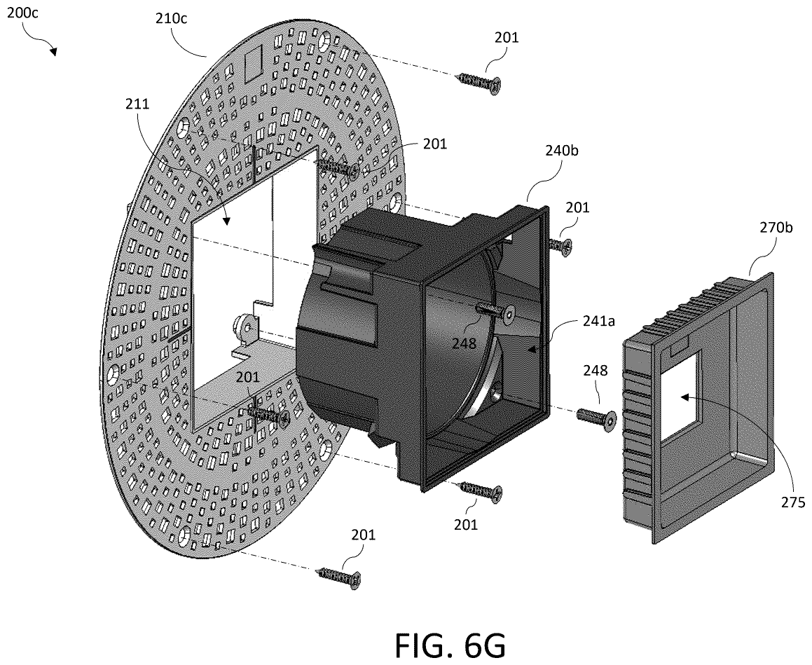

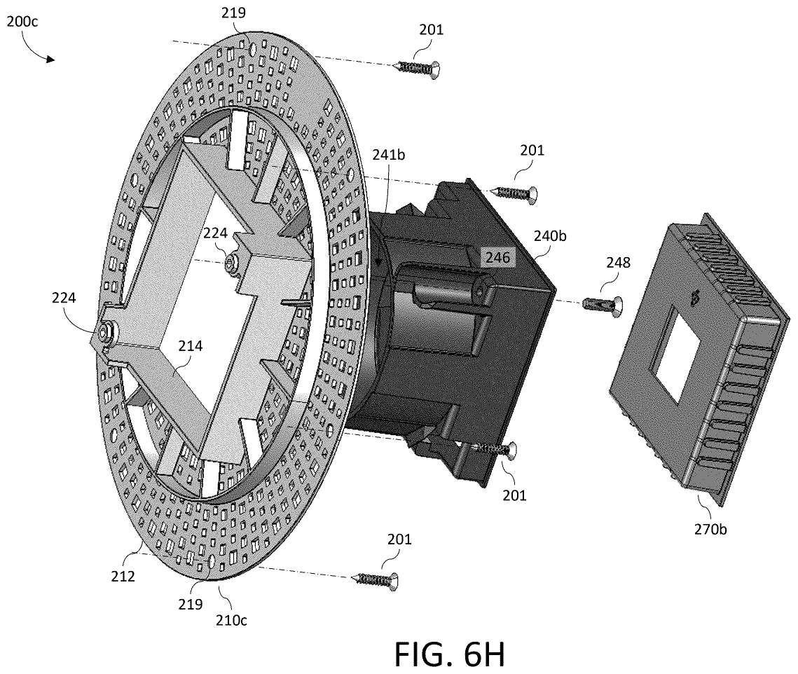

In some implementations, the flange 212 may have both a relatively large width, d₃, and a relatively small thickness, thus making the flange 212 more susceptible to deformation, e.g., due to the load applied by the lighting module and/or the trim. To reduce or, in some instances, mitigate flexing of the flange 212, the mud-in plate 210 may include one or more gussets and/or one or more ribs (generally referred to as a rib structure) to increase the structural rigidity of the flange 212. The gussets and/or the ribs may be formed along the surface of the flange 212 and, in some implementations, may be joined to the sidewall 214 (see, for example, the gussets 220a in the mud-in plate assembly 200a shown in FIGS. 3A-3H and the rib structures 220b and 220c in the mud-in plate assemblies 200b and 200c shown in FIGS. 4A-4G and 6A-6H).

The gussets and/or ribs on the flange 212 may be disposed on the top surface of the flange 212, i.e., the side of the flange 212 that abuts the ceiling drywall 92. Accordingly, the gussets and/or ribs may only be disposed along the portion of the flange 212 suspended across the opening 94. Said another way, the gussets and/or ribs may only be disposed onto the portion of the flange 212 subtended by the width, d₁, of the opening 94. As a result, the gussets and/or ribs may not extend to the outer edge of the flange 212; otherwise, the gussets and/or ribs may physically contact the bottom surface 93 of the ceiling drywall 92 and prevent the top side of the flange 212 from abutting the ceiling drywall 92. It should be appreciated that the portion of the flange 212 most susceptible to deformation is the portion suspended across the opening 94 since the remaining portions of the flange 212 (e.g., the portions of the flange 212 near the outer edge) are designed to abut a hard surface, such as the ceiling 92, which limits deformation. Thus, limiting the placement of the gussets and/or ribs in the manner described above does not adversely affect the structural rigidity of the flange 212 when installed onto the ceiling 92.

The mud-in plate assembly 200 may generally be designed to cover different-shaped openings 94 in the ceiling 92 including, but not limited to, openings 94 shaped as a circle, a square, and a polygon (e.g., a pentagon, a hexagon, an octagon). The opening 211 defined by the sidewall 214 may have various shapes including, but not limited to, a circle, a square, a polygon (e.g., a pentagon, a hexagon, an octagon), one or more slots, a linear track, and any combinations of the foregoing. In some implementations, the mud-in plate assembly 200 may cover an opening 94 in the ceiling 92 having a first shape and provide an opening 211 having a second shape different from the first shape. For example, the opening 94 may be shaped as a circle and the opening 211 may be shaped as a square (see, for example, the mud-in plate assembly 200c shown in FIGS. 6A-6H).

The flange 212 of the mud-in plate 210 may include a plurality of perforations to facilitate application of the joint compound 290 (see, for example, the perforations 213 in the mud-in plate assembly 200a shown in FIG. 3A). The perforations provide, in part, greater surface area for the joint compound 290 to adhere to the mud-in plate 210 and the ceiling drywall 92. Additionally, the perforations may extend across the thickness of the flange 212, thus allowing the joint compound 290 to infiltrate and wrap around portions of the flange 212 to further anchor the joint compound 290 to the mud-in plate 210.

In some implementations, the perforations may be disposed across the flange 212 from the outer edge of the flange 212 to the opening 211 defined by the sidewall 214. Thus, the joint compound 290 may be applied across the entirety of the flange 212 during installation.

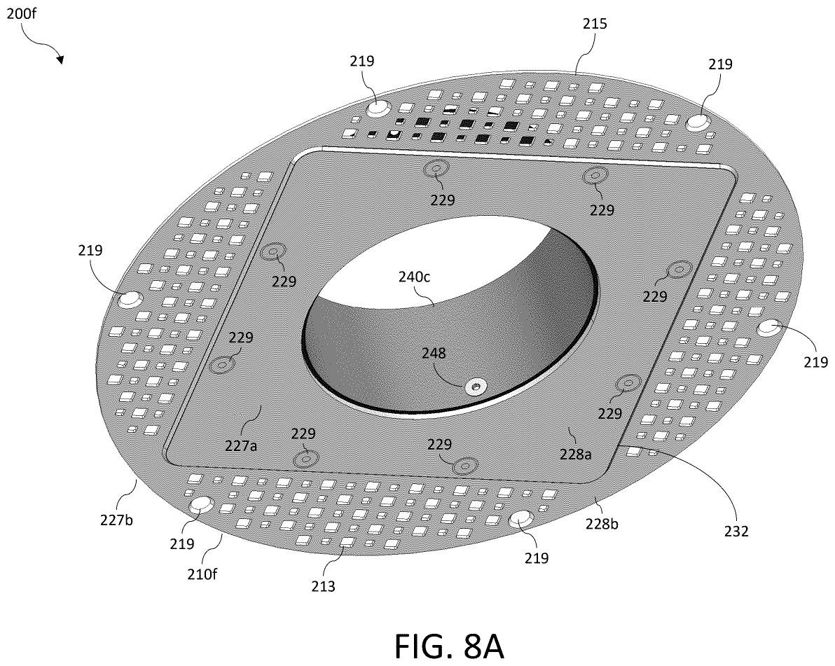

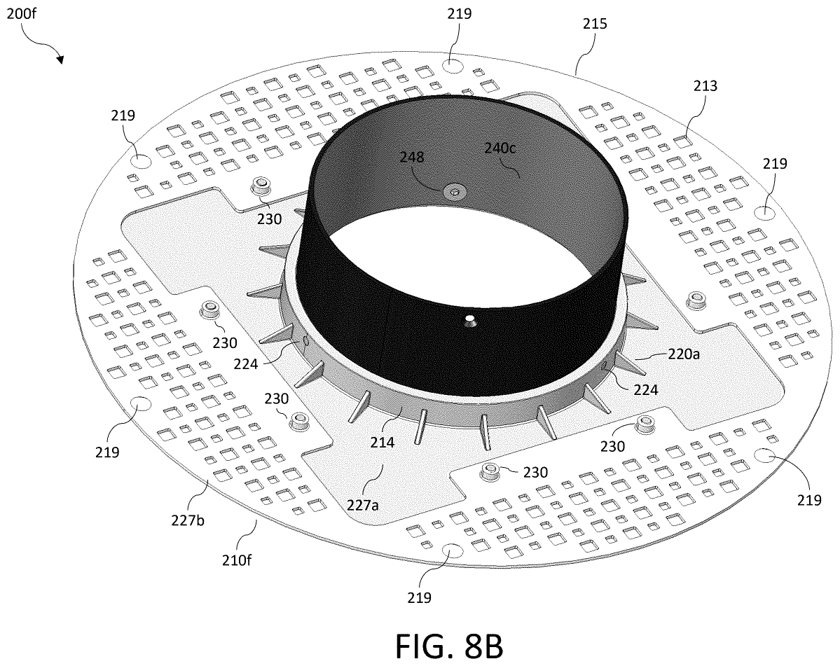

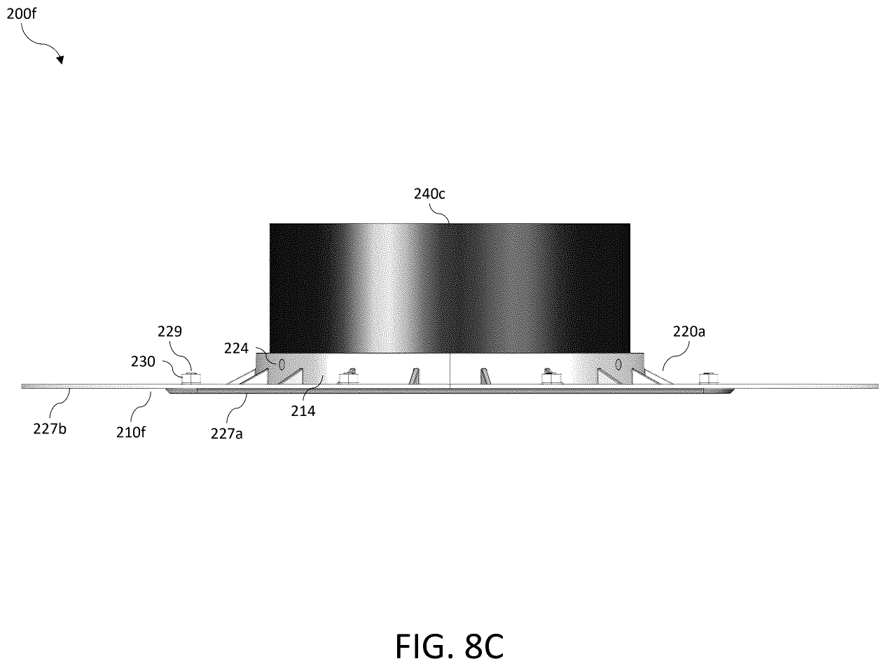

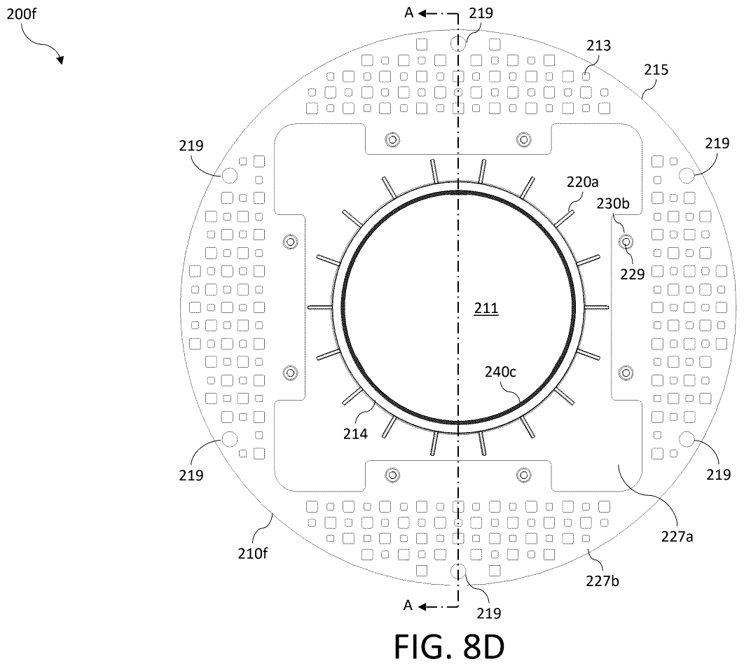

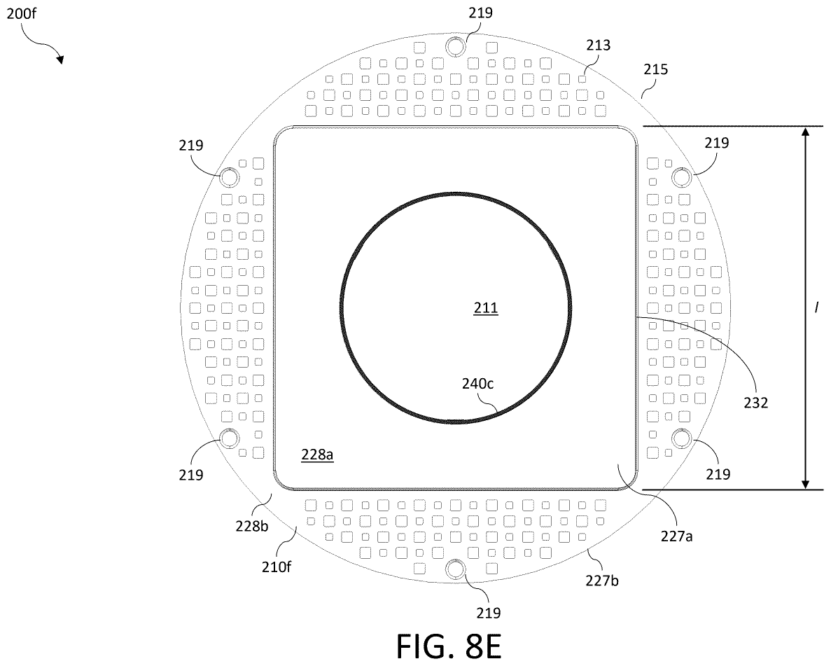

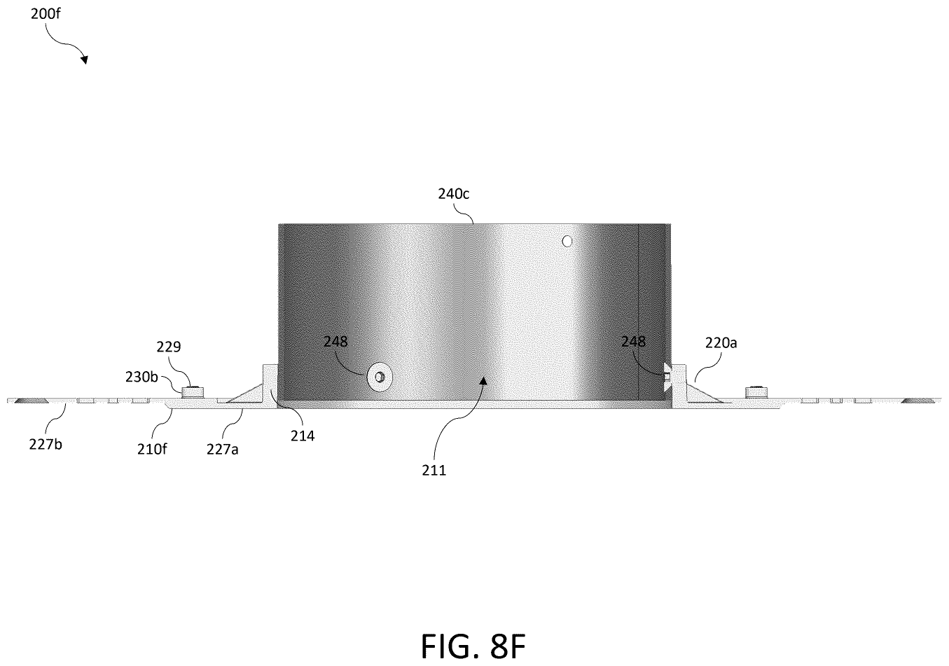

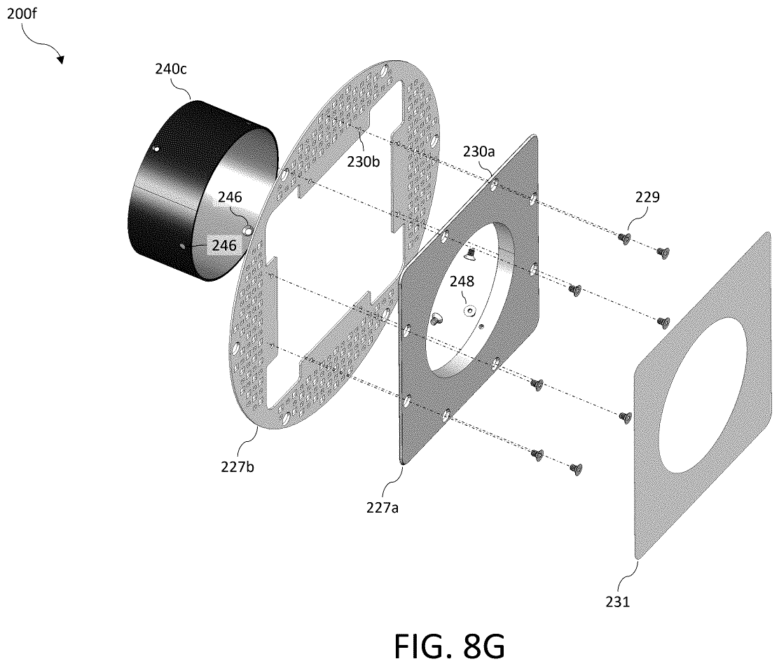

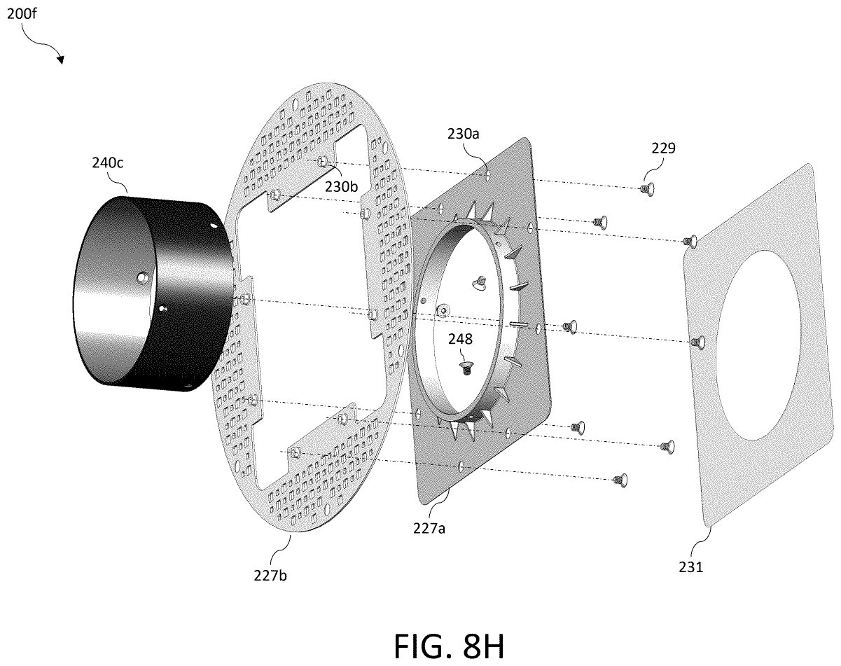

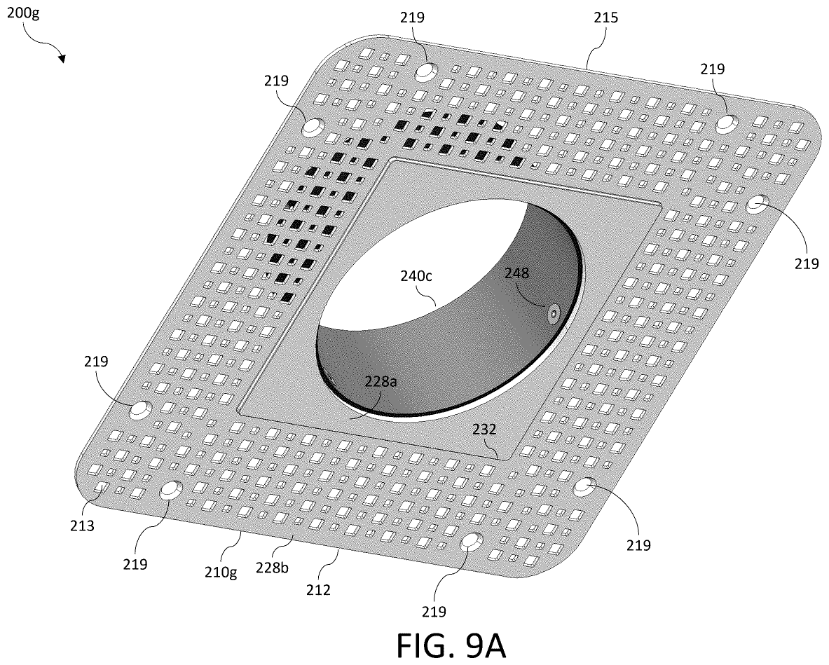

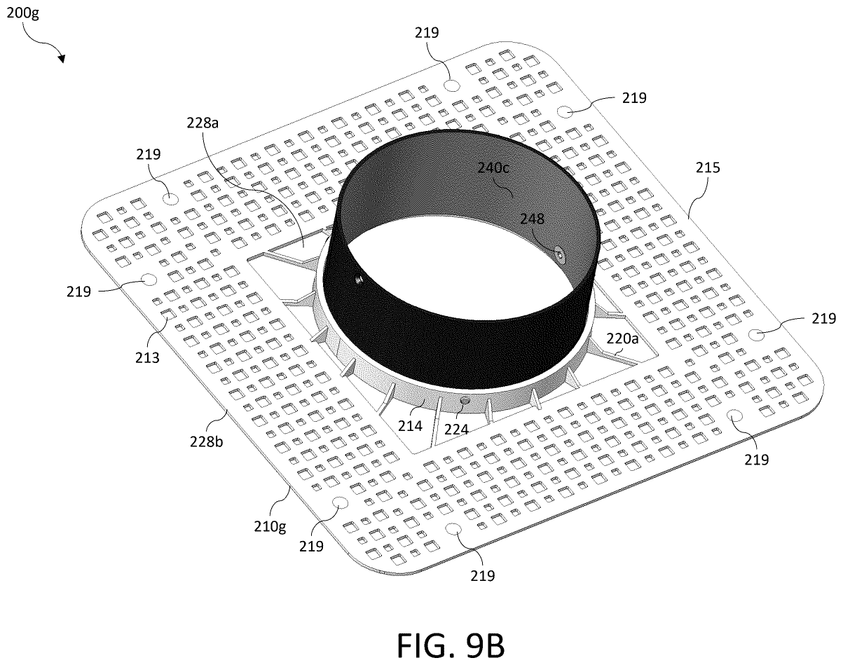

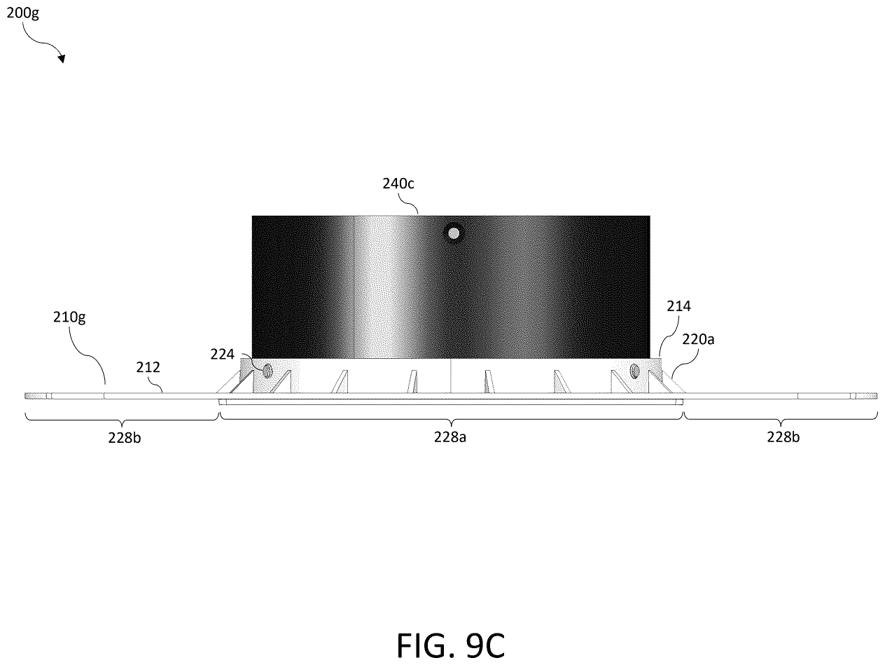

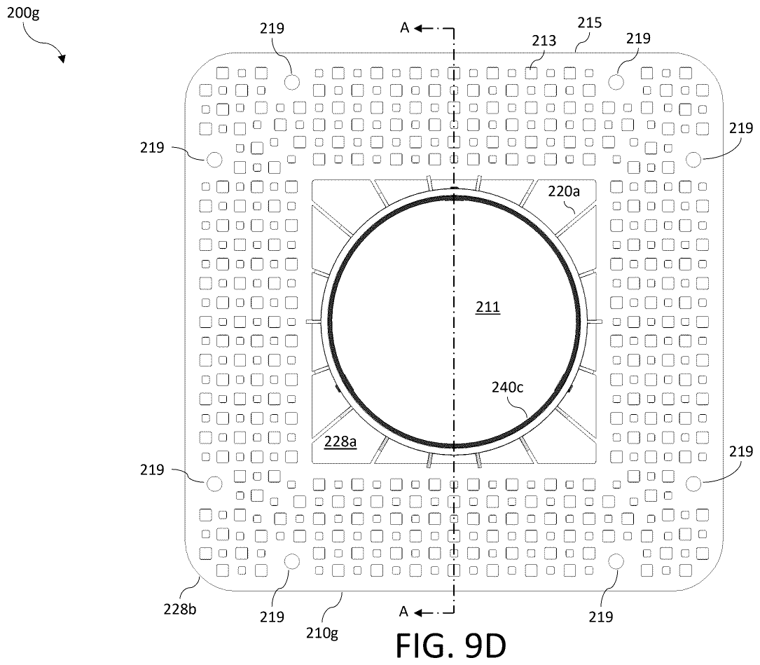

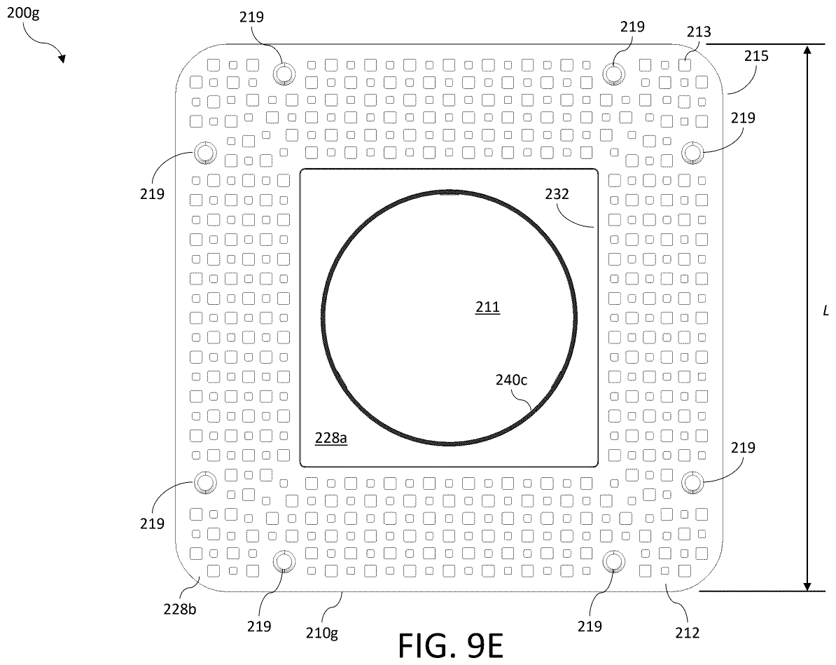

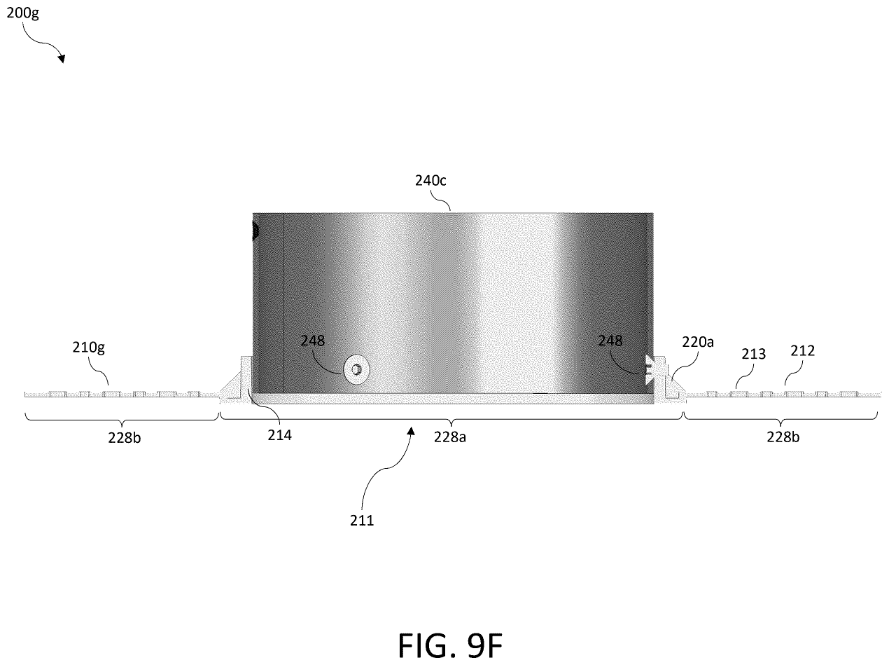

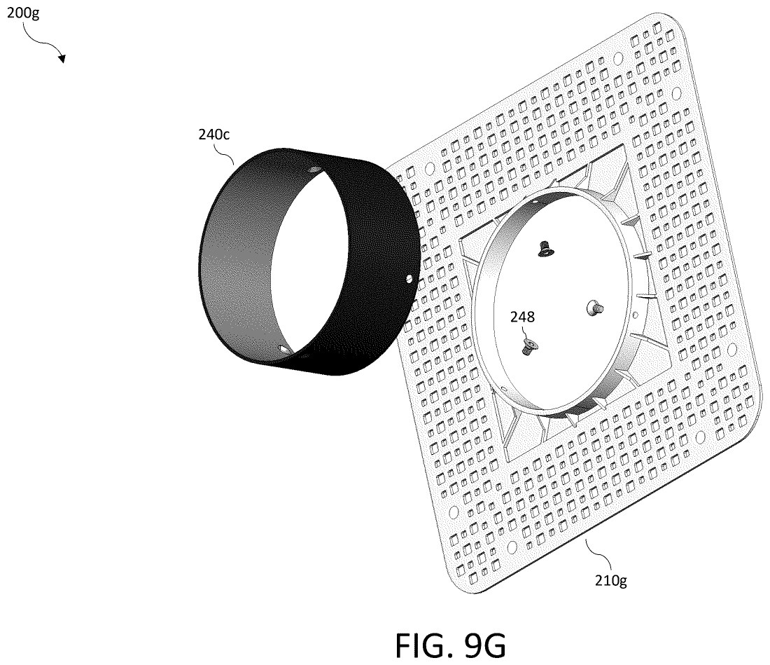

In some implementations, the perforations may only be disposed on a portion of the flange 212 (see, for example, the mud-in plate assemblies 200f and 200g shown in FIGS. 8A-8H and 9A-9G, respectively). For example, the perforations may only be disposed on an outer portion of the flange 212 located near the outer edge of the flange 212 while an inner portion of the flange 212 located near the opening 211 may not include any perforations. In some implementations, the inner portion of the flange 212 may not include any surface features. Thus, the inner portion of the flange 212 may be relatively smooth.

During installation, the joint compound 290 may be primarily applied to the portion of the flange 212 with the perforations (e.g., the outer portion of the flange 212), thus reducing or, in some instances, mitigating accumulation of the joint compound 290 near the opening 211. As described above, any accumulation of joint compound near the opening of a lighting fixture may adversely affect the installation of the lighting module 300 and/or the trim 310, e.g., by altering the placement of the lighting module 300 and/or the trim 310 or, in some instances, by blocking a portion of the opening 211, thus preventing insertion of the lighting module 300 and/or the trim 310 through the opening 211.

It should be appreciated that the joint compound 290 may be applied along the portion of the inner portion that joins the outer portion with the perforations, for example, to facilitate blending of the inner portion with the surrounding ceiling drywall. In implementations where the inner portion of the flange 212 is formed from a polymer, a primer may be applied to at least the bottom surface of the inner portion to improve the adhesion of any joint compound 290 applied to the inner portion. In implementations where the inner portion of the flange 212 is formed from gypsum, the bottom surface of the inner portion may not include a primer. Rather, any joint compound 290 applied to the inner portion may be applied directly to the gypsum.

In some implementations, the perforations on the flange 212 may be uniform in size and/or shape. The perforations may be uniformly distributed across the portion of the flange 212 supporting the perforations. For example, the distance between adjacent perforations may be approximately equal across the flange 212.

In some implementations, the perforations may include different-sized perforations (e.g., perforations that are relatively larger or smaller in size) and/or different-shaped perforations (e.g., perforations that are shaped as a circle, a square, or a polygon). In some implementations, the perforations may not be uniformly distributed across the portion of the flange 212 supporting the perforations. For example, the outer portion of the flange 212 near the outer edge may include a higher density of perforations (e.g., perforations that are more closely spaced together) and the inner portion of the flange 212 near the opening 211 may include a lower density of perforations (e.g., perforations that are spaced further apart). In another example, the outer portion of the flange 212 near the outer edge may include a lower density of perforations and the inner portion of the flange 212 near the opening 211 may include a higher density of perforations.

In some implementations, the mud-in plate 210 may include a ridge surrounding the opening 211 (see, for example, the ridge 218 in the mud-in plate assembly 200a shown in FIG. 3A). The ridge may extend from the bottom surface of the flange 212 downwards. Thus, the bottom end of the ridge may correspond to the lowest portion of the mud-in plate assembly 200a when the mud-in plate assembly 200a is installed into a ceiling. The ridge may serve as a guide of how much joint compound 290 to apply to the mud-in plate assembly 200. For example, when a trowel is used to apply the joint compound 290 to the mud-in plate assembly 200, the trowel may scrape along the ridge to limit the amount of the joint compound 290 applied. For instance, the thickness of the joint compound 290 applied to the bottom surface of the flange 212 may be equal to or less than the height of the ridge, which may be defined as the distance between the bottom end of the ridge and the bottom surface of the flange 212. In this manner, the ridge may make it easier to blend the mud-in plate assembly 200 with the surrounding ceiling drywall 92 and reduce the formation of any undesirable bulges between the mud-in plate assembly 200 and the surrounding ceiling drywall 92. The ridge may also reduce or, in some instances, prevent buildup of joint compound 290 around the opening 211, thus preserving the desired shape and size of the opening 211.

In some implementations, the mud-in plate assembly 200 may include a collar 240 to provide an interface to physically couple the lighting module 300 and/or the trim 310 to the mud-in plate 210. As shown in FIG. 1, the collar 240 may be at least partially disposed in the opening 211 formed by the sidewall 214 of the mud-in plate 210 and directly coupled to the sidewall 214 of the mud-in plate 210. In some implementations, the collar 240 may be a tube-like component that defines an opening 241. The collar 240 may conform, at least in part, to the shape of the desired opening 211 for the lighting module 300 (e.g., a circular opening, a square opening). The lighting module 300 and/or the trim 310 may be directly mounted to an interior surface of the collar 240 via an attachment mechanism, such as a friction clip. Thus, in some implementations, the lighting module 300 and the trim 310 may only be physically supported by the mud-in plate assembly 200. Said another way, the lighting module 300 and the trim 310 may not physically contact the housing 120 or any other components of the previously installed recessed lighting fixture.

In some implementations, the collar 240 may include a lip 244 (also referred to herein as a “recessed step”). For example, FIG. 3G shows the lip 244 may extend around the interior surface of the collar 240. The lip 244 may facilitate the positioning of a trim 310 such that a bottom end 312 of the trim 310 is aligned with the bottom surface 93 of the ceiling 92. For example, the trim 310 in FIG. 3H may include a top end 311 that, when inserted into the collar 240, abuts the lip 244. The trim 310 may be dimensioned such that the bottom end 312 is aligned to the bottom end of the collar 240 and/or the surface of the ceiling 92.

In some implementations, the collar 240 may be vertically adjustable with respect to the mud-in plate 210. The vertical position of the collar 240 may be adjusted, for example, to align the bottom surface 93 of the collar 240 with the bottom surface 93 of the ceiling 92 surrounding the sidewall opening 211. More generally, the collar 240 and, by extension, the lighting module 300 and the trim 310 may be positioned at a desired depth with respect to the bottom surface 93 of the ceiling 92. In some implementations, the vertical adjustment of the collar 240 may be accomplished using a rotation tool inserted into the opening of the collar 240 (see, for example, the rotation tool 270a in FIGS. 3A-3G). For example, the rotation tool may be directly coupled to the interior surface of the collar 240 via a friction fit. Additionally, the collar 240 may include an exterior surface with threads (see, for example, the threads 242 on the exterior surface 243 of the collar 240 in FIG. 3B) engaged with corresponding threads on an interior surface of the sidewall 214 of the mud-in plate 210 (see, for example, the threads 217 on the interior surface 216 of the sidewall 214 in FIG. 3G). When the rotation tool is turned, the rotational motion of the collar 240 may result in vertical displacement due to the threaded connection of the collar 240 and the sidewall 214.

It should be appreciated that a vertically adjustable collar 240 is a non-limiting example. In some implementations, the collar 240 is an optional component. For example, the mud-in plate assembly 200 of FIG. 1 may not include the collar 240. Rather, the lighting module 300 and/or the trim 310 may be securely coupled to the interior surface of the sidewall 214. In some implementations, the collar 240 may be securely coupled to the mud-in plate 210 (see, for example, the mud-in plate assemblies 200c-200g). In some implementations, the collar 240 may be integrally formed together with the mud-in plate 210. For example, the collar 240 may effectively become the sidewall 214 of the mud-in plate 210. Said another way, the flange 212 of the mud-in plate 210 may be joined directly to the collar 240. Accordingly, in implementations where the collar 240 effectively becomes the sidewall 214, the collar 240 and the sidewall 214 are interchangeable terms.

The rotation tool may also serve to enclose and protect the interior surface of the collar 240 and/or the sidewall 214 during installation. In particular, the rotation tool may appreciably reduce or, in some instances, mitigate the application of joint compound 290, drywall tape, paint, and/or any other substances applied to the mud-in plate assembly 200 during installation onto the interior surfaces of the collar 240 and/or the sidewall 214. In some implementations, once the joint compound 290 is applied and the vertical position of the collar 240 is adjusted, the rotation tool may be removed to allow insertion of the lighting module 300 and the trim 310. It should be appreciated that, in some implementations, the joint compound 290 may be sanded and/or painted before the rotation tool is removed.

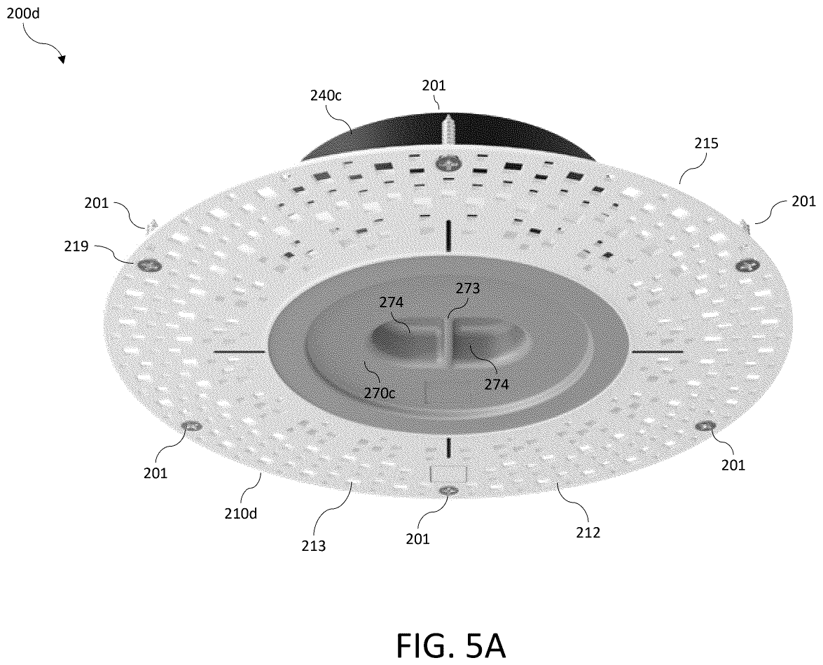

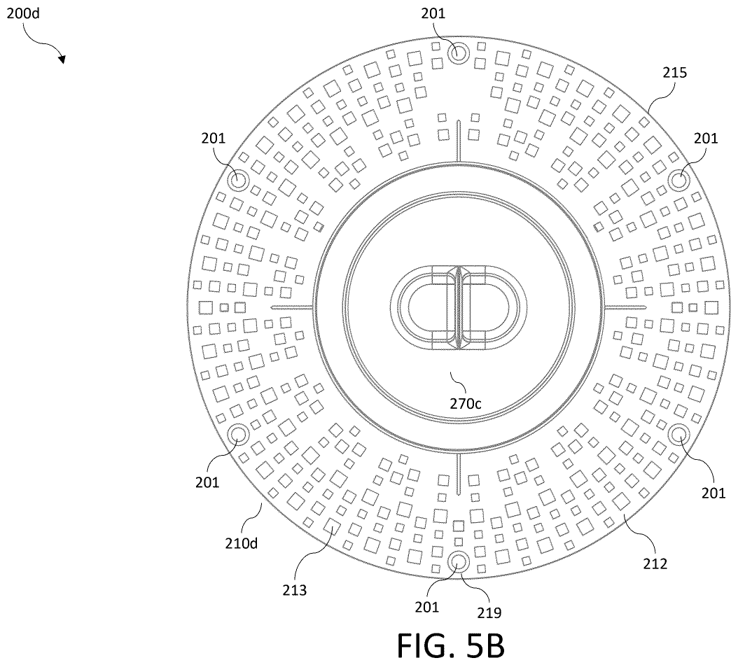

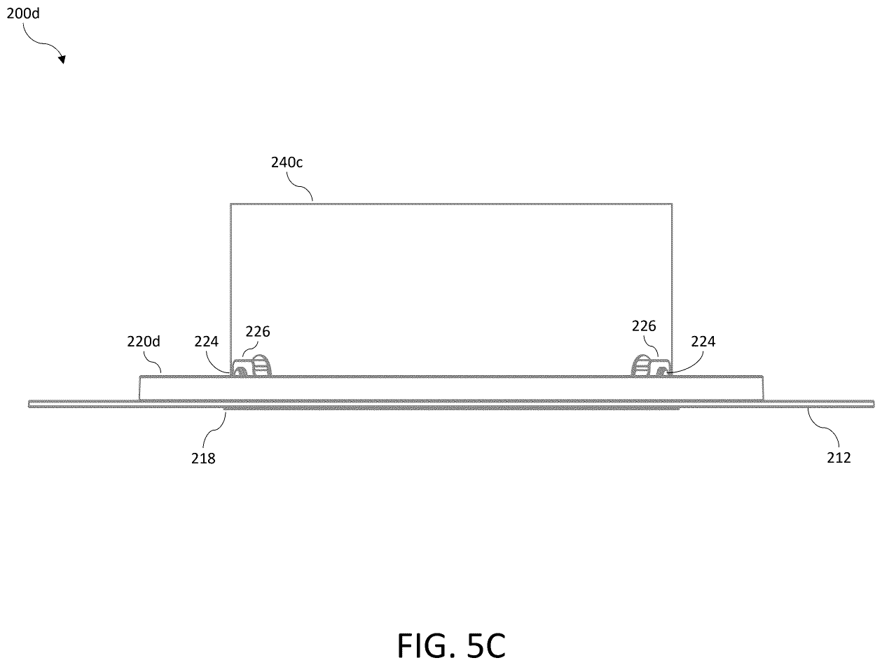

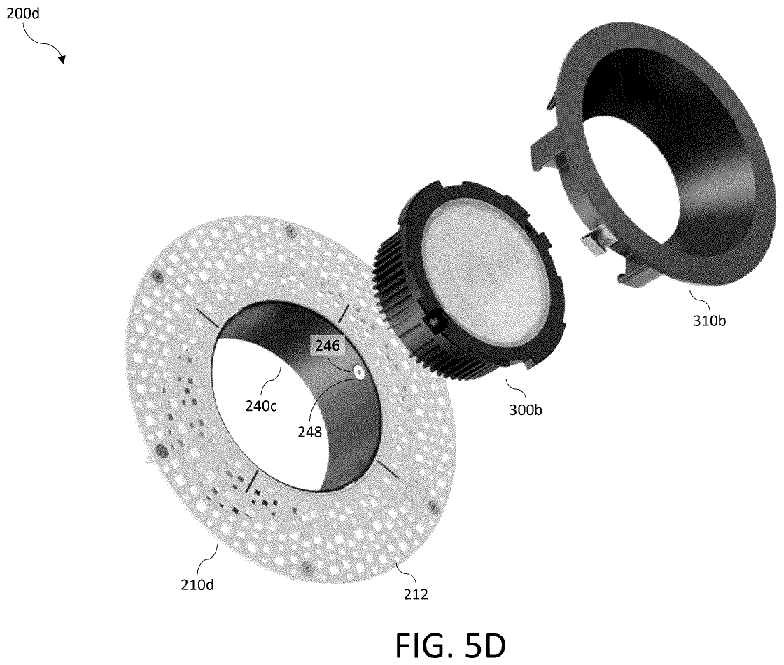

In implementations where the collar 240 is not vertically adjustable (e.g., the collar 240 is securely coupled to the mud-in plate 210 or integrally formed together with the mud-in plate 210) or the collar 240 is not included, the mud-in plate assembly 200 may include an insert to enclose the opening 211 of the mud-in plate 210 and protect the interior surfaces of the sidewall 214 and/or the collar 240 during application of the joint compound 290 and/or other substances. See, for example, the inserts 270b-270e shown in FIGS. 5A, 6A, 7A, and 11C.

In some implementations, the collar 240 may be removable from the mud-in plate assembly 200. For example, the collar 240 may be removed to facilitate servicing of components of the lighting fixture 100 and/or the junction box located above and behind the ceiling drywall 92. After servicing is complete, the collar 240 may be inserted into the mud-in plate 210 before installing the lighting module 300 and/or the trim 310.

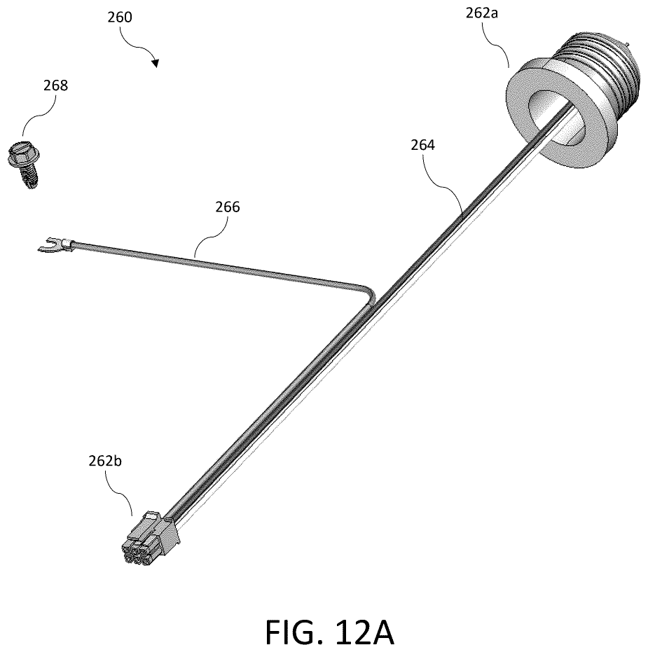

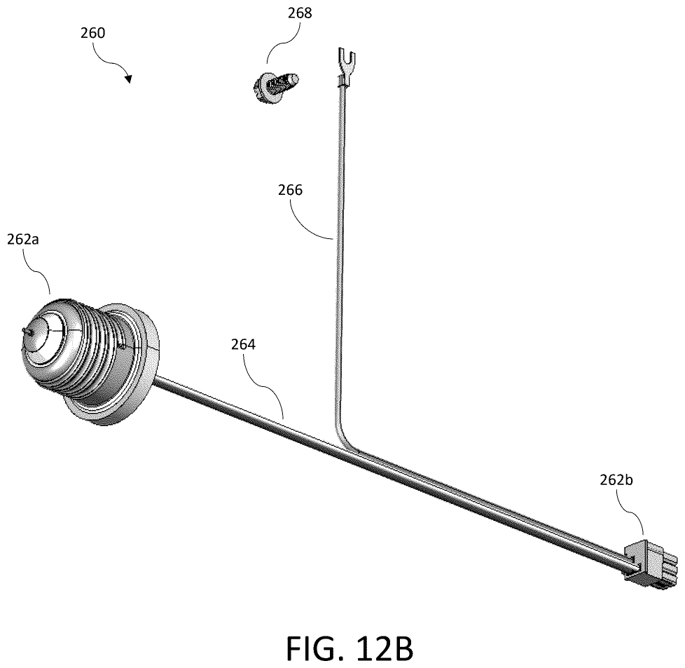

Before the lighting module 300 and the trim 310 are inserted into the mud-in plate assembly 200, a cable and/or adapters may be installed to facilitate an electrical connection with any existing electrical connectors in the recessed lighting fixture 100 (e.g., the socket 128) and an electrical connection with the lighting module 300 (e.g., via a compatible electrical connector). For example, FIG. 1 shows the recessed lighting fixture 100 may include a cable 260 with a socket connector 262a to connect to the socket 128 and a lighting module connector 262b to connect to the lighting module 300. Generally, the cable and/or adapters may supply electrical power and/or electrical control signals to the lighting module 300, e.g., to facilitate dimming and/or adjustments to the correlated color temperature of the emitted light. In some implementations, the cable and/or adapters may also provide a ground connection. A non-limiting example of a cable 260 with different electrical connectors is shown in FIGS. 12A and 12B.

The various components of the mud-in plate assembly 200 including, but not limited to, the mud-in plate 210, the collar 240, and the rotation tool 270 may be formed from various materials including, but not limited to, a metal (e.g., die-cast aluminum, sheet metal), a polymer (e.g., polyvinyl chloride (PVC), acrylonitrile butadiene styrene (ABS), polycarbonate (PC), polyurethane (PU), polyethylene, polyethylene terephthalate, polypropylene, and polystyrene), glass fiber, gypsum, and any combinations of the foregoing materials. For example, the components of the mud-in plate assembly 200 and, in particular, the mud-in plate 210, may be formed from a composite material, such as a 30% glass filled polycarbonate (e.g., LEXAN™ FR Resin 3413R). In another example, the components of the mud-in plate assembly 200 and, in particular, the mud-in plate 210, may be formed from G40 steel.

In some implementations, the mud-in plate 210 may be a unitary component formed from a single material. In some implementations, the mud-in plate 210 may be formed from different materials. For example, the mud-in plate 210 may include an inner plate formed from a first material (e.g., plastic) and an outer plate joined to the inner plate formed from a second material (e.g., metal) having a greater mechanical stiffness than the inner plate (see, for example, the mud-in plate assembly 200f shown in FIGS. 8A-8H).

In implementations where a primer is applied to at least a portion of the mud-in plate assembly 200 to improve adhesion of the joint compound 290 to the mud-in plate assembly 200, the primer may comprise a waterborne acrylic urethane primer/sealer (e.g., STIX SXA-110).

### 1.1 an Example Method of Installing the Mud-In Plate Assembly for a Trimless Recessed Lighting Fixture

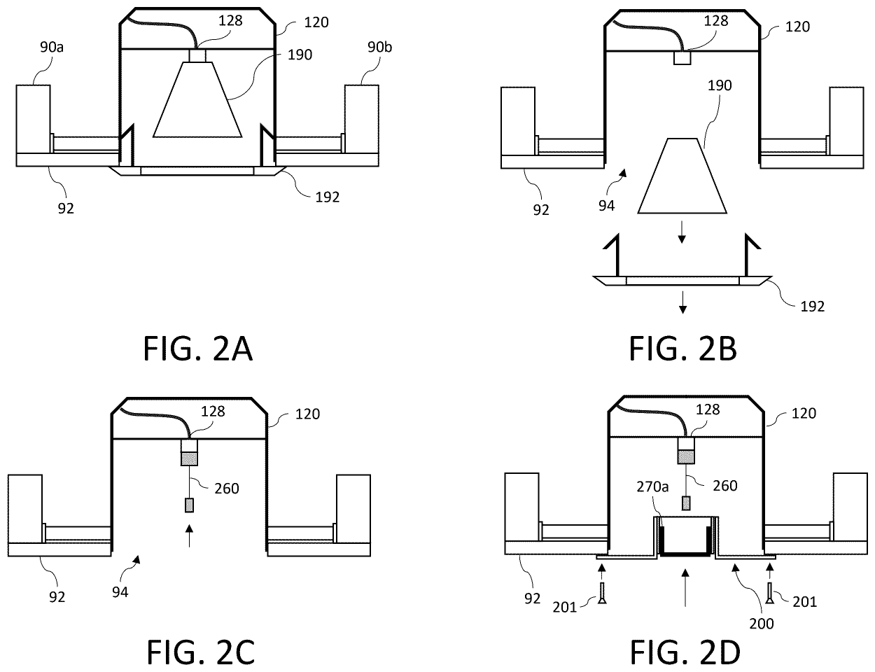

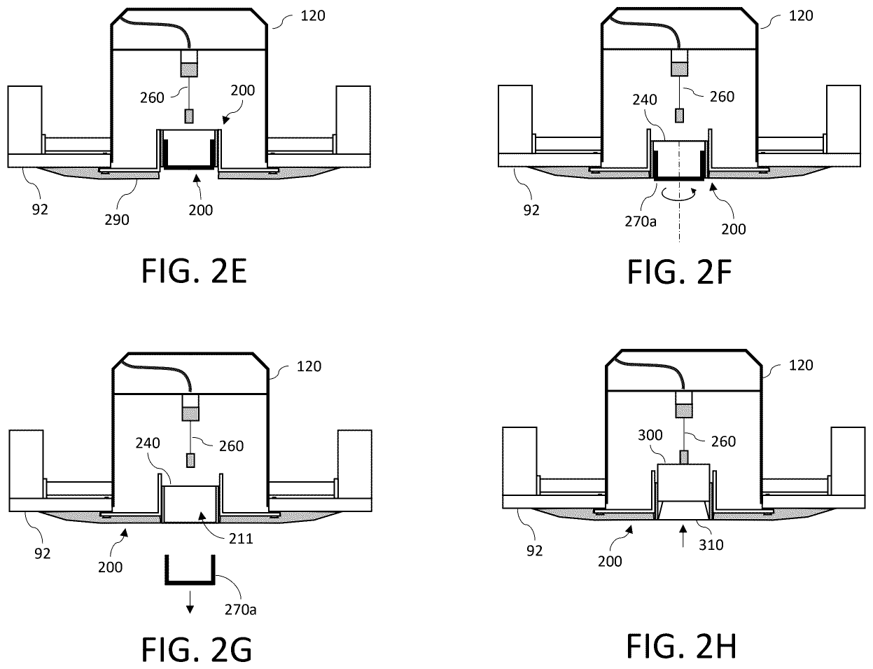

FIGS. 2A-2H show an example method for retrofitting a recessed lighting fixture 100 using the mud-in plate assemblies described herein (e.g., the mud-in plate assembly 200). As shown in FIG. 2A, the previously installed recessed lighting fixture 100 may initially include a conventional light source 190 (e.g., an incandescent lamp, a fluorescent lamp) and a conventional trim 192 covering the opening 94 in the ceiling 92 and, by extension, the opening 121 of the housing 120. The method may begin by removing the conventional light source 190 and the trim 192 to provide access to the cavity 122 of the housing 120 as shown in FIG. 2B. The next step may then be installing an electrical cable and/or adapter(s) to facilitate connection between: A) an existing electrical connection used in the recessed lighting fixture 100 (e.g., the socket 128); and B) an electrical connection for the lighting module 300. As a non-limiting example, FIG. 2C shows an electrical cable 260 may be connected to the socket 128 of the housing 120 via an electrical connector 262a. The electrical cable 260 may further include an electrical connector 262b configured for connection to the lighting module 300. In some implementations, the cable 260 may further include a ground wire. FIGS. 12A and 12B show an example cable 260 that may be installed during the step shown in FIG. 2B.

The next step may then be mounting the mud-in plate assembly 200 to the ceiling drywall 92 as shown in FIG. 2D. As shown, this may be accomplished using one or more fasteners 201 to securely couple the flange 212 of the mud-in plate 210 in the mud-in plate assembly 200 to the bottom surface 93 of the ceiling drywall 92 such that the mud-in plate 210 covers the opening 94 of the ceiling drywall 92 and, by extension, the opening 121 of the housing 120. In some implementations, a rotation tool 270a may be initially mounted to the mud-in plate 210 to enclose the opening 211 of the mud-in plate 210. In some implementations, the rotation tool 270a may be inserted into the opening 211 of the mud-in plate 210 after the mud-in plate assembly 200 is mounted to the ceiling drywall 92.

Thereafter, the next step may be applying joint compound 290 onto the flange 212 of the mud-in plate 210 as shown in FIG. 2E. The application of the joint compound 290 may give the appearance that the ceiling drywall 92 extends to the opening 211 of the mud-in plate 210, thus providing a seamless appearance with the surrounding ceiling drywall 92. It should be appreciated that the thickness of the joint compound 290 shown in FIG. 2E is exaggerated to make clear where the joint compound 290 is applied. In practice, the joint compound 290 may have a relatively small thickness sufficient to cover the flange 212 of the mud-in plate 210 such that the coats of joint compound 290 are not readily discernable from the surrounding ceiling drywall 92. For example, the joint compound 290 may not exhibit any appreciable bulge on and/or near the mud-in plate assembly 200. During this step, the rotation tool 270a may appreciably reduce or, in some instances, prevent the inadvertent application of joint compound 290 to the interior surfaces of the sidewall 214 of the mud-in plate 210 and/or the collar 240 if present in the mud-in plate assembly 200. Once the joint compound 290 is set, it may be sanded, for example, to blend the joint compound 290 with the surrounding ceiling drywall 92. Thereafter, one or more coatings of primer and/or paint may be applied to the joint compound 290.

In implementations where the mud-in plate assembly 200 includes the collar 240, the next step following application of the joint compound 290 may be adjusting the vertical position of the collar 240 via the rotation tool 270a such that the bottom end of the collar 240 is aligned to the bottom surface of the ceiling (i.e., the surface formed by the joint compound 290 applied in FIG. 2E). This may be accomplished, for example, by rotating the rotation tool 270a and, by extension, the collar 240 with respect to the mud-in plate 210 while threads of the collar 240 (e.g., the threads 242) remain engaged to threads of the sidewall 214 of the mud-in plate 210 (e.g., the threads 217). It should be appreciated that, in some implementations, the collar 240 may be securely coupled to the mud-in plate 210 and, hence, not movable with respect to the mud-in plate 210. Accordingly, the step of vertically adjusting the position of the collar 240 with respect to the mud-in plate 210 may not occur for these implementations. Moreover, an insert 270b may be inserted into the opening 211 rather than the rotation tool 270a described above.

The next step may then be removing the rotation tool 270a or the insert 270b from the mud-in plate assembly 200 to expose the opening 211 of the mud-in plate 210 as shown in FIG. 2G. The last step may be installing the lighting module 300 and/or a trim 310 via insertion through the opening 211 of the mud-in plate 210 as shown in FIG. 2H. This may be accomplished, for example, by first coupling the trim 310 to the lighting module 300 via, e.g., a snap-fit connection, a twist-and-lock mechanism, a fastener connection, or the like. The trim 310 may further include an attachment mechanism to securely couple the lighting module 300 and the trim 310 to the interior surfaces of the collar 240 or the sidewall 214. The attachment mechanism may include, but is not limited to, one or more friction clips and the like. The cable 260 installed in FIG. 2C may then be connected to the lighting module 300. Thereafter, the lighting module 300 and the trim 310 may be inserted together through the opening 211 of the mud-in plate 210 such that a bottom end of the trim 310 is either aligned with or disposed slightly above the bottom end of the collar 240 or the sidewall 214.

### 1.2 Examples of Mud-In Plate Assemblies for Trimless Recessed Lighting Fixtures

As described above, the mud-in plate assemblies 200 disclosed herein may generally include a mud-in plate 210 to cover an opening 94 of a ceiling 92 for a previously installed recessed lighting fixture and provide a relatively smaller opening 211 to accommodate a smaller lighting module 300 designed for a smaller aperture recessed lighting fixture. Accordingly, various implementations of the mud-in plate assembly 200 are contemplated herein to accommodate different sized ceiling openings 94 and/or to provide different sized and/or different shaped openings 211 for the lighting module 300. Following below are several non-limiting examples of mud-in plate assemblies 200.

1.2.1 Examples of Mud-In Plate Assemblies with a Circular Opening and a Vertically Adjustable Collar

In one non-limiting example, FIGS. 3A-3H show a mud-in plate assembly 200a to cover an opening (e.g., a circular opening) for a previously installed recessed lighting fixture (e.g., the opening 94) having a 4-inch trade size or a 5-inch trade size. The mud-in plate assembly 200a further provides an opening 211 to support a lighting module 300 and/or a trim 310 designed for a smaller aperture recessed lighting fixture (e.g., a lighting fixture having a 2-inch trade size). For example, FIG. 3H shows a lighting module 300a and a corresponding trim 310a for a 2-inch trade size recessed lighting fixture. As shown, the mud-in plate assembly 200a may include a mud-in plate 210a, a collar 240a, and a rotation tool 270a. The collar 240a and the rotation tool 270a are mounted to the mud-in plate 210a via insertion through the opening 211.

The mud-in plate 210a may include a flange 212 and a sidewall 214 defining the opening 211. In this example, the flange 212 may have an outer edge 215 shaped as a circle. The sidewall 214 may be cylindrical in shape. Thus, the opening 211 may be shaped as a circle.

The flange 212 of the mud-in plate 210a may be sufficiently large (e.g., the diameter, d₃, may be equal to about 6¾ inches) to cover the largest ceiling opening 94 supported by the mud-in plate assembly 200a (e.g., a ceiling opening 94 for a 5-inch trade size recessed lighting fixture). In some implementations, the opening 211 of the sidewall 214 may be dimensioned to accommodate a lighting module 300a configured to emit light for a 2-inch trade size recessed lighting fixture. In some implementations, the opening 211 may have a diameter, d₂, equal to about 2 inches. It should be appreciated however that, in some implementations, the lighting module 300a may define the 2-inch opening. Thus, the opening 211 of the mud-in plate 210a may have a diameter, d₂, larger than 2 inches. For example, the opening 211 defined by the sidewall 214 of the mud-in plate 210a may have a diameter of about 3 5/16 inches.

It should be appreciated that the foregoing dimensions are non-limiting. The various features of the mud-in plate assembly 200a may be readily adapted and scaled to facilitate the coverage of openings 94 of different sizes and/or shapes. Likewise, the various features of the mud-in plate assembly 200a may be readily adapted and scaled to support lighting modules 300a of different sizes and/or shapes.

The flange 212 may include a plurality of perforations 213 to facilitate application of the joint compound 290 as described above. In this example, the perforations 213 may be disposed across the entirety of the flange 212, i.e., from the outer edge 215 to where the sidewall 214 joins the flange 212. As shown in FIG. 3D, the perforations 213 may be radially distributed around the flange 212. Furthermore, the perforations 213 may vary in size; hence, the perforations 213 may not be identical.

The flange 212 may further include one or more fastener openings 219 disposed near the outer edge 215. During installation, corresponding fasteners 201 may be inserted through respective fastener openings 219 to securely couple the mud-in plate 210a to the ceiling drywall 92. In some implementations, the mud-in plate assembly 200a may only physically contact the ceiling drywall 92. Said another way, the mud-in plate assembly 200a does not physically contact other components of the recessed lighting fixture 100, including the housing 120.

The mud-in plate 210a further includes a ridge 218 disposed on a bottom surface of the flange 212 around the opening 211 as shown in FIG. 3A. As shown, the ridge 218 may extend from the bottom surface of the flange 212 downwards (e.g., away from the ceiling drywall 92). As explained above, the ridge 218 may guide how much joint compound 290 is applied to the mud-in plate 210a during installation. Further, the ridge 218 may reduce or, in some instances, prevent buildup of joint compound 290 around the opening 211, thus preserving the circular shape of the opening 211.

The sidewall 214 may be integrally formed together with the flange 212. Thus, in some implementations, the mud-in plate 210a may be unitary component. However, it should be appreciated that, in some implementations, the sidewall 214 and the flange 212 may be separate components that are coupled together (see, for example, the mud-in plate assembly 200d shown in FIGS. 5A-5D).

In some implementations, the mud-in plate 210a may further include a plurality of gussets 220a (also referred to herein as “ribs 220a”) directly coupled to the flange 212 and the sidewall 214, as shown in FIG. 3B. The gussets 220a increase the structural rigidity of the mud-in plate 210a, thus reducing or, in some instances, mitigating undesirable deformation of the flange 212 and/or sidewall 214 when the mud-in plate assembly 200a is subjected to a load, e.g., the weight of the lighting module 300a and the trim 310a, loads applied to install or remove the lighting module 300a and/or the trim 310a. In some implementations, the gussets 220a may be integrally formed together with the flange 212 and the sidewall 214.

As shown, the gussets 220a may be shaped as a triangle. The number of gussets 220a included in the mud-in plate assembly 200a may vary depending, in part, the materials used to form the mud-in plate 210a. In some implementations, the number of gussets 220a may range from 3 to 20, including all values and sub-ranges in between. For example, the number of gussets 220a may be equal to 3, 4, 5, 6, 7, 8, 9, 10, 11, 12, 13, 14, 15, 16, 17, 18, 19, or 20.

The gussets 220a may be dimensioned such that the gussets 220a do not physically contact the bottom surface 93 of the ceiling drywall 92; otherwise, the gussets 220a may prevent the top surface of the flange 212 from abutting the ceiling drywall 92. Thus, the gussets 220a may be dimensioned such that the gussets 220a are entirely disposed within the opening 94. Accordingly, the dimensions of the gussets 220a may be limited, in part, by the smallest size of the opening 94 supported by the mud-in plate assembly 200a (e.g., a ceiling opening 94 having a diameter, d₁, of about 4 inches). If the gussets 220a extend radially along the flange 212 away from a centerline axis 202 (see FIG. 3D), the maximum radius of the gusset 220a may be less than or equal to about 2 inches, i.e., half the smallest diameter, d₁, supported by the mud-in plate assembly 200a.

The collar 240a may provide an interface to mechanically couple the lighting module 300a and/or the trim 310a to the mud-in plate assembly 200a. The exterior surface 243 of the collar 240a may be directly coupled to the interior surface 216 of the sidewall 214 surrounding the opening 211. The collar 240a, in turn, may define an opening 241 to receive the lighting module 300a and/or the trim 310a. In some implementations, at least the bottom portion of the collar 240a may have a similar shape as the sidewall 214 surrounding the opening 211. For instance, the collar 240a in the mud-in plate assembly 200a may have a cylindrical shape corresponding to the circular-shaped opening 211.

The collar 240a may have a height larger than the height of the sidewall 214. Thus, the collar 240a may only be partially inserted through the opening 211 (see, for example, FIG. 3F). For example, the height of the collar 240a may be equal to about 2 inches. More generally, the height of the collar 240a may range from about 1 inch to about 3 inches, including all values and sub-ranges in between. In some implementations, the collar 240a may be vertically adjustable with respect to the mud-in plate 210a. Vertical adjustment of the collar 240a may allow the bottom end of the collar 240a to be aligned to the bottom end of the mud-in plate 210a (e.g., the bottom end of the ridge 218) after the joint compound 290 is applied. In this manner, the bottom end of the collar 240a may be substantially flush or flush with the joint compound 290.

In some implementations, vertical displacement of the collar 240a with respect to the mud-in plate 210a may be accomplished using a threaded connection. For example, FIG. 3G shows the collar 240a may include threads 242 disposed on the exterior surface 243 of the collar 240a and corresponding threads 217 disposed on the interior surface 216 of the sidewall 214. The threads 217 and 242 may be helical in shape. Thus, vertical displacement of the collar 240a may be achieved by rotating the collar 240a with respect to the mud-in plate 210a.

To facilitate rotation of the collar 240a with respect to the mud-in plate 210a, the mud-in plate assembly 200a may include a rotation tool 270a. The rotation tool 270a may be inserted into the opening 241 of the collar 240a. In some implementations, the rotation tool 270a may be securely coupled to the collar 240a via, for example, a press fit. As shown in FIG. 3F, the rotation tool 270a may include a base portion 271 joined to a sidewall 272. The sidewall 272 abuts the interior surface of the collar 240a. The physical contact between the sidewall 272 and the collar 240a may provide sufficient friction between the rotation tool 270a and the collar 240a to retain the rotation tool 270a within the opening 241 of the collar 240a and to constraint the rotation tool 270a to rotate with the collar 240a (i.e., the rotation tool 270a cannot readily rotate with respect to the collar 240a).

The rotation tool 270a may further include features to assist a user in rotating the collar 240a with respect to the mud-in plate 210a. For example, the rotation tool 270a may include one or more tabs 273 joined to the base portion 271 and the sidewall 272. The tab(s) 273 provide surfaces for a user to grab, push, and/or pull by hand to rotate the rotation tool 270a and, by extension, the collar 240a with respect to the mud-in plate 210a.

In some implementations, the rotation tool 270a may also substantially cover or cover the opening 211. For example, FIG. 3F shows the rotation tool 270a may span the width of the opening 211 defined by the sidewall 214. During installation, the rotation tool 270a may also protect the interior surfaces of the sidewall 214 and/or the collar 240a against accidental application of the joint compound 290 and/or other substances (e.g., paint). Said another way, the rotation tool 270a may keep the interior surfaces of the sidewall 214 and/or the collar 240a pristine to facilitate installation of the lighting module 300a and/or the trim 310a after the joint compound 290 and/or other substances are applied to the mud-in plate assembly 200a.

For example, after the joint compound 290 and/or paint is applied, the rotation tool 270a is removed from the collar 240a, thus exposing the opening 241. Thereafter, the lighting module 300a and/or the trim 310a may be inserted into the opening 241 and securely coupled to the collar 240a. The rotation tool 270a may be removed from the collar 240a by applying a sufficiently large vertical load to pull the rotation tool 270a out from the collar 240a through the opening 241.

In some implementations, the collar 240a may include a lip 244 offset from the bottom end of the collar 240a as shown in FIG. 3G. The lip 244 (also referred to herein as a “recessed step”) may facilitate positioning of the rotation tool 270a and/or the trim 310a. For instance, when inserting the rotation tool 270a and/or the trim 310a into the opening 241 of the collar 240a, the lip 244 may function as a mechanical stop that limits how far the rotation tool 270a and the trim 310a can be inserted into the collar 240a. In this manner, the lip 244 may be positioned and/or the rotation tools 270a and the trim 310a may be dimensioned such that respective bottom ends of the rotation tool 270a and the trim 310a align with the bottom end of the collar 240a. For example, the trim 310a in FIG. 3H may include a top end 311 that, when inserted into the collar 240, abuts the lip 244. The trim 310a may be dimensioned such that the bottom end 312 is aligned to the bottom end of the collar 240, which may correspond to the bottom surface 93 of the ceiling 92.

In the mud-in plate assembly 200a, the rotation tool 270a is shown to be directly coupled to the collar 240a. However, it should be appreciated that this is a non-limiting example. In some implementations, the mud-in plate assembly 200a may not include a collar and/or the collar may be fixed to the mud-in plate 210a (i.e., the collar is not vertically adjustable). Accordingly, in these implementations, an insert (see, for example, the insert 270c shown in FIG. 5A) may be inserted into the opening 211 and securely coupled to the sidewall 214 and/or the collar to enclose the opening 211 in the same manner as the rotation tool 270a described above.

In another non-limiting example, FIGS. 4A-4G show a mud-in plate assembly 200b to cover an opening (e.g., a circular opening) for a previously installed recessed lighting fixture (e.g., the opening 94) having a 6-inch trade size. The mud-in plate assembly 200b further provides an opening 211 to support a lighting module 300 and/or a trim 310 designed for a smaller aperture recessed lighting fixture (e.g., a lighting fixture having a 2-inch trade size), such as the lighting module 300a and the trim 310a. As shown, the mud-in plate assembly 200b may include a mud-in plate 210b, the collar 240a, and the rotation tool 270a. The mud-in plate assembly 200b may incorporate one or more of the same components and/or features as the mud-in plate assembly 200a described above or the mud-in plate assembly 200 described in Section 1. For brevity, repeated discussion of these components and/or features is not provided below unless indicated otherwise.

In this example, the flange 212 of the mud-in plate 210b may have an outer edge 215 shaped as a circle. The sidewall 214 may define an opening 211 shaped as a circle. The flange 212 may be sufficiently large to cover a ceiling opening 94 supporting a 6-inch trade size recessed lighting fixture. For example, the diameter, d₃, may be equal to about 8 1/16 inches. In some implementations, the opening 211 of the sidewall 214 may be dimensioned to accommodate a lighting module 300a for a 2-inch trade size recessed lighting fixture. In some implementations, the opening 211 may have a diameter, d₂, equal to about 2 inches. It should be appreciated however that, in some implementations, the lighting module 300a may define the 2-inch opening. Thus, the opening 211 of the mud-in plate 210a may have a diameter, d₂, larger than 2 inches. For example, the opening 211 defined by the sidewall 214 of the mud-in plate 210a may have a diameter of about 3 5/16 inches.

Compared to the mud-in plate assembly 200a, the flange 212 of the mud-in plate 210b in the mud-in plate assembly 200b may have a larger diameter, d₃, i.e., to cover a larger opening 94 in the ceiling 92 for the recessed lighting fixture 100. Accordingly, the relatively larger flange 212 of the mud-in plate assembly 200b may be more susceptible to deformation compared to the flange 212 of the mud-in plate assembly 200a.

To reduce or, in some instances, mitigate undesirable deformation of the flange 212, the mud-in plate 210b includes a rib structure 220b to increase the mechanical stiffness of the mud-in plate 210b, particularly along the portion of the flange 212 suspended across the opening 94 of the ceiling drywall 92. As shown in FIG. 4B, the rib structure 220b may include a plurality of radial ribs 222a joined to the sidewall 214 and the top surface of the flange 212. The radial ribs 222a may each be aligned along a radial axis that intersects the centerline axis 202 of the mud-in plate assembly 200b. In some implementations, the number of radial ribs 222a may range from 3 to 30, including all values and sub-ranges in between. For example, the number of radial ribs 222a may be equal to 3, 4, 5, 6, 7, 8, 9, 10, 11, 12, 13, 14, 15, 16, 17, 18, 19, 20, 21, 22, 23, 24, 25, 26, 27, 28, 29, or 30.

The rib structure 220b may further include a circular rib 222b joined to the plurality of radial ribs 222a and the flange 212. The circular rib 222b may be axisymmetric about the centerline axis 202. The rib structure 220b may only be disposed onto the portion of the flange 212 suspended across the opening 94 to ensure the top surface of the flange 212 can abut the bottom surface 93 of the ceiling drywall 92. In some implementations, the circular rib 222b may correspond to the portion of the rib structure 220b located furthest from the centerline axis 202. Accordingly, the circular rib 222b may have a width equal to or less than the diameter, d₁, of the opening 94 or the opening 121. In some implementations, the rib structure 220b may also serve as an alignment feature to facilitate alignment of the mud-in plate assembly 200b to the opening 94 of the ceiling drywall 92. For example, the mud-in plate assembly 200b may be placed against the ceiling drywall 92 such that the rib structure 220b is inserted through the opening 94. In implementations where the width of the rib structure 220b is similar to the width of the opening 94, insertion of the rib structure 220b through the opening 94 may result in the mud-in plate assembly 200b being concentrically aligned to the opening 94.

The radial ribs 222a and the circular rib 222b may have the same height, h. In some implementations, the height of the rib structure 220b, h, may be consistent throughout the rib structure 220b. In some implementations, the height may range from about 1/16 inch to about 1 inch, including all values and sub-ranges in between. For example, the height, h, of the rib structure 220b may be equal to about 1/16 inch, ⅛ inch, 3/16 inch, ¼ inch, 5/16 inch, ⅜ inch, 7/16 inch, ½ inch, 9/16 inch, ⅝ inch, 11/16 inch, ¾ inch, 13/16 inch, ⅞ inch, 15/16 inch, or 1 inch.

In some implementations, the rib structure 220b may be integrally formed together with the flange 212 and the sidewall 214. Accordingly, the mud-in plate 210b may be a unitary component.

1.2.2 an Example Mud-In Plate Assembly with a Circular Opening and a Fixed Collar

In another non-limiting example, FIGS. 5A-5D show a mud-in plate assembly 200d with a fixed collar 240c, i.e., the collar 240c is not vertically adjustable with respect to a mud-in plate 210d. The mud-in plate assembly 200d may cover an opening (e.g., a circular opening) for a previously installed recessed lighting fixture (e.g., the opening 94) having a 6-inch trade size. The mud-in plate assembly 200d further provides an opening 211 to support a lighting module 300 and/or a trim 310 designed for a smaller aperture recessed lighting fixture (e.g., a lighting fixture having a 4-inch trade size). For example, FIG. 5D shows a lighting module 300b and a trim 310b for a 4-inch trade size recessed lighting fixture. As shown, the mud-in plate assembly 200d may include a mud-in plate 210d, a collar 240c, and an insert 270c to enclose the opening 211 defined by the mud-in plate 210d in the same manner as the rotation tool 270a described above. The mud-in plate assembly 200d may incorporate one or more of the same components and/or features as the mud-in plate assemblies 200a and 200b described above or the mud-in plate assembly 200 described in Section 1. For brevity, repeated discussion of these components and/or features is not provided below unless indicated otherwise.

In this example, the flange 212 of the mud-in plate 210d may have an outer edge 215 shaped as a circle. The mud-in plate 210d may define an opening 211 shaped as a circle. The flange 212 may be sufficiently large to cover a ceiling opening 94 supporting a 6-inch trade size recessed lighting fixture. For example, the diameter, d₃, may be equal to about 8 1/16 inches. In some implementations, the opening 211 may be dimensioned to accommodate a lighting module 300b for a 4-inch trade size recessed lighting fixture. In some implementations, the opening 211 may have a diameter, d₂, equal to about 4 inches. It should be appreciated however that, in some implementations, the lighting module 300b may define the 4-inch opening. Thus, the opening 211 of the mud-in plate 210a may have a diameter, d₂, larger than 4 inches. For example, the opening 211 of the mud-in plate 210a may have a diameter of about 4¼ inches.

The flange 212 may include a rib structure 220d similar to the rib structure 220b. For example, the rib structure 220d may include a plurality of radial ribs (e.g., the radial ribs 222a) and a circular rib (e.g., the circular rib 222b) disposed on a top surface of the flange 212. However, it should be appreciated that, in some implementations, the flange 212 of the mud-in plate 210d may include a plurality of gussets (e.g., the gussets 220a) in place of or in addition to the rib structure 220d.

In this example, the collar 240c is not vertically adjustable with respect to the mud-in plate 210d. Rather the collar 240c may be securely coupled to the mud-in plate 210d. This may be accomplished, for example, by a fastener connection. For instance, FIG. 5C shows the mud-in plate 210d may include multiple tabs 226 disposed around the opening 211. The tabs 226 may be oriented vertically and include a fastener opening 224. Each fastener opening 224 may be aligned to a corresponding fastener opening 246 on the collar 240c during assembly. Corresponding fasteners 248 may be inserted through the fastener openings 224 and 246 to securely couple the collar 240c to the mud-in plate 210d.

It should be appreciated that the fastener connection between the mud-in plate 210d and the collar 240c is a non-limiting example. In another example, the collar 240c may be securely coupled to the mud-in plate 210d via a snap-fit connection. In yet another example, the features of the collar 240c may be integrally formed with the mud-in plate 210d. Thus, the collar 240c may effectively be the same as the sidewall 214.

The insert 270c may enclose the opening 211 to reduce or, in some instances, mitigate application of the joint compound 290 and/or other substances onto the interior surfaces of the collar 240c. As shown in FIG. 5A, the insert 270c may include a tab 273 located near or at the center of the insert 270c and a pair of recesses 274 disposed adjacent to the tab 273. The tab 273 provide surfaces for a user to grab, push, and/or pull by hand to insert and/or remove the insert 270c from the mud-in plate assembly 200d.

1.2.3 Examples of Mud-In Plate Assemblies with a Square Opening

The mud-in plate assemblies disclosed herein may generally provide different-shaped openings for the lighting module 300. For example, the mud-in plate assemblies 200a, 200b, and 200d described above provide a circular-shaped opening for the lighting module 300. Following below are several examples of mud-in plate assemblies that provide a square-shaped opening for the lighting module 300.

FIGS. 6A-6H show an example mud-in plate assembly 200c to cover an opening (e.g., a circular opening) for a previously installed recessed lighting fixture (e.g., the opening 94) having a 6-inch trade size. The mud-in plate assembly 200c further provides a square-shaped opening 211 to support a lighting module 300 and/or a trim 310 designed for a smaller aperture recessed lighting fixture (e.g., a lighting fixture having a 2-inch trade size), such as the lighting module 300a and the trim 310a. As shown, the mud-in plate assembly 200c may include a mud-in plate 210c, a collar 240b, and an insert 270b to enclose the opening 211 defined by the mud-in plate 210c. The mud-in plate assembly 200c may incorporate one or more of the same components and/or features as the mud-in plate assemblies 200a, 200b, and 200d described above or the mud-in plate assembly 200 described in Section 1. For brevity, repeated discussion of these components and/or features is not provided below unless indicated otherwise.

In this example, the flange 212 of the mud-in plate 210c may have an outer edge 215 shaped as a circle. The flange 212 may be sufficiently large to cover a ceiling opening 94 supporting a 6-inch trade size recessed lighting fixture. For example, the diameter, d₃, may be equal to about 8- 1/16 inches. In some implementations, the opening 211 may be dimensioned to accommodate a lighting module 300 for a 2-inch trade size recessed lighting fixture. The sidewall 214 may be shaped as square tube defining the square-shaped opening 211. In some implementations, the opening 211 defined by the sidewall 214 may have a side length, L, equal to about 2 inches. It should be appreciated however that, in some implementations, the lighting module 300 may define the 2-inch opening. Thus, the opening 211 of the mud-in plate 210c may have a side length, L, larger than 2 inches. For example, the opening 211 of the mud-in plate 210c may have a side length, L, of about 3⅜ inches.

The flange 212 may further include a rib structure 220c similar to the rib structure 220b. For example, the rib structure 220c may include a plurality of radial ribs 222a and a circular rib 222b disposed on a top surface of the flange 212. However, it should be appreciated that, in some implementations, the flange 212 of the mud-in plate 210c may include a plurality of gussets (e.g., the gussets 220a) in place of or in addition to the rib structure 220c.

It should be appreciated that the same lighting modules 300 used for the mud-in plate assemblies 200a, 200b, and 200d may also be installed into the mud-in plate assembly 200c. As shown in FIGS. 3H and 5D, the lighting modules 300a and 300b may have a round (e.g., circular) geometry. To support round-shaped lighting modules (e.g., the lighting modules 300a and 300b), the collar 240b may include a square shaped bottom portion that conforms to the sidewall 214 and defines a square-shaped opening 241a at the bottom end of the collar 240b and a cylindrical upper portion that defines a circular opening 241b at the top end of the collar 240b. The cylindrical top portion of the collar 240b may support the round-shaped lighting module 300 and the square-shaped bottom portion of the collar 240b may support a square-shaped trim 310.

In this example, the collar 240b may be securely coupled to the sidewall 214 of the mud-in plate 210c. For example, FIGS. 6G and 6H show the collar 240b may include a pair of fastener openings 246 that align with corresponding fastener openings 224 on the sidewall 214. Corresponding fasteners 248 are inserted through respective fastener openings 224 and 246 to securely couple the collar 240b to the mud-in plate 210c.

The insert 270b may enclose the opening 211 defined by the sidewall 214. As shown in FIGS. 6G and 6H, the insert 270b may be shaped as a square to conform with the square-shaped bottom portion of the collar 240b. In some implementations, the insert 270b may include an opening 275, which provides surfaces for a user to grab, push, and/or pull by hand to insert and/or remove the insert 270b from the mud-in plate assembly 200c.

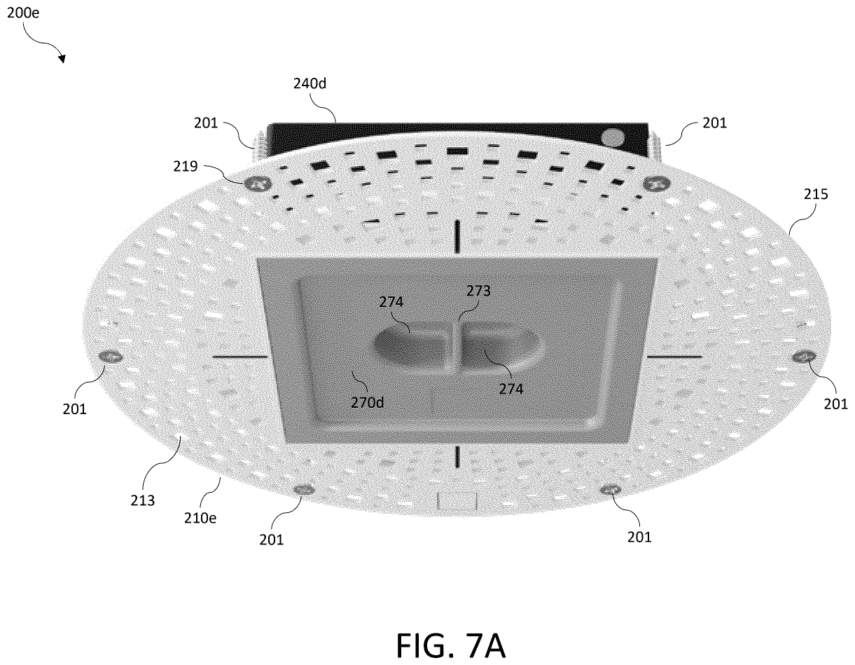

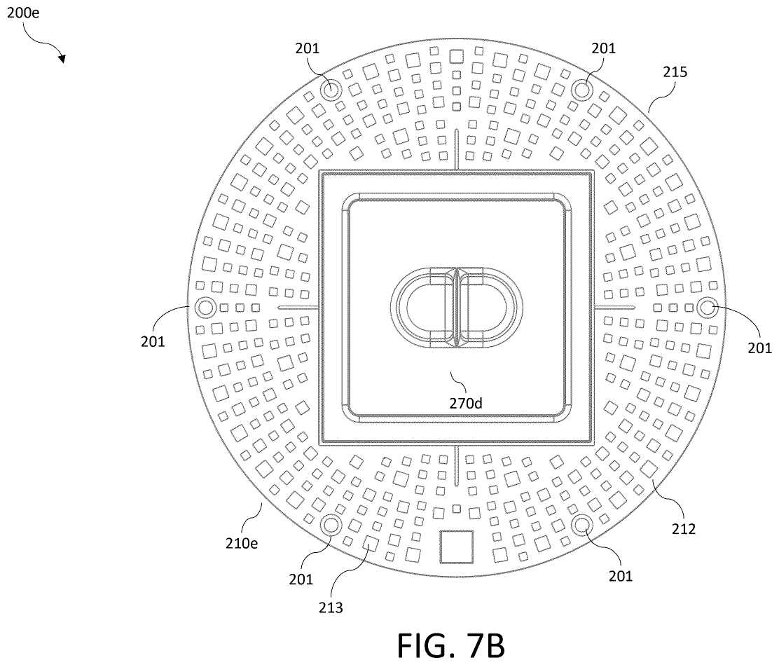

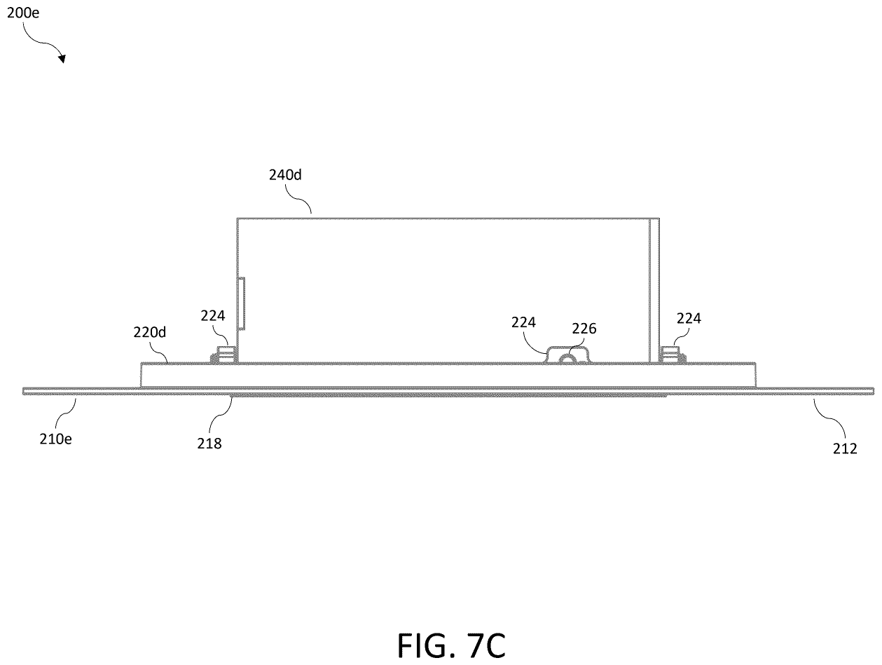

FIGS. 7A-7C show another example mud-in plate assembly 200e with a square-shaped opening 211. The mud-in plate assembly 200c may cover an opening (e.g., a circular opening) for a previously installed recessed lighting fixture (e.g., the opening 94) having a 6-inch trade size. The mud-in plate assembly 200e further provides a square-shaped opening 211 to support a lighting module 300 and/or a trim 310 designed for a smaller aperture recessed lighting fixture (e.g., a lighting fixture having a 4-inch trade size), such as the lighting module 300b and the trim 310b. As shown, the mud-in plate assembly 200e may include a mud-in plate 210e, a collar 240d, and an insert 270d to enclose the opening 211 defined by the mud-in plate 210e. The mud-in plate assembly 200c may incorporate one or more of the same components and/or features as the mud-in plate assemblies 200a-200d described above or the mud-in plate assembly 200 described in Section 1. For brevity, repeated discussion of these components and/or features is not provided below unless indicated otherwise.

In this example, the flange 212 of the mud-in plate 210e may have an outer edge 215 shaped as a circle. The flange 212 may be sufficiently large to cover a ceiling opening 94 supporting a 6-inch trade size recessed lighting fixture. For example, the diameter, d₃, may be equal to about 8 1/16 inches. In some implementations, the opening 211 may be dimensioned to accommodate a lighting module 300 for a 4-inch trade size recessed lighting fixture. The sidewall 214 may be shaped as square tube defining the square-shaped opening 211. In some implementations, the opening 211 defined by the sidewall 214 may have a side length, L, equal to about 4 inches. It should be appreciated however that, in some implementations, the lighting module 300 may define the 4-inch opening. Thus, the opening 211 of the mud-in plate 210e may have a side length, L, larger than 4 inches. For example, the opening 211 of the mud-in plate 210e may have a side length, L, of about 4 1/16 inches. The lighting module 300b shown in FIG. 5D is an example of a lighting module that may be installed using the mud-in plate assembly 200c.

As shown, the mud-in plate 210e may include several of the same features as the mud-in plate 210d, such as the rib structure 220d and the tabs 226 and fastener openings 224 to couple the mud-in plate 210e to the collar 240d. The insert 270d may similarly include several of the same features as the insert 270c, such as the centrally located tab 273 flanked by the recesses 274 to facilitate insertion and removal of the insert 270d from the mud-in plate assembly 200c.

1.2.4 Example Mud-In Plate Assemblies with a Flange Having a Smooth Inner Portion and a Perforated Outer Portion.

In the foregoing example mud-in plate assemblies 200a-200c, the mud-in plates 210a-210c include a plurality of perforations 213 that extend from the outer edge 215 to the opening 211. It should be appreciated that these are non-limiting examples. In some implementations, the perforations 213 may only be disposed on a portion of the flange 212. In the following example implementations, the perforations 213 are disposed on an outer portion of the flange 212 while an inner portion of the flange 212 located near the opening 211 does not include any perforations 213. Furthermore, the inner portion of the flange 212 may be relatively smooth. The smooth inner portion of the flange 212 may require less or, in some instances, no application of joint compound 290. This, in turn, may reduce or, in some instances, mitigate any accumulation of the joint compound 290 near the opening 211, thus preserving the desired shape of the opening 211 for installation of the lighting module 300.

In one non-limiting example, FIGS. 8A-8H show a mud-in plate assembly 200f that includes a mud-in plate 210f with an inner plate 227a having a relatively smooth surface and an outer plate 227b having a plurality of perforations 213. The mud-in plate assembly 200f may cover an opening (e.g., a circular opening) for a previously installed recessed lighting fixture (e.g., the opening 94) having an 8-inch trade size. The mud-in plate assembly 200f further provides an opening 211 to support a lighting module 300 and/or a trim 310 designed for a smaller aperture recessed lighting fixture (e.g., a lighting fixture having a 4-inch trade size), such as the lighting module 300b and the trim 310b. As shown, the mud-in plate assembly 200f may include a mud-in plate 210f and the collar 240c. In some implementations, the mud-in plate assembly 200f may further include an insert (not shown) to enclose the opening 211. The mud-in plate assembly 200f may incorporate one or more of the same components and/or features as the mud-in plate assemblies 200a-200e described above or the mud-in plate assembly 200 described in Section 1. For brevity, repeated discussion of these components and/or features is not provided below unless indicated otherwise.

The outer plate 227b may define the outer edge 215 of the mud-in plate 210f. In this example, the outer edge 215 may be shaped as a circle. The outer plate 227b may be sufficiently large to cover a ceiling opening 94 supporting an 8-inch trade size recessed lighting fixture. For example, the diameter, d₃, which is defined by the outer plate 227b of the mud-in plate 210f, may be equal to about 10 inches. The inner plate 227a may define the opening 211 of the mud-in plate 210f. In some implementations, the opening 211 may be dimensioned to accommodate a lighting module 300 for a 4-inch trade size recessed lighting fixture. In some implementations, the opening 211 may have a diameter, d₂, equal to about 4 inches. It should be appreciated however that, in some implementations, the lighting module 300b may define the 4-inch opening. Thus, the opening 211 of the mud-in plate 210f may have a diameter, d₂, larger than 4 inches. For example, the opening 211 of the mud-in plate 210f may have a diameter of about 4.2 or about 4.3 inches.

In this example, the inner plate 227a may define a smooth inner portion 228a of the mud-in plate 210f as described above. The inner plate 227a may further include a sidewall 214 joined to the inner portion 228a. The inner plate 227a may include a plurality of fastener openings 224 that align with corresponding fastener openings 246 on the collar 240c. Corresponding fasteners 248 may be inserted through respective fastener openings 224 and 246 to securely couple the collar 240c to the inner plate 227a of the mud-in plate 210f.

The outer plate 227b may define an outer portion 228b of the mud-in plate 210f, which includes a plurality of perforations 213 to facilitate application of the joint compound 290. The outer plate 227b may further include one or more fastener openings 219 to receive corresponding fasteners 201 to securely couple the mud-in plate assembly 200f to the ceiling drywall 92.

The inner plate 227a may be directly coupled to the outer plate 227b. In some implementations, this may be accomplished by a fastener connection. For example, FIGS. 8G and 8H show the inner plate 227a may include one or more fastener openings 230a that each align with corresponding fastener openings 230b on the outer plate 227b. Corresponding fasteners 229 are inserted through the fastener openings 230a and 230b to securely couple the inner plate 227a to the outer plate 227b. It should be appreciated that the fastener connection between the inner plate 227a and the outer plate 227b is a non-limiting example. More generally, the inner plate 227a may be securely coupled to the outer plate 227b using a variety of coupling mechanisms including, but not limited to, a snap-fit connection mechanism, an adhesive, and the like.

In some implementations, the bottom surface of the inner plate 227a (i.e., the surface of the inner plate 227a facing away from the ceiling drywall 92), may be disposed lower than the bottom surface of the outer plate 227b as shown in FIG. 8F. This arrangement may serve a similar function as the ridge 218 in the sense that the offset between the bottom surface of the outer plate 227b and the bottom surface of the inner plate 227a may guide how much joint compound 290 is applied to the mud-in plate 210f during installation. For example, the outer plate 227b may be offset vertically from the inner plate 227a by a height sufficient to accommodate the thickness of the joint compound 290, drywall tape, paint, and/or any other substances applied to the outer plate 227b to integrate the mud-in plate assembly 200f into the ceiling 92. This, in turn, makes it easier to blend the mud-in plate assembly 200f into the surrounding ceiling drywall 92 and/or reduce the formation of any undesirable bulges between the mud-in plate assembly 200f and the surrounding ceiling drywall 92.

In some implementations, the mud-in plate assembly 200f may include a cover sheet 231 disposed onto the bottom surface of the inner plate 227a. The cover sheet 231 may cover respective portions of the fasteners 229 and the fastener openings 230a visible from the bottom surface of the inner plate 227a. In this manner, the cover sheet 231 may provide the relatively smooth surface of the inner plate 227a that surrounds the opening 211. However, it should be appreciated that, in some implementations, the inner plate 227a may provide the relatively smooth surface of the inner portion 228a. In some implementations, the bottom surface of the inner portion 228a may have a surface quality similar to or, in some instances, the same as a level 3, level 4, or level 5 surface finish for gypsum as set forth in Gypsum Association GA-214-2021. In some implementations, the bottom surface of the inner portion 228a may have a textured surface, e.g., a texture that matches the texture of the surrounding ceiling 92. More generally, the inner portion 228a may provide a surface that can be used as part of the finished ceiling for the trimless recessed lighting fixture. In some implementations, the inner portion 228a may be painted or left bare. For example, the inner portion 228a may be painted with a primer or a combination of paint and primer. Thereafter, a final coat of paint may be applied to the inner portion 228a to finish the installation.

The cover sheet 231 may be shaped and/or dimensioned to be approximately the same or, in some instances, the same as the bottom surface of the inner plate 227a. Further, the cover sheet 231 may be directly coupled to the bottom surface of the inner plate 227a, e.g., via an adhesive. In some implementations, the cover sheet 231 may be a laminated paper. In some implementations, the smooth surface of the inner plate 227a, e.g., the surface of the cover sheet 231, may be coated with a primer to improve adhesion with any applied joint compound 290 that physically contacts the inner plate 227a. Although the mud-in plate assembly 200f is designed to have the joint compound 290 primarily applied to the bottom surface of the outer plate 227b, some joint compound 290 may nevertheless be applied to the inner plate 227a, e.g., along portions of the inner plate 227a that join to the outer plate 227b. Accordingly, the primer may help the joint compound 290 adhere to the bottom surface of the inner plate 227a as necessary. The primer may comprise a waterborne acrylic urethane primer/sealer (e.g., STIX SXA-110).

To reduce or, in some instances, mitigate undesirable deformation of the inner portion 228a and the outer portion 228b, which together form the flange for the flange of the mud-in plate 210f, the inner plate 227a and the outer plate 227b may be formed from different materials. For example, the inner plate 227a may be formed from a first material and the outer plate 227b may be formed from a second material different from the first material where the second material has a Young's modulus greater than the first material. In one non-limiting example, the inner plate 227a may be formed from a composite material comprising 30% glass filled polycarbonate (e.g., LEXAN™ FR Resin 3413R) and the outer plate 227b may be formed from G40 steel, which is a material commonly used in sheet metal. In another non-limiting example, the inner plate 227a may be formed, at least in part, from gypsum and the outer plate 227b may be formed from a metal, e.g., G40 steel. Additionally, the inner plate 227a may include a plurality of gussets 220a joined to the inner portion 228a and the sidewall 214 to increase the structural rigidity of the inner plate 227a.

Generally, the application of joint compound around a circle is more challenging compared to a square and can often lead to the excessive application of joint compound. To improve the case of applying joint compound 290 to the mud-in plate assembly 200f, FIGS. 8G and 8H show the inner portion 228a defined by the inner plate 227a may have an outer edge 232 shaped as a square. As shown, the square shape of the outer edge 232 may have rounded corners; thus, the square may be a rounded square. The outer edge 215 of the outer portion 228a defined by the outer plate 227b and the opening 211 of the inner plate 227a may remain shaped as a circle. The square shape of the inner portion 228a may allow the joint compound 290 and/or drywall tape to be applied along relatively straight paths (e.g., along the sides of the square). As a result, the outer edge 232 of the inner portion 228a may have a different shape compared to the outer edge 215 or the opening 211.

In some implementations, the outer edge 232 of the inner portion 228a, when shaped as a square, may have a side length, l, that range from about 4 inches to about 7 inches, including all values and sub-ranges in between. For example, the side length, l, may be equal to about 4 inches, about 4.5 inches, about 5 inches, about 5.5 inches, about 6 inches, about 6.5 inches, or about 7 inches.

In another non-limiting example, FIGS. 9A-9G show a mud-in plate assembly 200g that includes a mud-in plate 210g, which is a unitary component that provides an inner portion 228a having a relatively smooth surface and an outer portion 228b having a plurality of perforations 213. The mud-in plate assembly 200g may cover an opening (e.g., a circular opening) for a previously installed recessed lighting fixture (e.g., the opening 94) having an 8-inch trade size. The mud-in plate assembly 200g further provides an opening 211 to support a lighting module 300 and/or a trim 310 designed for a smaller aperture recessed lighting fixture (e.g., a lighting fixture having a 4-inch trade size), such as the lighting module 300b and the trim 310b. As shown, the mud-in plate assembly 200g may include the mud-in plate 210g and the collar 240c joined to the sidewall 214 of the mud-in plate 210g via a plurality of fasteners 248. In some implementations, the mud-in plate assembly 200g may further include an insert (not shown) to enclose the opening 211. The mud-in plate assembly 200g may incorporate one or more of the same components and/or features as the mud-in plate assemblies 200a-200f described above or the mud-in plate assembly 200 described in Section 1. For brevity, repeated discussion of these components and/or features is not provided below unless indicated otherwise.

In this example, the flange 212 of the mud-in plate 210g may have an outer edge 215 shaped as a square. The flange 212 may be sufficiently large to cover a ceiling opening 94 supporting an 8-inch trade size recessed lighting fixture. For example, the length, L, may be equal to about 9 inches (see FIG. 9E). In some implementations, the opening 211 may be dimensioned to accommodate a lighting module 300 for a 4-inch trade size recessed lighting fixture. The sidewall 214 may be shaped as circular tube defining a circular-shaped opening 211. In some implementations, the opening 211 may have a diameter, d₂, equal to about 4 inches. It should be appreciated however that, in some implementations, the lighting module 300b may define the 4-inch opening. Thus, the opening 211 of the mud-in plate 210g may have a diameter, d₂, larger than 4 inches. For example, the opening 211 of the mud-in plate 210g may have a diameter of about 4.2 inches or about 4.3 inches.

The mud-in plate 210g may be a unitary component that incorporates several of the same features as the mud-in plate 210f. For example, the outer portion 228b may only include perforations 213. The inner portion 228a may provide a relatively smooth bottom surface, thus reducing or, in some instances, eliminating the need to apply joint compound 290 to this surface during installation. The inner portion 228a has an outer edge 232 shaped as a square to improve the case of applying the joint compound 290 to the mud-in plate 210g as described above. The inner portion 228a further includes a plurality of gussets 220a joined to the sidewall 214 and disposed on the top surface of the inner portion 228a. The bottom surface of the inner portion 228a is offset from the bottom surface of the outer portion 228b, e.g., to accommodate the thickness of the joint compound 290, drywall tape, paint, and/or any other substances applied to the outer portion 228b to integrate the mud-in plate assembly 200g into the ceiling 92.

In some implementations, the mud-in plate 210g may be formed from a composite material comprising 30% glass filled polycarbonate (e.g., LEXAN™ FR Resin 3413R) and/or gypsum. The bottom surfaces of the mud-in plate 210g may be coated with a primer to improve adhesion of any joint compound 290 applied to the mud-in plate 210g. The primer may comprise a waterborne acrylic urethane primer/scaler (e.g., STIX SXA-110).

### 1.3 an Example Mud-In Plate Assembly for a Gang Box Installation

It should be appreciated that while the example mud-in plate assemblies disclosed herein are configured for trimless recessed lighting fixtures, the inventive concepts associated with the mud-in plate assemblies may be applied to other types of retrofit installations. For example, a built environment may include a multi gang box (e.g., a 2 gang box, a 3 gang, box, a 4 gang box, and so on) to house various electrical components (e.g., electrical wires, control electronics for various devices including lighting fixtures, and so on). Typically, a multi gang box is mounted to a support structure and an opening is cut into a drywall panel based on the shape and dimensions of the multi gang box. In some installations, the electrical components may include one or more switches (e.g., a light switch). Accordingly, a cover plate installed to cover the opening of the drywall panel may include openings to provide access to the switch.

In some installations, the electrical components housed within a multi gang box may only include a single switch. The switch itself may fit within a single gang box. Thus, in principle, a cover plate for a single gang box is suitable to provide access to the switch. However, the size of the multi gang box generally requires a cover plate for a multi gang box to ensure the opening within the drywall panel is covered. As a result, some installations may include a disproportionately large cover plate that provides access to a single switch, which can be undesirable.

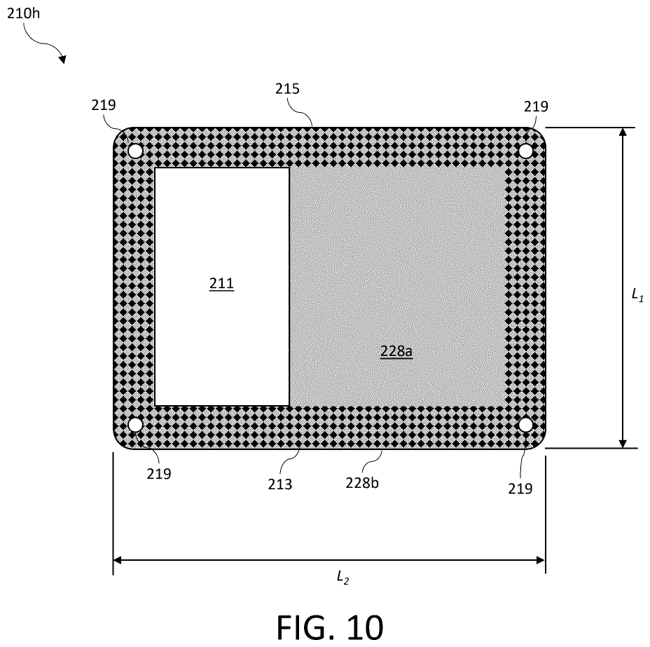

To address these foregoing situations, FIG. 10 shows an example mud-in plate 210h to cover an opening for a previously installed multi gang box (e.g., a 3 gang box) and provide an opening for a single gang box. The mud-in plate 210h may further be integrated into a wall or a ceiling in the same manner as the mud-in plates described above, e.g., by applying joint compound to 290 to portions of the mud-in plate 210h, to provide a seamless appearance. In this manner, the mud-in plate 210h may make the multi gang box visually appear as a single gang box. The mud-in plate 210h may incorporate one or more of the same features as the mud-in plate assemblies 200a-200g described above or the mud-in plate assembly 200 described in Section 1. For brevity, repeated discussion of these features is not provided below unless indicated otherwise.

As shown, the mud-in plate 210h may include an inner portion 228a and an outer portion 228b joined to the inner portion 228a. The inner portion 228a may define an opening 211 shaped and/or dimensioned for a single gang box. The remaining portion of the inner portion 228a may provide a relatively smooth surface as shown in FIG. 10. It should be appreciated, however, that in some implementations the inner portion 228a may include a plurality of perforations 213. The outer portion 228b may include a plurality of perforations 213. The outer portion 228b may further include one or more fastener openings 219 to receive corresponding fasteners (e.g., fasteners 201) to securely couple the mud-in plate 210h to a wall or a ceiling.

The mud-in plate 210h may be formed from various materials including, but not limited to, a polymer, a composite material (e.g., 30% glass filled polycarbonate, such as LEXAN™ FR Resin 3413R), and gypsum. In some implementations, the surfaces of the mud-in plate 210h may be coated with a primer (e.g., a waterborne acrylic urethane primer/scaler, such as STIX SXA-110) to improve adhesion of any joint compound 290 applied to the mud-in plate 210h.

The outer dimensions of the mud-in plate 210h may be sufficiently large to cover an opening for a multi gang box. For example, the mud-in plate 210h may have an outer edge 215 shaped as a rectangle or a rounded rectangle. In some implementations, the outer edge 215 may have a side length, L₁, ranging from about 4.5 inches to about 6 inches, including all values and sub-ranges in between, and a side length, L₂, ranging from about to about 6.375 inches to about 8 inches, including all values and sub-ranges in between.

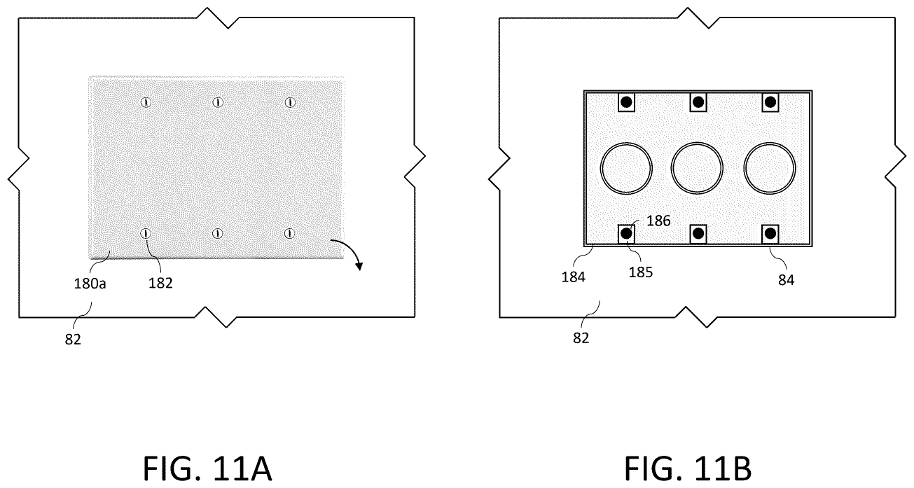

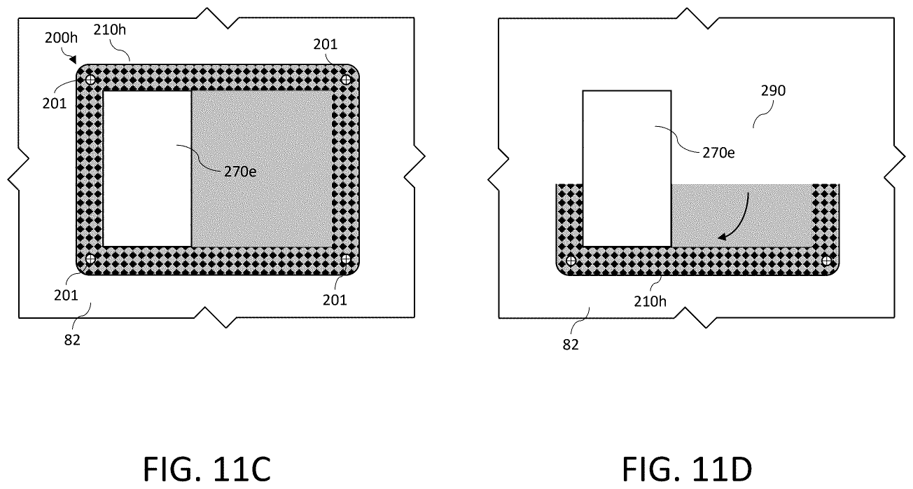

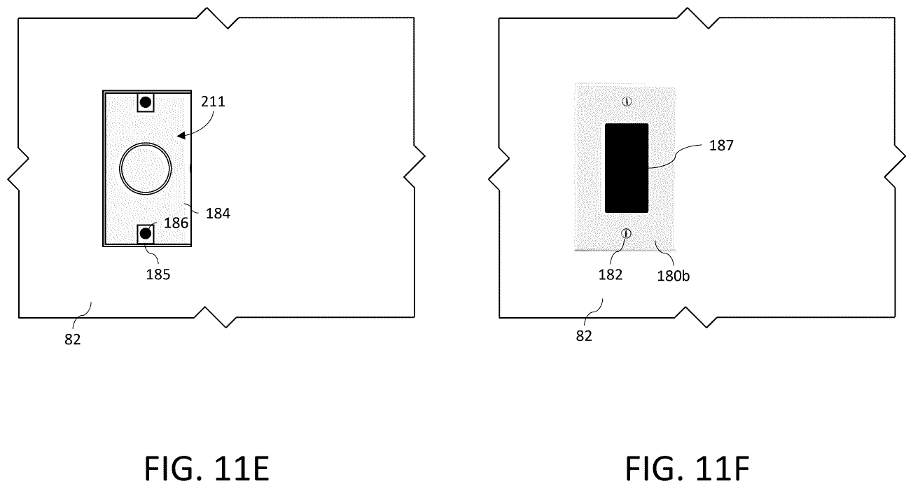

FIGS. 11A-11F show an example process for retrofitting a multi gang box using the mud-in plate 210h. As shown in FIG. 11A, the previously installed multi gang box 184 may initially include a cover plate 180a coupled to a drywall panel 82 forming a wall or a ceiling. The cover plate 180a may first be removed, e.g., by removing one or more fasteners 182 used to securely couple the cover plate 180a to the drywall panel 82. After the cover plate 180a is removed, FIG. 11B shows the multi gang box 184 is exposed and accessible through an opening 84 in the drywall panel 82. As shown, the multi gang box 184 may include one or more tabs 185 with corresponding fastener openings 186, which previously received the fasteners 182.

Once the opening 84 for the gang box 184 is exposed, the mud-in plate 210h may be mounted to the drywall panel 82 as shown in FIG. 11C. As shown, the mud-in plate 210h may form part of a mud-in plate assembly 200h, which includes, for example, an insert 270e enclosing the opening 211. The insert 270e may protect the opening 211 against inadvertent application of the joint compound 290, paint, drywall tape, and/or other substances which may interfere with the opening 211. The mud-in plate 210h may be securely coupled to the drywall panel 82 via a plurality of fasteners 201 inserted through corresponding fastener openings 219 on the outer portion 228b of the mud-in plate 210h.

After the mud-in plate assembly 200h is mounted to the drywall panel 82, joint compound 290 may be applied to the mud-in plate 210h as shown in FIG. 11D. The joint compound 290 may be blended with the surrounding drywall panel 82 to integrate the mud-in plate 210h into the drywall. In some implementations, the joint compound 290 may be sanded (e.g., feathered) to give the appearance the drywall panel 82 extends to the opening 211 defined by the mud-in plate 210h. Thereafter, the joint compound 290 may be painted.

FIG. 11E shows the mud-in plate assembly 200h after application of the joint compound 290 and, optionally, paint. As shown, the insert 270e may be removed, thus exposing the opening 211, which provides access to the multi gang box 184. Notably, the tabs 185 and fastener openings 186 for a portion of the gang box 184 may remain accessible. FIG. 11F shows a cover plate 180b for a single gang box may then be securely coupled to the gang box 184 via fasteners 182 inserted through the fastener openings 186. As shown, the cover plate 180b may include an opening 187 for a switch disposed within the gang box 184. However, it should be appreciated that, in some implementations, the cover plate 180b may not include any opening.

### 1.4 an Example Cable for the Mud-In Plate Assembly

The mud-in plate assemblies described herein may include an electrical cable 260 to facilitate an electrical connection between a lighting module 300 and existing electrical connections provided in a previously installed recessed lighting fixture. As described above, the cable 260 may supply electrical power and/or electrical control signals to the lighting module 300, e.g., to facilitate dimming and/or adjustments to the correlated color temperature of the emitted light. This may be accomplished, in part, by the electrical cable 260 providing the necessary wiring and electrical connectors.

As an illustrative example, FIGS. 12A and 12B show an electrical cable 260 for the mud-in plate assemblies 200 described herein. As shown, the cable 260 includes a pair of wires 264 to supply electrical power. The wires 264 may include, at one end, a socket connector 262a to facilitate connection an existing socket connector (e.g., the socket 128). The wires 264 may include, at another end, a lighting module connector 262b for the lighting module 300. In some implementations, the cable 260 may further include a ground wire 266 to electrically ground the lighting module 300. As shown, the ground wire 266 may connect to the lighting module connector 262b at one. At the other end, the ground wire 266 may include a terminal (e.g., a spade terminal, a ring terminal) for connection to an electrical ground of the recessed lighting fixture via a fastener 268.

In some implementations, the cable 260 may further include wires and/or electrical connectors (not shown) to facilitate connections to a remote control, which provides electrical control signals to adjust the light output of the lighting module 300 (e.g., dimming, adjustments to the correlated color temperature).

### 2. a Mounting Frame for a New Construction Installation

As described in Section 1, the mud-in plate assembly 200 may facilitate the conversion of a previously installed recessed lighting fixture into a trimless recessed lighting fixture capable of supporting lighting modules designed for a smaller aperture recessed lighting fixture in a retrofit installation. In some implementations, a mounting frame incorporating several of the same features as the mud-in plate assembly 200 may be used to facilitate installation of a trimless recessed lighting fixture for a new construction installation. In a new construction installation, most or, in some instances, all the components of the recessed lighting fixture may be installed. For example, a new housing and/or a new drywall panel may be installed as part of the installation. The mounting frames disclosed herein may incorporate one or more of the same components and/or features as the mud-in plate assemblies described in Section 1. For brevity, repeated discussion of these features is not provided below unless indicated otherwise.

Compared to the mud-in plate assemblies disclosed herein, the mounting frame may be directly coupled to a housing, e.g., via one or more fasteners. In some implementations, the mounting frame may also physically contact the ceiling drywall 92.

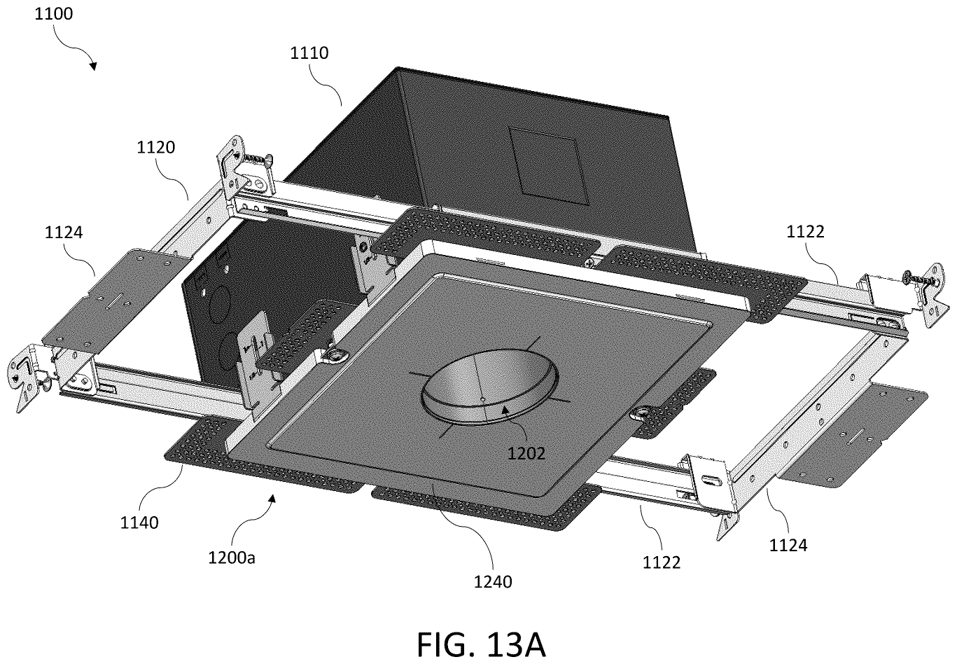

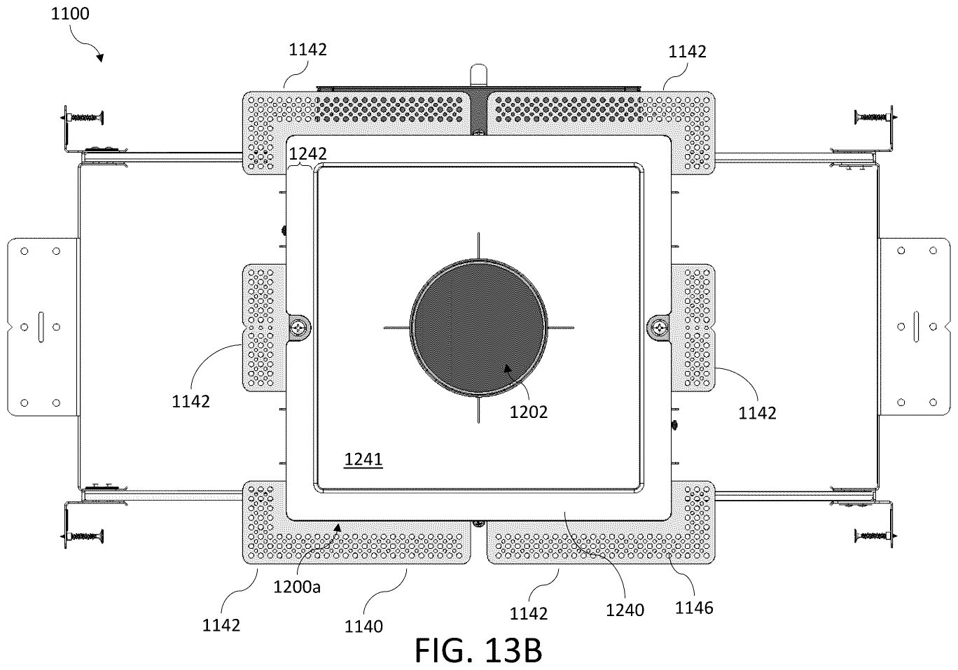

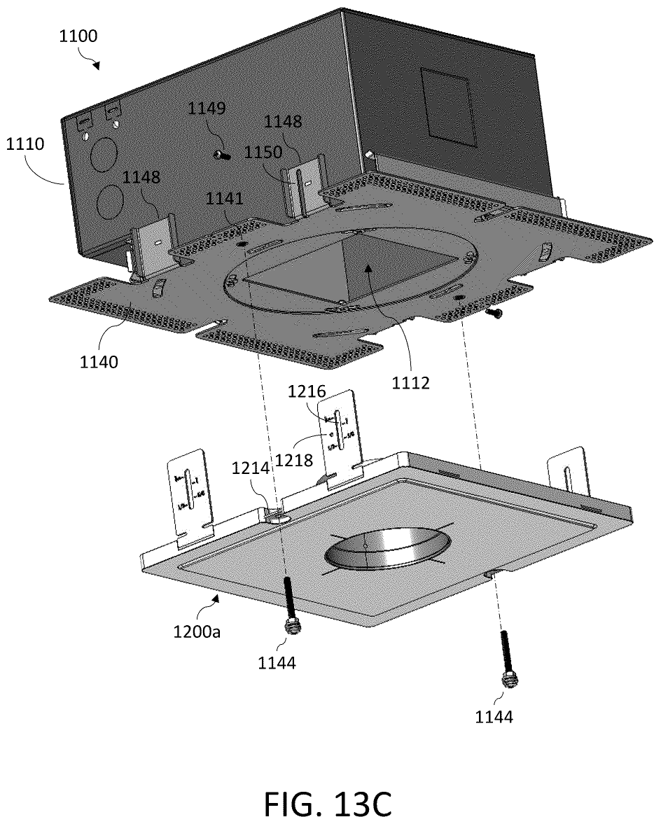

FIGS. 13A-13C show a non-limiting example of a housing assembly 1100 with a mounting frame 1200a to facilitate a new construction installation of a trimless recessed lighting fixture. As shown, the housing assembly 1100 may include a housing 1110 and a bar hanger assembly 1120 to securely mount the housing 1110 to a building support structure (e.g., the building support structures 90a and 90b shown in FIG. 1), such as a wood/metal joist, a T-bar, or a hat channel. In this example, the bar hanger assembly 1120 may include two pairs of telescopically slidable bar hangers 1122. The housing 1110 may include one or more bar hanger holders to support the bar hangers 1122. The ends of each bar hanger 1122 may be coupled to a crossmember 1124, which provides various mounting features to accommodate different building support structures.

The housing 1110 may generally provide one or more cavities to contain, for example, one or more wiring connections (e.g., wire splices) to facilitate connection to an external building power supply system to provide electrical power and/or remote controller to provide electrical control signals (e.g., dimming, adjustments to the correlated color temperature) to the lighting fixture. The housing 1110 may also contain a lighting module and/or a trim (e.g., the lighting modules 300a or 300b and/or the trims 310a or 310b). The housing 1110 may also provide a bottom opening (behind the baseplate 1140). In some implementations, the mounting frame 1200a may include a collar 1220a partially disposed through the bottom opening. In some implementations, a lighting module supported by the collar 1220a may also be partially disposed through the bottom opening. The housing 1110 may further include one or more knockouts (e.g., circular knockouts, Romex knockouts), which may be removed to allow wiring to pass through into the housing 1110.

The housing 1110 may further include a baseplate 1140 coupled to a bottom side of the housing 1110, e.g., via one or more fasteners. The baseplate 1140 may provide an interface to couple the mounting frame 1200a to the housing 1110. The baseplate 1140 may further provide features to align and couple the housing assembly 1100 to the ceiling drywall. For example, the baseplate 1140 may include an opening 1112 aligned to the opening on the bottom side of the housing 1110. The baseplate 1140 may further include multiple tabs 1142 that extend horizontally outwards away from the opening 1112 beyond the outer edge of the panel 1240 in the mounting frame 1200a. The tabs 1142 may abut a top side of the ceiling drywall during installation to increase the structural stability of the housing assembly 1100.

In some implementations, each tab 1142 may include multiple perforations 1146 and/or be dimensioned to be sufficiently thin (e.g., a thickness ranging from 1 mm to 3 mm) so that a fastener (e.g., a sheetrock screw) inserted from the bottom side of the ceiling drywall (i.e., the side facing the space illuminated by the lighting module 300) may readily pierce the tab 1142. One or more fasteners may thus be used to securely couple the baseplate 1140 to the ceiling drywall to further increase the structural stability of the housing assembly 1100. This, in turn, may appreciably reduce or, in some instances, mitigate any relative movement between the panel 1240 of the mounting frame 1200a and the surrounding ceiling drywall, thus preventing cracks forming on the ceiling after installation.

The baseplate 1140 may further provide one or more guides 1148 where each guide 1148 may be slidably coupled to a corresponding rail 1212 of the mounting frame 1200a. The baseplate 1140 may provide one or more fastener openings 1141 to couple to an adjustment fastener 1144 of the mounting frame 1200a. Together, the guides 1148 and the fastener openings 1141 may facilitate vertical adjustment of the mounting frame 1200a with respect to the housing 1110. Further details of the guides and the fastener openings are discussed below.

The baseplate 1140 may be formed from various materials including, but not limited to, a metal (e.g., die-cast aluminum, sheet metal) and a polymer (e.g., polyvinyl chloride (PVC), acrylonitrile butadiene styrene (ABS), polycarbonate (PC), polyurethane (PU), polyethylene, polyethylene terephthalate, polypropylene, and polystyrene).

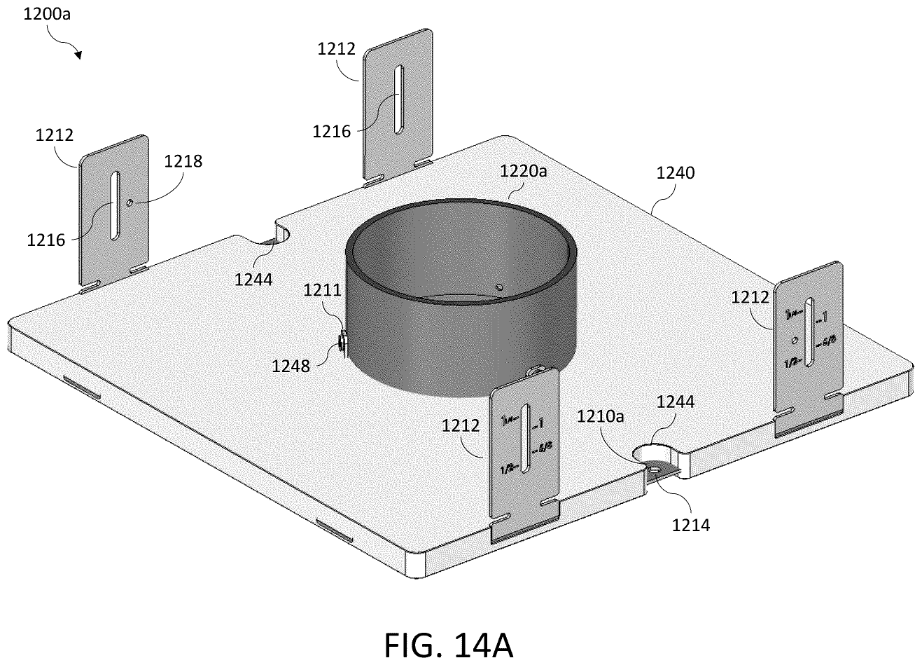

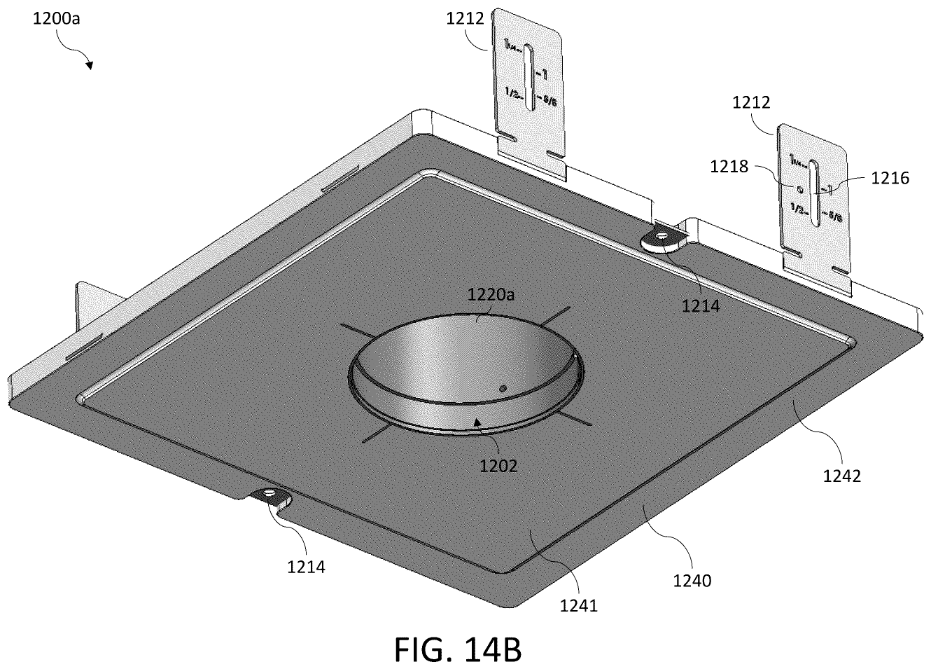

FIGS. 14A and 14B show several views of the mounting frame 1200a. As shown, the mounting frame 1200a may include a frame 1210a to support a collar 1220a and a panel 1240. The frame 1210a may further facilitate coupling of the mounting frame 1200a to the baseplate 1140. The frame 1210a may provide an opening 1202 through which the collar 1220a may be disposed. The frame 1210a may further include multiple tabs 1211 oriented to abut an exterior surface of the collar 1220a. A fastener 1248 may be inserted through corresponding fastener openings (not shown) on each tab 1211 and the collar 1220a to securely couple the collar 1220a to the frame 1210a (see FIG. 3E).

The collar 1220a may provide an interface to physically support a lighting module 300 and a trim 310. For example, the collar 1220a may be a tube-like component that conforms, at least in part, to the shape of the desired opening for the lighting module 300 (e.g., a circular opening, a square opening). The lighting module 300 and/or the trim 310 may be directly mounted to an interior surface of the collar 1220a via an attachment mechanism, such as a friction clip. Thus, in some implementations, the lighting module 300 and the trim 310 may only be physically supported by the mounting frame 1200a. Said another way, the lighting module 300 and the trim 310 may not physically contact the housing 1110.

In some implementations, the mounting frame 1200a may further include an insert (not shown) to enclose the opening of the collar 1220a during installation. The insert may appreciably reduce or, in some instances, mitigate any undesirable substances (e.g., joint compound 290) from being deposited onto the interior surface of the collar 1220a. If an undesirable substance is deposited onto the collar 1220a, this may interfere with the insertion of the lighting module 300 and the trim 310.

The frame 1210a and the collar 1220a may be formed from various materials including, but not limited to, a metal (e.g., die-cast aluminum, sheet metal) and a polymer (e.g., polyvinyl chloride (PVC), acrylonitrile butadiene styrene (ABS), polycarbonate (PC), polyurethane (PU), polyethylene, polyethylene terephthalate, polypropylene, and polystyrene).

The panel 1240 may generally be designed for case of integration with the surrounding ceiling drywall. For example, the panel 1240 may be shaped such that the application of drywall tape and/or joint compound is appreciably similar to conventional drywall panels. For instance, the panel 1240 may be shaped as a square or a rectangle. During installation, an opening may be formed in the ceiling drywall in the shape of the panel 1240 (e.g., a square, a rectangle) so that the panel 1240 may be inserted into the opening for integration with the ceiling drywall. As a non-limiting example, FIGS. 14A and 14B show the panel 1240 shaped as a square. In some implementations, the panel 1240 may have a width (e.g., defined as the span of one side of the square or the rectangle) ranging from about 5 inches to about 8 inches, including all values and sub-ranges in between.

In some implementations, the panel 1240 may include a center portion 1241 and a recessed portion 1242 disposed along the edges of the panel 1240 around the center portion 1241. The recessed portion 1242 may provide a region of the panel 1240 to accommodate the thickness of drywall tape and one or more coats of joint compound, thus reducing the likelihood of any bulge forming when integrating the panel 1240 together with the surrounding ceiling drywall. Said another way, the recessed portion 1242 of the panel 1240 may facilitate greater case of blending the panel 1240 with any adjacent ceiling drywall.

The panel 1240 may be formed from various materials including, but not limited to, gypsum and a composite material comprising 30% glass filled polycarbonate (e.g., LEXAN™ FR Resin 3413R). The panel 1240 may provide a finished opening for the lighting fixture. Herein, a finished opening may be an opening that does not require any further renovations except painting. In some implementations, at least the center portion 1241 of the panel 1240 may have a surface finish that corresponds to a level 5 surface finish as set forth in Gypsum Association GA-214-2021. However, it should be appreciated that, in some implementations, the panel 1240 may include portions (including the center portion 1241) with a lower-level surface finish (e.g., a level 3 surface finish, a level 4 surface finish).

The panel 1240 may improve the case of installation of a trimless recessed lighting fixture by appreciably reducing the amount of joint compound applied to integrate the panel 1240 into the ceiling. For instance, joint compound may only be applied to the edges of the panel 1240 to integrate the panel 1240 into the ceiling. In some implementations, the panel 1240 may be coated with a primer to improve adhesion of any joint compound applied to the panel 1240. The primer may comprise a waterborne acrylic urethane primer/sealer (e.g., STIX SXA-110).

As shown in FIG. 14B, the panel 1240 may be formed around the bottom edge of the collar 1220a. The opening 1202 may have various shapes including, but not limited to, a circle, a square, and a polygon. The panel 1240 may support the same trade sizes as the mud-in plate assembly 200 described in Section 1. Likewise, the dimensions of the opening 1202 may be the same as the dimensions of the opening 211 of the mud-in plate assembly 200.

In implementations where the panel 1240 is formed from gypsum, the panel 1240 may be cast directly onto the frame 1210a and extend around the opening 1202. In some implementations, the frame 1210a and the collar 1220a may be at least partially embedded within the panel 1240. In this manner, the panel 1240 may be securely coupled to the frame 1210a. During casting, the frame 1210a and the collar 1220a may be disposed within a mold that defines the exterior shape of the panel 1240. The frame 1210a may include multiple casting openings to facilitate a flow of drywall material (e.g., gypsum) around the frame 1210a during the casting process, thus reducing or, in some instances, eliminating the formation of bubbles within the drywall material.

The term “about,” when used to describe the dimensions of the housing assembly 1100 or the mounting frame 1200a, is intended to cover manufacturing tolerances and variations in assembly and installation. For example, “about 1 inch” may correspond to the following ranges: 0.99 inches to 1.01 inches (+/−1% variation), 0.98 inches to 1.02 inches (+/−2% variation), 0.97 inches to 1.03 inches (+/−3% variation), 0.96 inches to 1.04 inches (+/−4% variation), 0.95 inches to 1.05 inches (+/−5% variation), including all values and sub-ranges in between.

Vertical movement of the mounting frame 1200a may be facilitated, in part, by the frame 1210a having one or more rails 1212 that are slidably coupled to corresponding guides 1148 formed on the baseplate 1140. As shown, at least one rail 1212 or, in some instances, all the rails 1212 may include a slot 1216 that overlaps with a marker on a corresponding guide 1148. The marker on the guide(s) 1148 and the slot 1216 on the rail(s) 1212 may provide a way to determine the desired vertical position of the mounting frame 1200a. For example, the rail 1212 may include one or more labels along the slot 1216 to indicate the ceiling thickness for that particular installation (e.g., the labels “½”, “⅝”, “1”, and “1¼”). Additionally, at least one rail 1212 may include a fastener opening 1218 that aligns with a slot 1150 formed on the corresponding guide 1148. A rail fastener 1149 may be inserted into the fastener opening 1218 on the rail 1212 and the slot 1150 on the guide 1148 to further guide the vertical motion of the mounting frame 1200a.

In some implementations, the vertical adjustment of the mounting frame 1200a may be facilitated, in part, by one or more adjustment fasteners 1144 coupled to the frame 1210a and the baseplate 1140. Referring again to FIGS. 13A-13C, the adjustment fastener 1144 may be mounted to the frame 1210a via the fastener openings 1214, e.g., the fastener 1144 may be rotatable, but not translationally movable with respect to the frame 1210a. The adjustment fastener 1144 may be inserted into a threaded fastener opening 1141 on the baseplate 1140. Thus, turning the adjustment fastener 1144 causes the mounting frame 1200a to be vertically displaced relative to the housing 1110. In some implementations, the mounting frame 1200a may include multiple adjustment fasteners 1144 disposed on different portions of the frame 1210a. Thus, adjustments to the vertical position of the mounting frame 1200a may involve adjusting each adjustment fastener 1144 separately. In some implementations, the inclusion of multiple adjustment fasteners 1144 may provide a way to adjust the orientation of the drywall panel 1240 with respect to the ceiling drywall.

The head of the adjustment fastener 1144 may be accessible from the bottom side of the mounting frame 1200a. This, in turn, provides a way to adjust the vertical position of the amounting frame 1200a from below the ceiling after the housing 1110 is securely coupled to the support structure and the ceiling drywall is installed. As shown, the panel 1240 may be formed with a notch 1244 to provide clearance around the portion of the frame 1210a where the fastener opening 1214 and the adjustment fastener 1144 are located.

### 2.1 Additional Examples of Mounting Frames

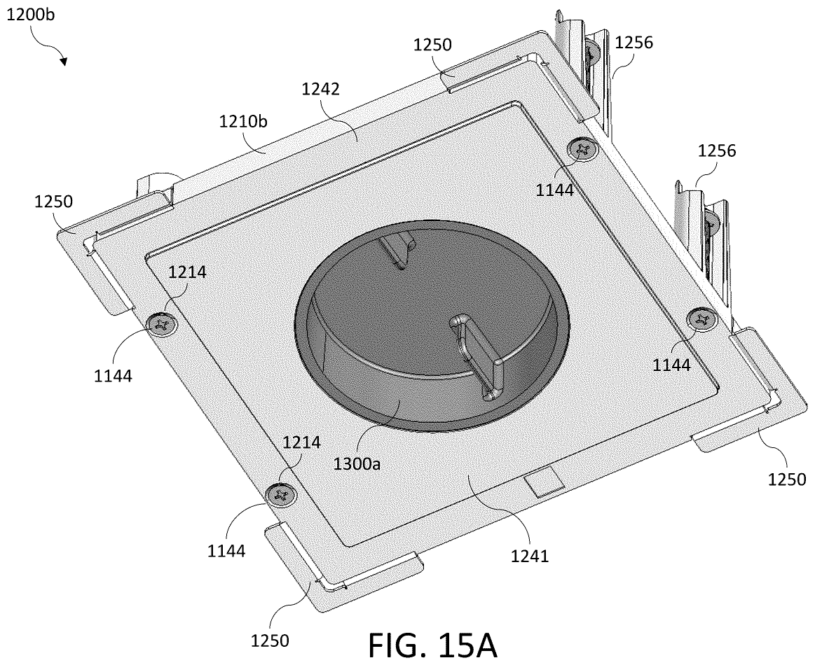

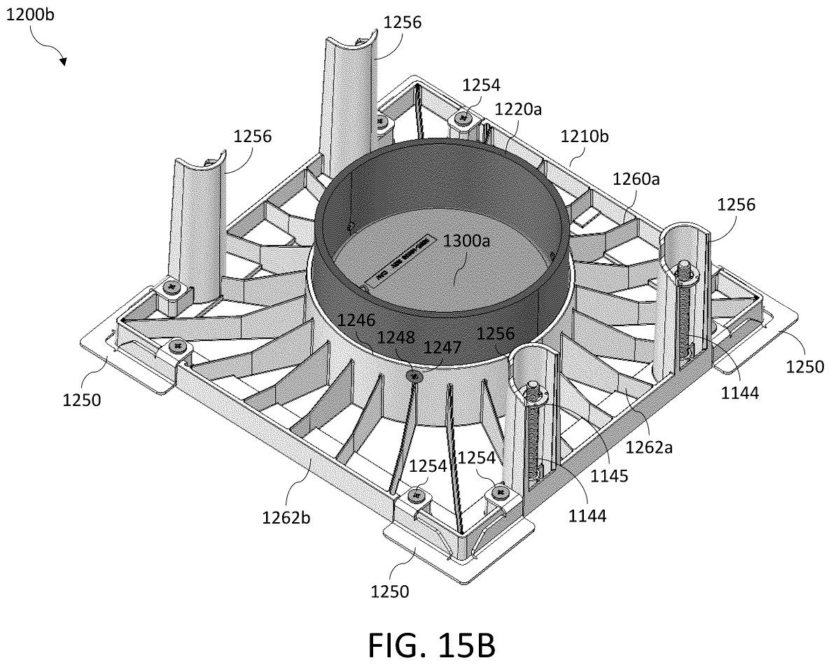

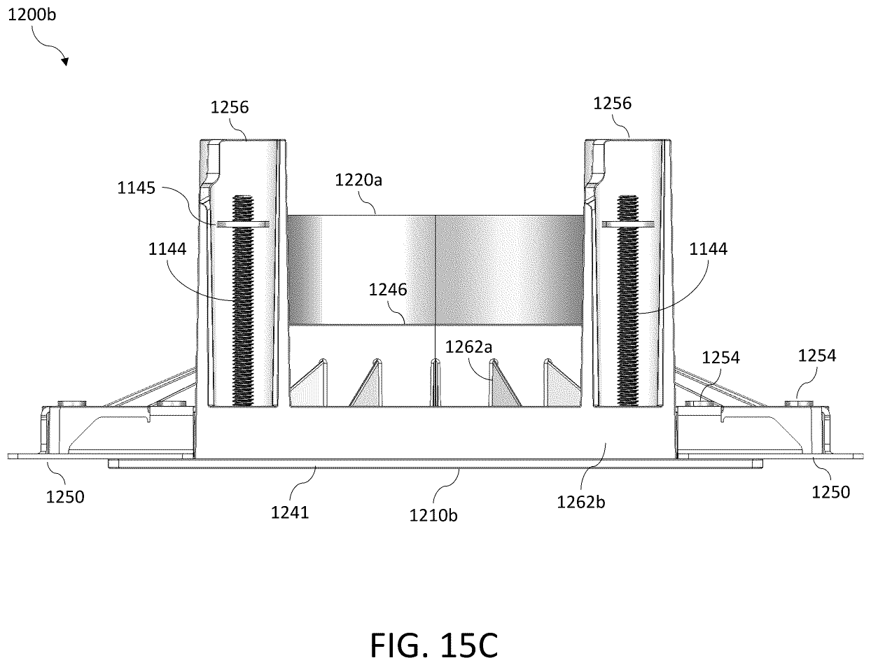

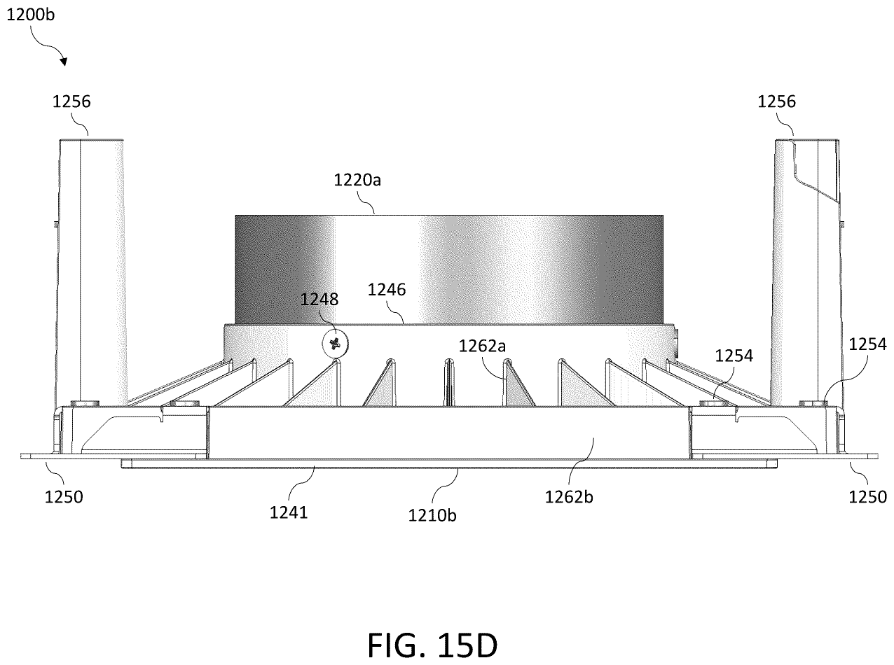

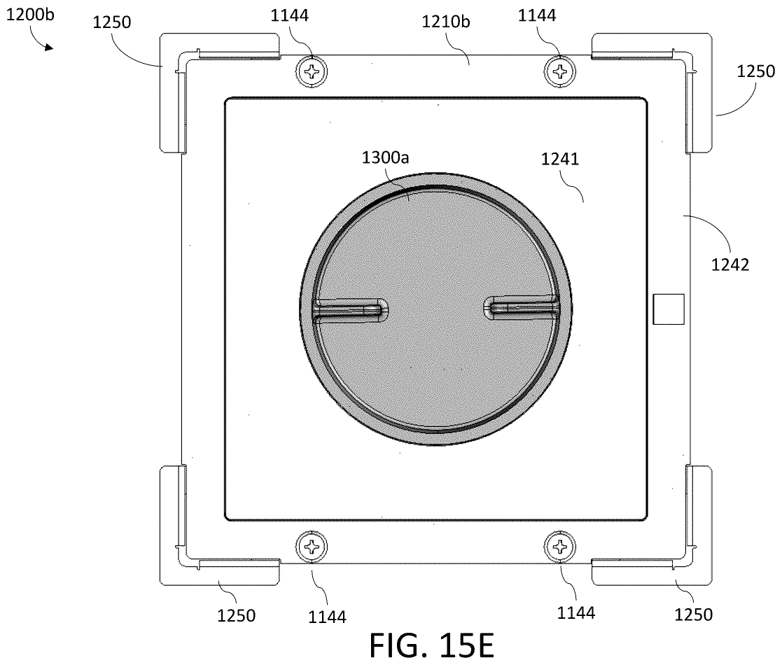

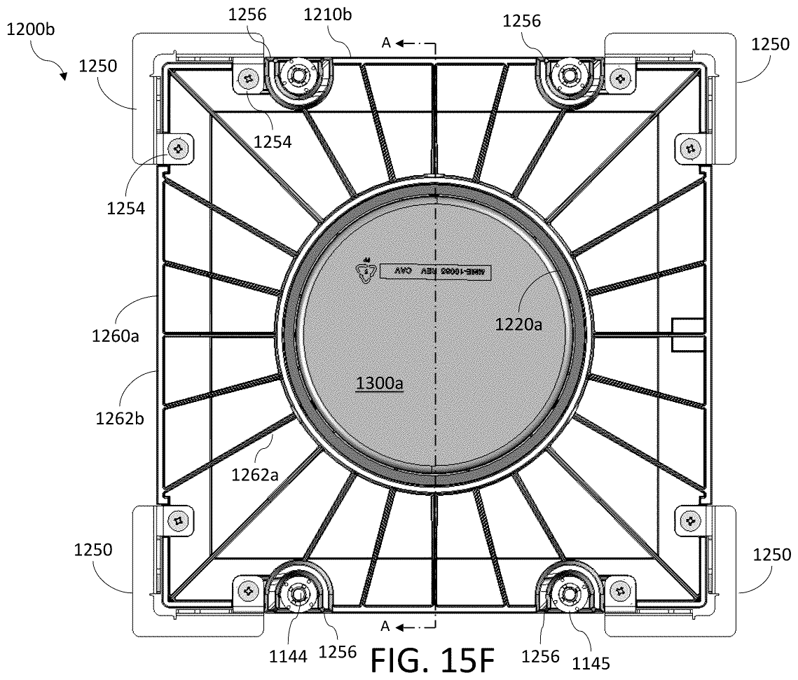

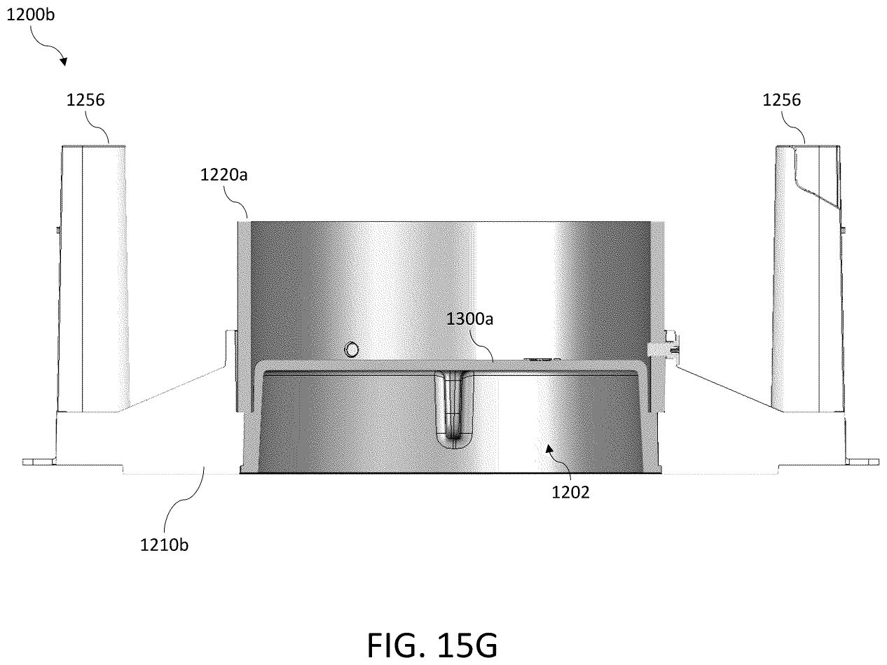

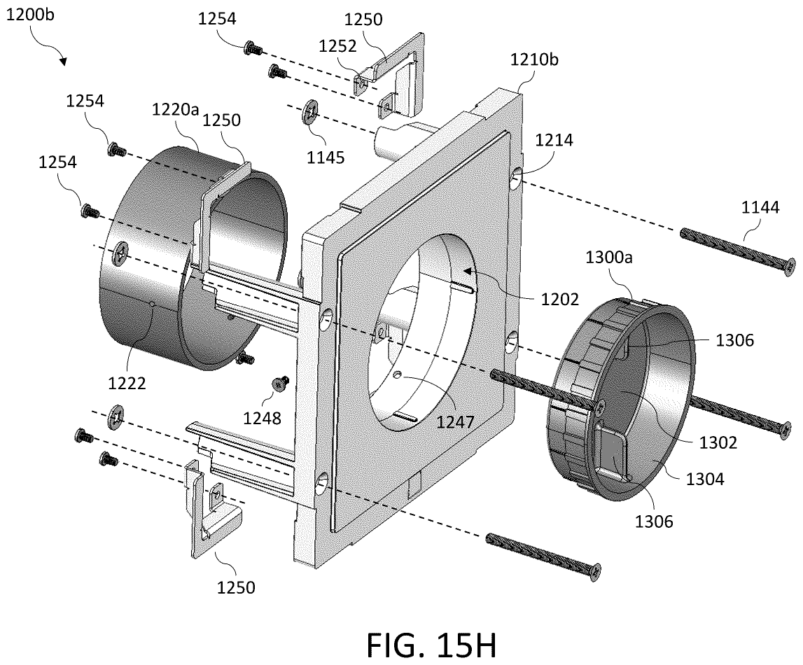

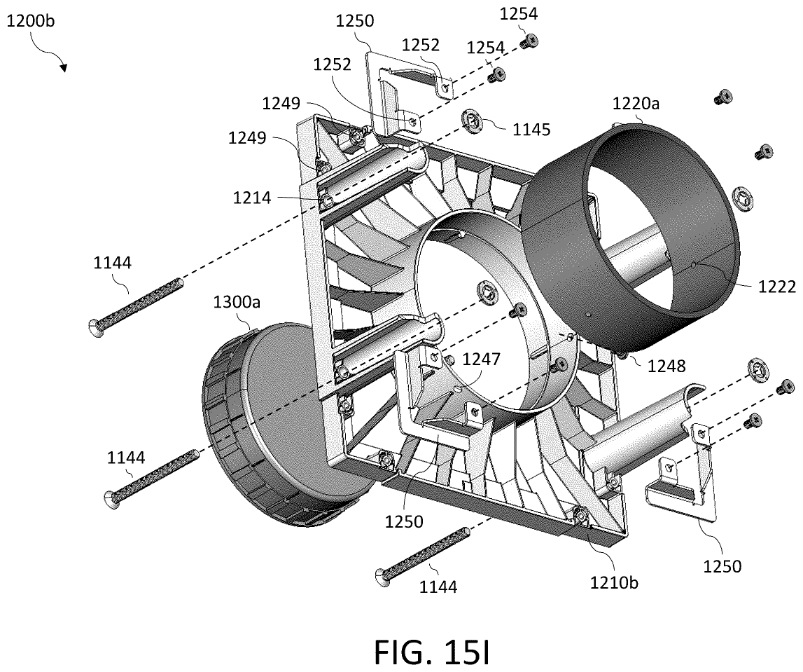

FIGS. 15A-15I show another example mounting frame 1200b for a trimless recessed lighting fixture where the mounting frame 1200b includes an opening 1202 shaped as a circle. In this example, the mounting frame 1200b is affixed to a housing. Thus, the mounting frame 1200b is not vertically adjustable with respect to the housing. As shown, the mounting frame 1200b may include a frame 1210b, the collar 1220a joined to the frame 1210b via a plurality of fasteners 1248, and an insert 1300a to enclose the opening 1202 of the mounting frame 1200b. The mounting frame 1200b may incorporate one or more of the same components and/or features as the mounting frame 1200a described above or the mud-in plate assemblies 200 and 200a-200h described in Section 1. For brevity, repeated discussion of these components and/or features is not provided below unless indicated otherwise.

The mounting frame 1200b may include a frame 1210b that combines the features of the frame 1210a and the panel 1240 in the mounting frame 1200a. As shown, the frame 1210b includes a bottom surface that comprises a central portion 1241 surrounding the opening 1202 and a recessed portion 1242 surrounding the central portion 1241. In some implementations, the central portion 1241 may provide a finished opening for the lighting fixture. In some implementations, at least the center portion 1241 may have a surface finish that corresponds to a level 5 surface finish as set forth in Gypsum Association GA-214-2021. The recessed portion 1242 is disposed along the outer edge of the frame 1210b. The recessed portion 1242 may be vertically offset from the central portion 1241 to accommodate the thickness of any drywall tape and/or joint compound applied to the mounting frame 1200b when integrating the mounting frame 1200b into a ceiling.

The frame 1210b may be formed from various materials including, but not limited to, gypsum, and a composite material comprising 30% glass filled polycarbonate (e.g., LEXAN™ FR Resin 3413R).

The frame 1210b may further include one or more fastener openings 1214 to receive corresponding fasteners 1144 to securely couple the frame 1210b to a housing. In some implementations, the mounting frame 1200b may not be securely coupled to the ceiling drywall, e.g., via a fastener. As shown, the fastener openings 1214 may be disposed onto the recessed portion 1242, in part, to preserve the finished surfaces of the central portion 1241. The top side of the frame 1210b may include a boss 1256 for each fastener opening 1214. When the mounting frame 1200b is inserted into the cavity of the housing, the bosses 1256 may abut opposing interior sidewalls of the housing, thus aligning the mounting frame 1200b to the housing. In some implementations, the housing may include corresponding tabs disposed within the cavity with fastener openings to receive the fasteners 1144. The bosses 1256 may physically align the mounting frame 1200b to the tabs to facilitate insertion of the fasteners 1144 into respective fastener openings of the tabs. In some implementations, each fastener 1144 may include a nut 1145.

The mounting frame 1200b may further include a bracket 1250 disposed on each corner of the frame 1210a. The bracket 1250 may include a lip 1251, which abuts a bottom surface of the surrounding ceiling drywall when the mounting frame 1200b is mounted to the housing. In this manner, the bracket 1250 provides a mechanical stop to limit how far the mounting frame 1200b is inserted into the cavity of the housing. In some implementations, the brackets 1250 may be the only portion the mounting frame 1200b that physically contacts the ceiling drywall. Each bracket 1250 is directly coupled to the frame 1210b via one or more fasteners 1254. As shown in FIG. 15I, each fastener 1254 may be inserted through a fastener opening 1252 on the bracket 1250 and a fastener opening 1249 on the frame 1210b.

The frame 1210b may include a rib structure 1260a disposed on the top side of the frame 1210b as shown in FIG. 15B. The rib structure 1260a may provide structural rigidity to the frame 1210b, thus reducing or, in some instances, mitigating undesirable deformation of the frame 1210b when subjected to a load. The rib structure 1260a may incorporate the same features as the rib structure 220b for the mud-in plate 210b. As shown, the rib structure 1260a may include one or more radial ribs 1262a joined to a sidewall 1246 and the top surfaces of the central portion 1241 and the recessed portion 1242. The rib structure 1260a may further include an outer rib 1262b that spans the periphery of the frame 1210b. The outer rib 1262b may conform to the shape of the frame 1210b. Thus, in this example, the outer rib 1262b may be in the shape of a square.

In some implementations, the collar 1220a may incorporate the same features as the collar 240c for the mud-in plate assemblies discussed in Section 1. The collar 1220a may be securely coupled to the sidewall 1246 of the frame 1210b via one or more fasteners 1248. Each fastener 1248 may be inserted through a fastener opening 1247 on the sidewall 1246 and a fastener opening 1222 on the collar 1220a.

In some implementations, the insert 1300a may incorporate the same features as the rotation tool 270a for the mud-in plate assemblies discussed in Section 1. For example, the insert 1300a may include a base portion 1302 and a sidewall 1304 joined to the base portion. The sidewall 1304 may abut the interior surfaces of the sidewall 1246 and/or the collar 1220a. The insert 1300a may further include one or more tabs 1306 to provide surfaces to grab, push, and/or pull when inserting or removing the insert 1300a from the mounting frame 1200b. As shown, the insert 1300a may enclose the opening 1202 of the mounting frame 1200b, thus protecting the surface of the sidewall 1246 and/or the collar 1220a against any accumulation of joint compound or other substances during installation.

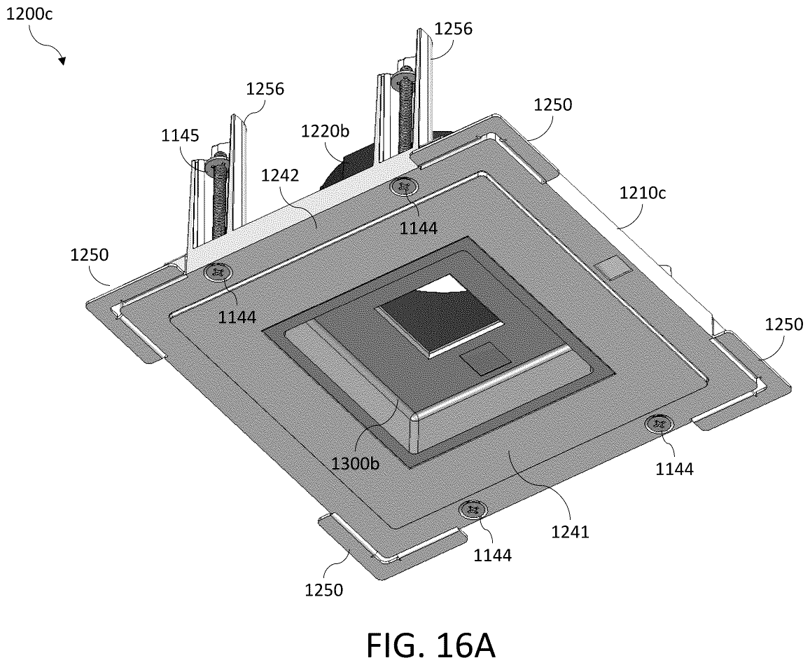

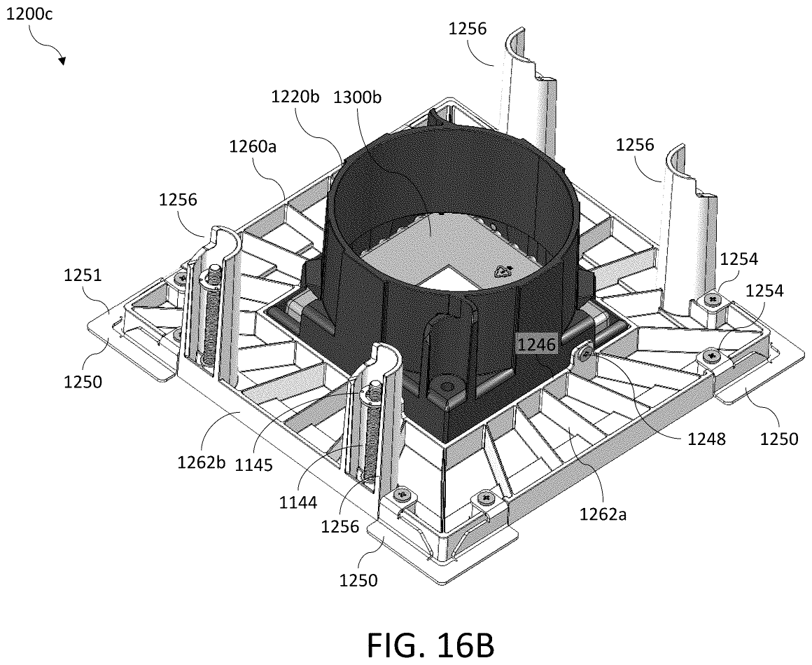

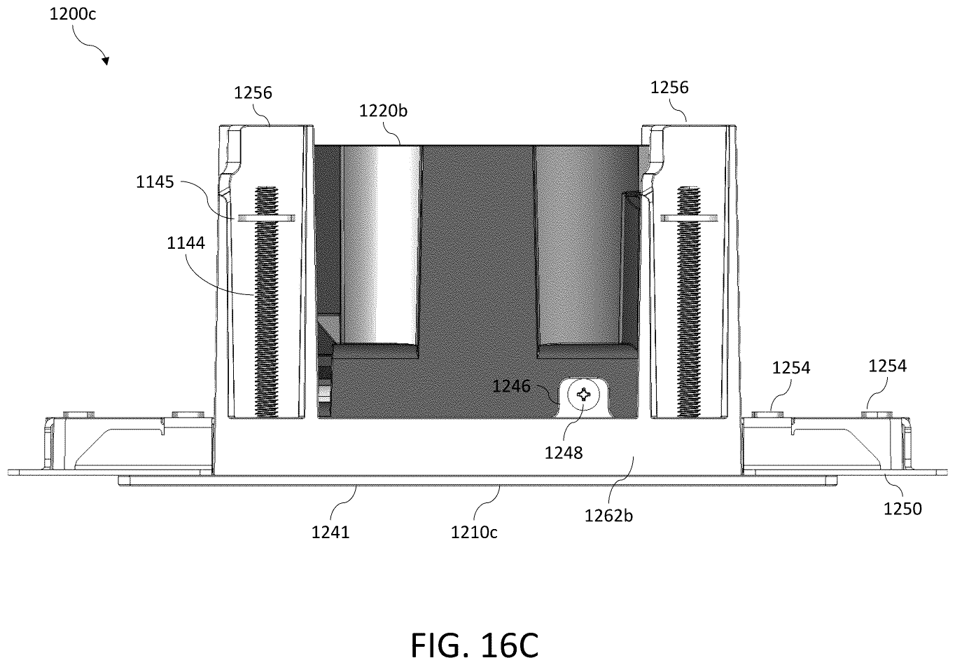

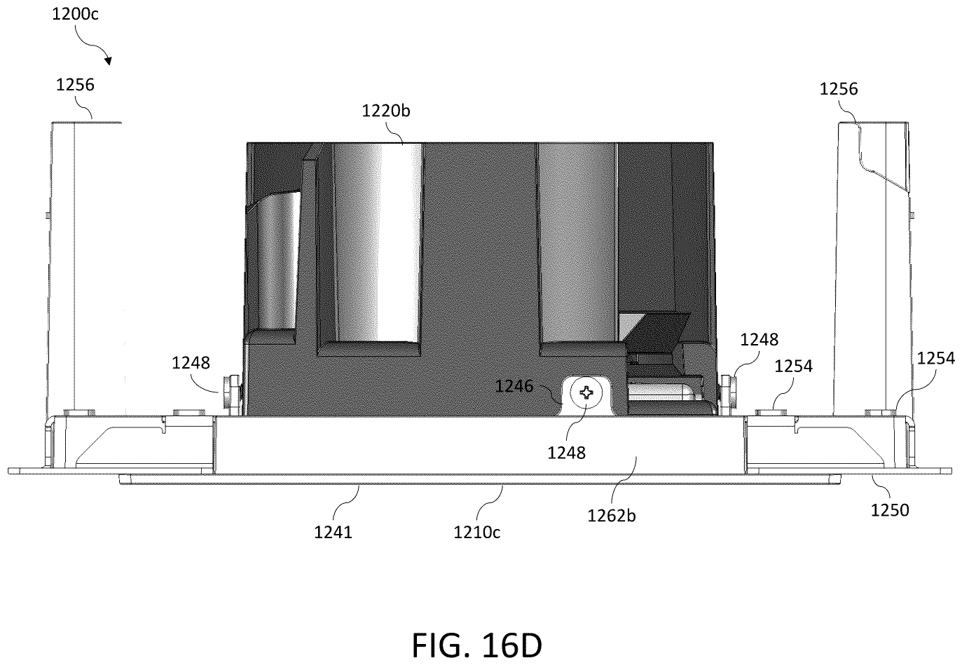

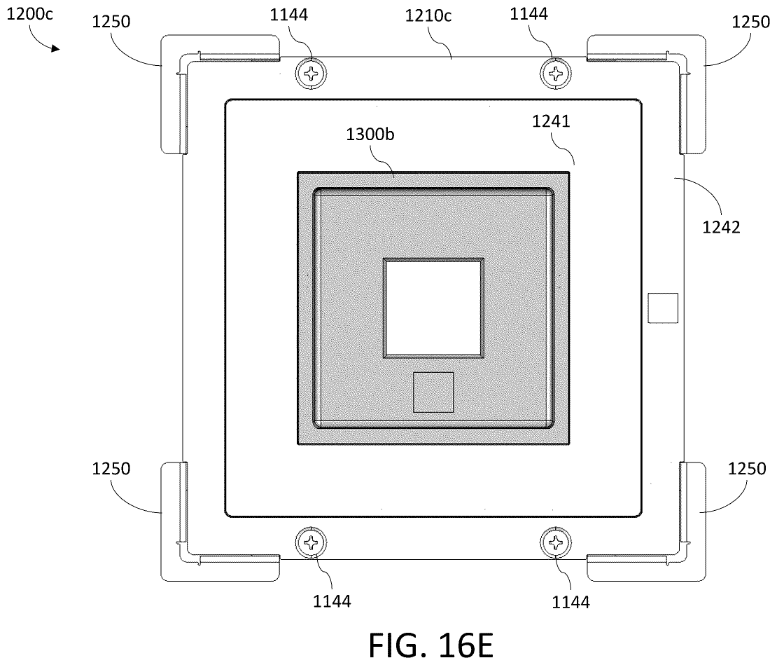

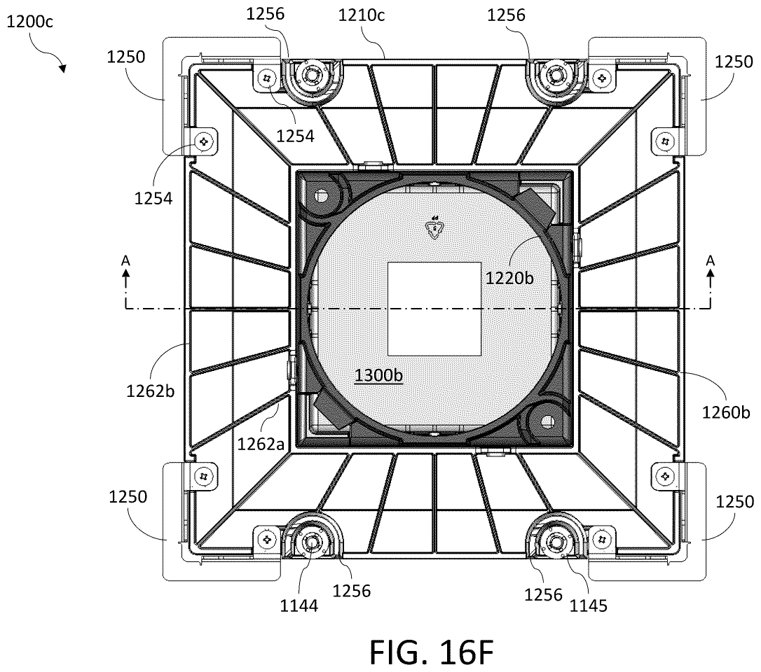

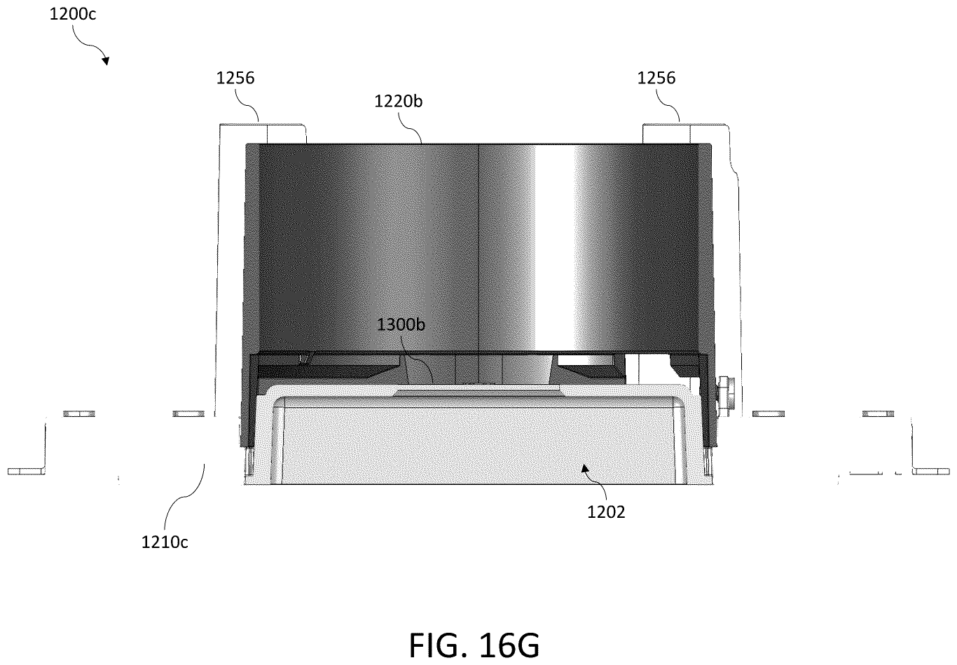

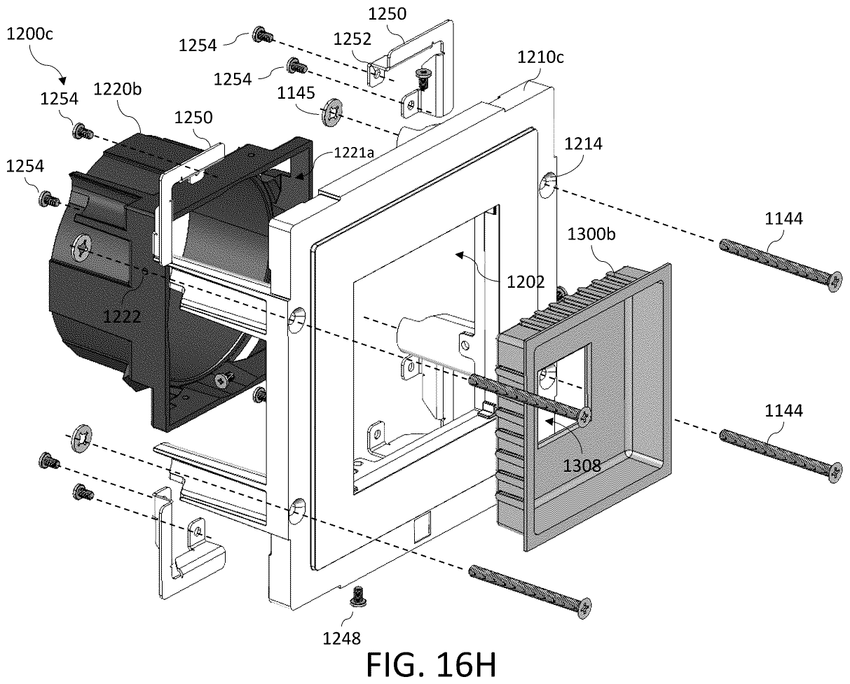

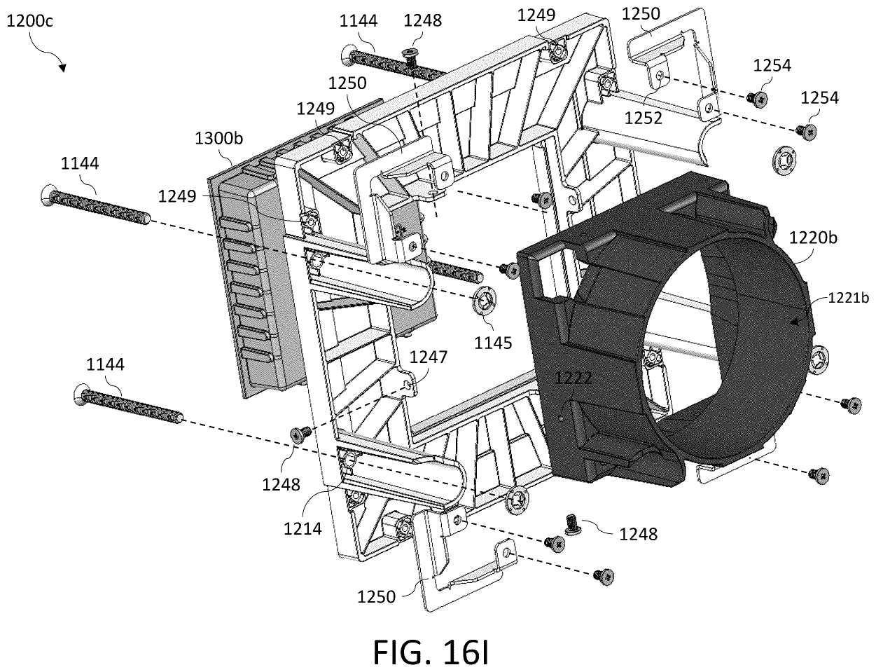

FIGS. 16A-16I show another example mounting frame 1200c with an opening 1202 shaped as a square. As shown, the mounting frame 1200c may include a frame 1210c, a collar 1220b joined to the frame 1210c via a plurality of fasteners 1248, and an insert 1300b to enclose the opening 1202 of the mounting frame 1200c. The mounting frame 1200c may incorporate one or more of the same components and/or features as the mounting frames 1200a and 1200b described above or the mud-in plate assemblies described in Section 1. For brevity, repeated discussion of these components and/or features is not provided below unless indicated otherwise.

In this example, the collar 1220b may incorporate the same features as the collar 240b for the mud-in plate assemblies discussed in Section 1. As shown, the collar 1220b may include a square shaped bottom portion that conforms to the sidewall 1246 and defines a square-shaped opening 1221a at the bottom end of the collar 1220b and a cylindrical upper portion that defines a circular opening 1221b at the top end of the collar 1220b. The cylindrical top portion of the collar 1220b may support a round-shaped lighting module 300 and the square-shaped bottom portion of the collar 1220b may support a square-shaped trim 310.

The insert 1300b may incorporate the same features as the collar 240b for the mud-in plate assemblies discussed in Section 1. As shown, the insert 1300b may include an opening 1308, which provides surfaces for a user to grab, push, and/or pull by hand to insert and/or remove the insert 1300b from the mounting frame 1200c.

### 3. Conclusion

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures. Section 2111.03.

1. A mud-in plate for a recessed lighting fixture installed in a built environment, the mud-in plate comprising:
a flange configured to cover a first opening of a housing in the recessed lighting fixture;
a sidewall extending from a top side of the flange and surrounding a second opening, the sidewall being configured to mechanically support a light source inserted through the second opening, the sidewall further being configured to be at least partially disposed within the housing; and
at least one of a gusset or a rib joined to the flange and the sidewall,
wherein:
the mud-in plate is configured for attachment only to a drywall panel in the built environment; and
the mud-in plate is configured to only physically contact the drywall panel.

2. The mud-in plate of claim 1, wherein the flange has a thickness ranging from about 0.5 millimeters to about 3 millimeters.

3. The mud-in plate of claim 1, wherein the flange has an outer diameter ranging from about 6 inches to about 9 inches.

4. The mud-in plate of claim 1, wherein the at least one of a gusset or a rib comprises:
a circular rib joined to the flange and arranged to be axisymmetric about a centerline of the mud-in plate; and
a plurality of radial ribs joined to the flange, each radial rib of the plurality of radial ribs extending radially from the sidewall to the circular rib.

5. The mud-in plate of claim 4, wherein:
the plurality of radial ribs and the circular rib are configured to be partially disposed within the housing;
the first opening of the housing has a first width; and
the circular rib has a second width approximately equal to the first width.

6. The mud-in plate of claim 1, wherein:
the housing covered by the flange is for a lighting fixture having a first trade size; and
the light source inserted through the second opening is for a lighting fixture having a second trade size smaller than the first trade size.

7. The mud-in plate of claim 6, wherein:
the first trade size is one of a 5-inch trade size, a 6-inch trade size, a 7-inch trade size, or an 8-inch trade size; and
the second trade size is one of a 1-inch trade size, a 2-inch trade size, a 3-inch trade size, or a 4-inch trade size.

8. The mud-in plate of claim 1, wherein:
the first opening of the housing has a first width;
the second opening of the sidewall has a second width smaller than the first width; and
a difference between the first width and the second width is greater than or equal to 1 inch.

9. The mud-in plate of claim 1, wherein:
the first opening of the housing has a first width ranging from about 4 inches to about 6 inches; and
the second opening of the sidewall has a second width smaller than the first width, the second width ranging from about 0.5 inches to about 4 inches.

10. The mud-in plate of claim 1, wherein:
the first opening of the housing is shaped as a circle; and
the second opening of the sidewall is shaped as one of a circle or a square.

11. The mud-in plate of claim 1, wherein the flange comprises:
an inner portion surrounding and adjoining the second opening; and
an outer portion surrounding and adjoining the inner portion,
wherein only the outer portion comprises a plurality of perforations configured to receive a joint compound.

12. The mud-in plate of claim 11, wherein the inner portion is shaped as at least one of a circle or a square.

13. A mud-in plate assembly, comprising:
the mud-in plate of claim 1; and
a collar directly coupled to the sidewall and partially inserted through the second opening, the collar being configured to be directly coupled to the light source.

14. The mud-in plate assembly of claim 13, wherein the collar is vertically adjustable with respect to the mud-in plate.

15. The mud-in plate assembly of claim 14, further comprising:
a rotation tool, directly coupled to the collar, to facilitate vertical adjustment of the collar with respect to the mud-in plate and cover a third opening defined by the collar.

16. A recessed lighting fixture installed in a ceiling, the ceiling comprising a drywall panel, the recessed lighting fixture comprising:
a housing disposed above a surface of the drywall panel in the ceiling;
the mud-in plate assembly of claim 13 directly coupled to the surface of the drywall panel in the ceiling via a plurality of fasteners; and
a light source, disposed within the housing, to emit light through the second opening of the mud-in plate.

17. A mud-in plate for a recessed lighting fixture installed in a built environment, the mud-in plate comprising:
a flange configured to cover a first opening of a housing in the recessed lighting fixture; and
a sidewall extending from a top side of the flange and surrounding a second opening, the sidewall being configured to mechanically support a light source inserted through the second opening, the sidewall further being configured to be at least partially disposed within the housing,
wherein:
the flange has an outer diameter ranging from about 6 inches to about 9 inches and a thickness ranging from about 0.5 millimeters to about 3 millimeters;
the first opening is shaped as a circle and has a first width;
the second opening is shaped as one of a circle or a square and has a second width smaller than the first width, the second width ranging from about 0.5 inches to about 4 inches;
a difference between the first width and the second width is greater than or equal to 1 inch;
the mud-in plate is configured for attachment only to a drywall panel in the built environment; and
the mud-in plate is configured to only physically contact the drywall panel.

18. A recessed lighting fixture installed in a ceiling, the ceiling comprising a drywall panel, the recessed lighting fixture comprising:
a housing disposed above a surface of the drywall panel in the ceiling;
a mud-in plate assembly, comprising:
the mud-in plate of claim 17 directly coupled to the surface of the drywall panel in the ceiling via a plurality of fasteners; and
a collar directly coupled to the sidewall and partially inserted through the second opening; and
a light source, disposed within the housing, to emit light through the second opening of the mud-in plate.

19. A mud-in plate for a recessed lighting fixture installed in a built environment, the mud-in plate comprising:
a flange configured to cover a first opening of a housing in the recessed lighting fixture; and
a sidewall extending from a top side of the flange and surrounding a second opening, the sidewall being configured to mechanically support a light source inserted through the second opening, the sidewall further being configured to be at least partially disposed within the housing,
wherein:
the flange comprises:
an inner portion surrounding and adjoining the second opening; and
an outer portion surrounding and adjoining the inner portion; and
only the outer portion comprises a plurality of perforations configured to receive a joint compound.

20. The mud-in plate of claim 19, wherein:
the outer portion has a first outer edge shaped as one of a circle or a square;
the inner portion has a second outer edge shaped as one of a square; and
the second opening is shaped as one of a circle or a square.
